(19) United States
(12) Patent Application Publication
(10) Pub. No.: US 2020/0051701 A1
(43) Pub. Date: Feb. 13, 2020

(54) METHODS AND APPARATUS FOR FACILITATING LOCALIZED NUCLEAR FUSION REACTIONS ENHANCED BY ELECTRON SCREENING

(71) Applicant: PineSci Consulting, Avon Lake, OH (US)

(72) Inventor: Vladimir Pines, Avon Lake, OH (US)

(73) Assignee: PineSci Consulting, Avon Lake, OH (US)

(21) Appl. No.: 16/600,244

(22) Filed: Oct. 11, 2019

Related U.S. Application Data
(63) Continuation-in-part of application No. 15/064,649, filed on Mar. 9, 2016, now abandoned.
(60) Provisional application No. 62/744,867, filed on Oct. 12, 2018.

(51) Int. Cl. G21B 3/00; G21B 1/19

(52) U.S. Cl. CPC G21B 3/006; G21B 1/057; G21B 3/008; G21B 1/19

(57) ABSTRACT

Methods and apparatuses for facilitating localized nuclear fusion reactions in a globally cold deeply screened fuel source are disclosed, where the volume of cold fuel is much larger than that of hot fuel participating in fission reactions, maintaining structural integrity. Such a deeply screened environment may facilitate the combination of shell and conduction electrons and plasma channels created from external x-ray and/or gamma irradiation. Deeply screened fuel nuclei can tunnel at lower energies, and can much more effectively scatter at high angles, leading to increased tunneling probabilities. Local “hot” fusion conditions may be created by providing neutral hot particles (e.g., hot neutrons) that are substantially more effective at high angle scattering off charged fuel nuclei and can deliver around a half of their kinetic energy in one collision to result in a hot fuel nucleus. Such methods and apparatuses may have various applications, such as heat or medical isotope production.

### CROSS REFERENCE TO RELATED APPLICATIONS

This application is a continuation-in-part (CIP) of U.S. Nonprovisional patent application Ser. No. 15/064,649 filed Mar. 9, 2016. This application also claims the benefit of U.S. Provisional Patent Application No. 62/744,867 filed Oct. 12, 2018. The subject matter of these earlier filed applications is hereby incorporated by reference in its entirety.

### STATEMENT OF FEDERAL RIGHTS

This invention was made with government support under Contract Nos. NNC14CA16C and 80GRC017C0021 awarded by the National Aeronautics and Space Administration (NASA). The U.S. Government has certain rights in the invention.

### FIELD

The present invention generally relates to nuclear technologies, and more particularly, to methods and apparatuses for facilitating localized nuclear fusion reactions enhanced by electron screening.

### BACKGROUND

In hot fusion, deuterium or tritium nuclei possessing high kinetic energy (i.e., “hot” deuterons) collide and fuse. As used herein, “deuteron” or “deuterium” may refer to either hydrogen isotope. However, in practice, nearly all deuteron collisions involve non-productive elastic scattering (i.e., scattering events that do not lead to subsequent nuclear tunneling and fusion events) off of the Coulomb barrier of the nucleus with which they collide. See particle interactions 100 of FIG. 1A and graph 110 of FIG. 1B. The principle impediment for nuclear fusion is the strong Coulomb repulsion between the nuclei at close proximity. Bare nuclei cannot practically be fused since the Coulomb barrier elastic scattering cross section (i.e., the interaction probability of the two deuterons that does not lead to nuclear fusion) at small angles (e.g., less than 90°) is (theoretically) unbounded and the overall vast majority of scattering cross sections are very high, meaning that small angle scattering is highly preferred during interactions of two hot charged particles, such as deuterons. Large angle scattering (e.g., 90° or more) is significantly less frequent than small angle scattering, although such large angle scattering may enable subsequent quantum tunneling, leading to close proximity of the nuclei that may lead to strong force-mediated nuclear reactions, such as nuclear fusion.

In conventional hot fusion approaches, the Coulomb repulsion can be overcome by heating (typically of all of) the fuel to extremely high temperatures (e.g., ˜20 keV, or 2×10⁸ K, which is much greater than the interior temperature of the sun at 1.5×10⁷ K). At this extreme temperature, the nuclei have sufficient energy to tunnel through the Coulomb barrier. However, the fuel also becomes an inherently unstable hot plasma that requires confinement (e.g., magnetic confinement) so as not to vaporize the reactor walls. Indeed, no known physical structure could withstand temperatures even a small fraction of those required in conventional hot fusion processes.

Several other process-specific physical mechanisms leading to losses also make practical hot fusion impossible to date. Additionally, hot fusion processes rely on interactions between charged alpha particles (i.e., the nuclear reaction products) and the charged fuel nuclei to maintain hot fuel. This is an extremely inefficient process for transferring kinetic energy between particles in comparison with the highly efficient energy transfer upon elastic collisions between uncharged particles (such as neutrons) and charged fuel nuclei. The fuel density in the most widely used experimental configuration, a Tokamak reactor, is also extremely low, further reducing the overall reaction rate per unit volume. Currently, confinement time and plasma temperature conditions have been insufficient in both inertial confinement fusion (ICF) and magnetic confinement fusion (Tokamaks) in order to achieve positive power output. In other words, such reactors consume more energy than they produce.

At the other extreme, devices exist for generating neutrons (e.g., for neutron spectroscopy applications). Such devices accelerate charged deuterons using an electric field and then collide the generated deuterons with deuterons or tritons embedded in a metal target. The process may accelerate a relatively large number of deuterons, but the yield of such neutron generators is significantly lower, typically from 10⁶ to 10⁸ neutrons per second are being generated from a much larger number of charged projectile deuterons. This process suffers from the same nonproductive small angle elastic scattering between charged particles as in the Tokamak configuration. Thus, using such deuteron accelerators to produce heat, for example, is highly inefficient and impractical.

In the pursuit to understand astrophysical processes involving fusion processes, studies have been performed directing deuteron beams into deuterated metal substrates. These studies have measured substantially increased reaction rates over gaseous targets at same energy levels. A key difference between the two experimental configurations is the screening of the Coulomb electrostatic barrier between the charged particles. The bound shell and free conduction electron clouds in the metal targets act to screen the positive ion charge, where the projectile deuteron (d) effectively encounters the electrostatic barrier much nearer to the target nucleus, leading to effectively higher reaction cross sections for d-D fusion than for bare nuclei (the projectile is notated with lower case “d” and the target is notated with an upper case “D” herein). The community introduced the concept of screening potential Uₑ to increase the probability of quantum tunneling by a uniform negative shift −Uₑ of the Coulomb barrier U_{C}(r). Researchers have found that Uₑ ranging from ˜25 eV for gaseous targets to ˜50 eV for deuterated insulators and semiconductor targets, to much higher levels for metals such as beryllium (˜180 eV) and palladium (˜800 eV). Nuclear reactions within the confine of a metal lattice may also provide additional benefits by invoking alternative reaction processes, such as screened Oppenheimer-Phillips reactions at low deuteron energy levels that may lead to multiplication events and higher process efficiency.

There are many impediments to creating a net positive energy source from conventional hot fusion approaches, including, but not limited to, the extremely low reaction cross sections (σ) in gaseous targets, lack of efficient screening of the Coulomb barrier leading to small angle dominance of all elastic interactions between nuclei, as well as an extremely low kinetic energy transfer rate between charged particles to keep the fuel nuclei hot, the lack of inherently useful multiplication processes via interactions with metal nuclei, and the extremely low density of the reacting fuel nuclei. Accordingly, an improved nuclear fusion approach may be beneficial.

### SUMMARY

Certain embodiments of the present invention may provide solutions to the problems and needs in the art that have not yet been fully identified, appreciated, or solved by conventional nuclear processes and technologies. For example, some embodiments of the present invention pertain to methods and apparatuses for facilitating localized nuclear fusion reactions in deuterated materials (e.g., deuterated metals) enhanced by electron screening, the reliance on hot neutrons to efficiently transfer kinetic energy to fuel nuclei, and the utilization of nuclear interactions with metal lattice nuclei and other nuclei to further enhance the overall reaction rate via process multiplication of nuclear events with positive energy output.

Screening is effective not only to enhance nuclear tunneling, but also to increase the probability of Coulomb scattering at large angles, which is a requisite for efficient subsequent tunneling. A deuterated or tritiated material (e.g., high Z metals or even low Z materials, such as lithium deuteride (LiD)) may be used to create an environment that is well screened. It is generally known that quasi-free-moving conduction electrons in metals may add to screening of interacting nuclei. Indeed, when atoms are tightly packed, such as in solid host metals, wave functions of valence electrons of individual atoms are overlapped, acquiring considerable kinetic energy due to quantum degeneracy. This Fermi repulsion is large enough to liberate valence electrons from individual atoms into a sea of conduction electrons since the liberated electrons and the conduction electrons are identical particles and are truly indistinguishable, and these electrons participate in effective screening of adjacent nuclei. Furthermore, the screening of ions by atomic shell (bound) electrons of the hydrogen isotopes is also available and is commonly modeled by the Thomas-Fermi model.

Taken together, the metal lattice provides both the electrons for deep screening and a molecular “cage” so the deuterons themselves can be at a high density. An external source of x-rays or gamma rays may also be utilized to enhance further a so-called deep screening within the metal lattice. In deuterated materials exposed to ionizing radiation (γ-quanta and/or energetic electron e-beam), a high density of plasma channels is created inside an irradiated sample, creating non-equilibrium two-temperature plasma with free-moving hot electrons and free-moving cold deuteron ions. As used herein, the word “cold” describes particles at approximately room temperature, ambient temperature, or another temperature substantially below 1 eV (e.g., temperatures in which metals could remain in gaseous, solid, or liquid states). As used herein, the word “hot” describes particles at a substantially higher energy than “cold” particles (e.g., tens, hundreds, thousands, or millions of eV, or even more). Such two-temperature plasma creates highly screened conditions between adjacent fuel nuclei in addition to the screening created by conduction and shell electrons described above. As used herein, the term “deep screening” designates the combined effects of shell, conduction, and/or plasma electrons screening a cold target deuteron, as appropriate to the respective embodiment.

Uncharged particles (e.g., neutrons) may efficiently elastically scatter off of other target particles (e.g., charged particles), delivering a significant portion of the kinetic energy of the uncharged particle to the target particle. More specifically, the probability of large angle scattering (i.e., greater than 90°) in neutral particle scattering is much higher than in scattering of charged particles. Additionally, neutral particles may deliver a substantially larger portion of their kinetic energy to the target particles in comparison to scattering of a charged particle from the same target. Therefore, it may be advantageous to provide kinetic energy to a charged particle, such as hydrogen fuel nuclei, using scattering from hot neutrons.

Creation of hot neutrons within a dense fuel sample that includes deuterated hydrogen isotopes in a metal lattice, by way of nonlimiting example, could be accomplished by irradiation from certain radioactive isotopes, from photodisintegration of deuteron fuel nuclei using gamma irradiation of sufficient energy (i.e., above 2.226 MeV), or from ensuing reactions once fusion or other nuclear reactions are initiated using hot neutron scattering using the above externally driven processes. As a nonlimiting example, the metal lattice may be bombarded with neutrons from a neutron source that provides a desired rate of neutron production. Process multiplication events of the hot neutrons used to efficiently transfer kinetic energy for local heating of the nuclear fuel for subsequent reactions can be designed using materials such as LiD could photodisintegrate or otherwise disintegrate at sufficiently high energy levels, inclusion of other materials capable of participating in screened Oppenheimer-Phillips reactions with hot deuterons even at low energy, and/or by inclusion of radioactive materials capable of fissioning and producing of additional hot neutrons. As used herein, the reference to Oppenheimer-Phillips reactions describes more generally a Oppenheimer-Phillips “deuteron stripping” process since Oppenheimer Phillips stripping typically describes the preferential neutron capture over proton capture. In the deeply screened local environment of some embodiments, both proton and neutron stripping and nuclei capture rates are increased, regardless of the deuteron polarization. As another nonlimiting example, the metal lattice may further include additional materials capable of being deuterated and also being fissionable (e.g., deuterated or tritiated actinide metals). Such materials may provide additional multiplication channels for neutron production.

The combined process of some embodiments could be described as “locally hot—globally cold,” in contrast with other hot fusion processes in which the fuel itself is globally hot and entirely ionized (“locally hot—globally hot”). The processes of some embodiments feature a condition in which locally hot fusion and other subsequent nuclear process are initiated by efficient scattering of neutral particles (e.g., neutrons) in localized regions of the deuterated sample while the remaining fuel within the vast majority of the sample remains “cold.” In some embodiments, the cold fuel is relatively dense, deeply screened, and ready to fuse upon heating of one fuel nucleus by scattering of hot neutrons provided by external means or by photodisintegration of another fuel deuterium nucleus. Fusion and additional reactions with the host metal nuclei create additional hot neutrons. A key feature of locally hot—globally cold processes is that the energy generated by fusion and other nuclear reactions is efficiently dispersed by conduction, convection, or radiation outside of the sample, allowing self-healing and re-deuteration of the host material, maintaining of the overall state of matter of the fuel as a gas, liquid, or solid state or maintaining the chemical composition of the fuel. In comparison with conventional globally hot fusion processes, the deuterated fuel remains globally cold, although at temperatures sufficient to deliver heat energy to the external domain.

In an embodiment, a method for locally hot but globally cold nuclear fusion includes providing cold deeply screened fuel at energies below 1 electron volt (eV) that enhances nuclear tunneling. The method also includes subjecting the deeply screened fuel to hot energetic neutrons at energies of 1 keV or more that scatter off of target fuel particles, thereby delivering a portion of kinetic energies of the energetic neutrons to the target particles and causing local nuclear fusion within the deeply screened fuel.

In another embodiment, a method for locally hot but globally cold nuclear fusion includes irradiating deeply screened fuel with γ-quanta and/or energetic electron e-beam ionizing radiation sufficient to create plasma channels within the deeply screened fuel. The plasma channels further create deeply screened conditions between adjacent nuclei in the deeply screened nuclear fuel with at least one of the adjacent nuclear fuel nuclei being cold. The method also includes creating hot energetic neutrons at energies of 1 keV or more via irradiation from one or more radioactive isotopes, photodisintegration of deuteron fuel nuclei in the deeply screened fuel using gamma irradiation, from reactions from hot neutron scattering in the deeply screened fuel, from secondary fission processes, or any combination thereof. The method further includes subjecting the deeply screened fuel to the hot energetic neutrons that scatter off of target fuel particles, thereby delivering a portion of kinetic energies of the energetic neutrons to the target particles and causing local nuclear fusion within the deeply screened fuel.

In yet another embodiment, a method includes providing cold deeply screened fuel at energies below 1 electron volt (eV) that enhances nuclear tunneling. The deeply screened fuel includes a deuterated and/or tritiated metal lattice. The method also includes providing a neutron reflector or moderator, an envelope, a participating fissionable material, or any combination thereof to reflect or moderate hot neutrons, to facilitate further nuclear reactions, or both. The method further includes irradiating the deeply screened fuel with γ-quanta and/or energetic electron e-beam ionizing radiation sufficient to create plasma channels within the deeply screened fuel. The plasma channels further create deeply screened conditions between adjacent nuclei in the deeply screened nuclear fuel with at least one of the adjacent nuclear fuel nuclei being cold. Additionally, the method includes subjecting the deeply screened fuel to hot energetic neutrons at energies of 1 keV or more that scatter off of target fuel particles, thereby delivering a portion of kinetic energies of the energetic neutrons to the target fuel particles and causing local nuclear fusion within the deeply screened fuel. The method also includes controlling a nuclear reaction rate by adjusting a flux of x-rays and/or gamma rays produced by an x-ray device, a LINAC, or both. The nuclear reaction rate is sufficiently low that energy generated by the local nuclear fusion is sufficiently dispersed by conduction, convention, radiation, or any combination thereof, outside of the deeply screened fuel that the metal lattice self-heals and re-deuterates, that the deuterated material maintains a chemical composition, or that the deeply screened fuel remains in a gaseous, liquid, or solid state.

In some embodiments, nuclear fuel is embedded within a lattice containing screened nuclei capable of participating in subsequent Oppenheimer-Phillips reactions with hot deuterons energized by collisions with hot neutrons or with other particles originating from other secondary reactions. In certain embodiments, the nuclear fuel is combined with fissionable elements, such as uranium, plutonium, thorium, etc., that may further participate in fission reactions to assist in process multiplications by producing additional hot neutrons to efficiently scatter off deuterons.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1A illustrates an interaction between two particles, such as between charged particles (i.e., deuterons) or between uncharged particles (i.e., neutrons) and charged particles (i.e., deuterons), illustrating various potential scattering paths and a scattering angle θ.

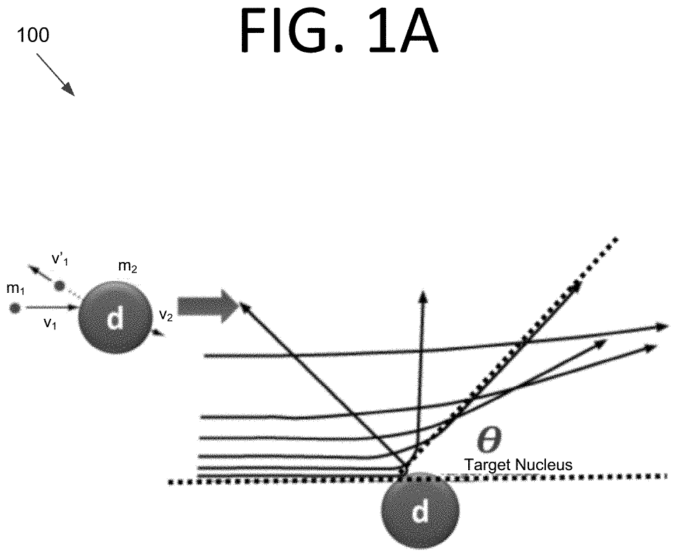

FIG. 1B is a general graph illustrating the probability of Coulomb elastic scattering between two charged particles as a function of the scattering angle. Interactions at small angles dominate, but do not lead to subsequent nuclear interactions that are possible at large scattering angle above 90°, for example.

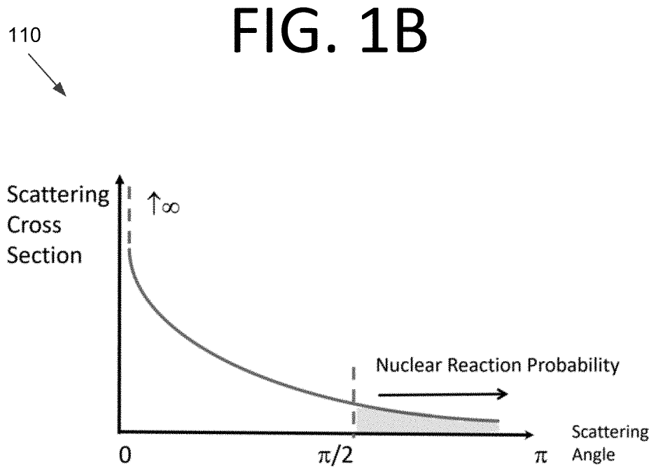

FIG. 2 illustrates a portion of a deuterated metal lattice, according to an embodiment of the present invention.

FIG. 3A illustrates the first stage of a deep screened fusion process in which a hot neutron (n*) is being introduced into a deuterated metal lattice, according to an embodiment of the present invention.

FIG. 3B illustrates the second stage of the deep screened fusion process in which a high energy (hot) neutron (n*) is being scattered off a previously low energy (cold) fuel nucleus within the deuterated metal lattice, thus delivering kinetic energy from the neutron to the fuel nucleus (d*), according to an embodiment of the present invention.

FIG. 3C illustrates the third stage of the deep screened fusion process in which the hot fuel deuteron (d*) scatters off the cold deuteron (D) at a high scattering angle and is effectively screened to result in a nuclear tunneling reaction between the hot deuteron and the cold deuteron, according to an embodiment of the present invention.

FIG. 4 illustrates a comparison between a conventional plasma hot fusion process and a deeply screened fusion process, according to an embodiment of the present invention.

FIG. 5 is a flow diagram illustrating a deeply screened fusion process with subsequent nuclear events leading to neutron multiplications, according to an embodiment of the present invention.

FIG. 6A illustrates a deeply screened nuclear reaction process that uses photo neutrons, according to an embodiment of the present invention.

FIG. 6B illustrates a deeply screened nuclear reaction process that uses a radioactive neutron source, according to an embodiment of the present invention.

FIG. 7A is a side view illustrating a linear accelerator (LINAC)-based experimental example, according to an embodiment of the present invention.

FIG. 7B is a top view illustrating an experimental example showing deuterated or tritiated material samples being irradiated by a photon beam, and also showing the cave with the top showing neutron detection instrumentation, according to an embodiment of the present invention.

FIG. 7C is a magnified side view of the experimental example illustrating the close proximity of the sample vials relative to the braking target increasing the unit photon density to increase reaction rates, according to an embodiment of the present invention.

FIG. 8 shows a general architecture of an example experimental setup, according to an embodiment of the present invention.

FIG. 9 is a graph illustrating the Bremsstrahlung photon spectrum for an electron beam endpoint of 2.9 MeV for a 450-μA (per vial) test case (top of sample), according to an embodiment of the present invention.

FIG. 10A provides an example Pulse Shape Discrimination (PSD) plot relating PSD parameters versus electron equivalent energy recorded in the detector (EJ309 HV) for TS1576 ErD₃, according to an embodiment of the present invention.

FIG. 10B is a graph illustrating the EJ309 detector results for TS1576 (fueled, black line above) and TS589 (unfueled, dark gray line below) in detector counts (PMT counts after filtered using the process noted earlier) versus electron energy equivalent units (keVee), according to an embodiment of the present invention.

FIG. 10C is a graph illustrating a comparison of the measured net counts (TS1576 (fueled) minus TS589 (unfueled) prior to unfolding with the HEBROW algorithms for ErD₃ (black, solid) with two detector simulations for a source of monochromatic neutrons with energies (Eₙ) of 2.45 MeV (dashed tracing upper peak) and 4 MeV (lower dashed), according to an embodiment of the present invention.

FIG. 11A is a graph illustrating neutron spectra for TS1575 (6-hours EJ309) net neutron counts (beam: 2.9 MeV, 15 mA), according to an embodiment of the present invention.

FIG. 11B is a graph illustrating neutron spectra for TS1576 (6-hours EJ309) net neutron counts (beam: 2.9 MeV, 15 mA), according to an embodiment of the present invention.

FIG. 11C is a graph illustrating neutron spectra for TS1575 (6-hours Stilbene) net neutron counts (beam: 2.9 MeV, 15 mA), according to an embodiment of the present invention.

FIG. 12 is a graph illustrating neutron spectra for TiD₂ (TS610-612) (5.5-hours EJ309) net neutron counts (Beam: 2.9 MeV, 15 mA), according to an embodiment of the present invention.

FIG. 13 is a flowchart illustrating deeply screened fusion reaction process, according to an embodiment of the present invention.

FIG. 14 is a flowchart illustrating a process for locally hot but globally cold nuclear fusion, according to an embodiment of the present invention.

FIG. 15 is an architectural diagram illustrating a fusion reaction system, according to an embodiment of the present invention.

FIG. 16 is an architectural diagram illustrating a fusion-based reaction system, according to an embodiment of the present invention.

FIG. 17 is a block diagram illustrating a computing system configured to control a nuclear reaction rate, according to an embodiment of the present invention.

Unless otherwise indicated, similar reference characters denote corresponding features consistently throughout the attached drawings.

### DETAILED DESCRIPTION OF THE EMBODIMENTS

Some embodiments provide a deeply screened nuclear fuel environment with “cold” fuel. Such a deeply screened environment may facilitate the combination of shell and conduction electrons and plasma channels created from external x-ray and/or gamma irradiation. Deeply screened fuel nuclei can tunnel at lower energies, and can much more effectively scatter at high angles, leading to increased tunneling probabilities. Local “hot” fusion conditions may be created by providing neutral hot particles (e.g., hot neutrons) that are substantially more effective at high angle scattering off charged fuel nuclei and can deliver around a half of their kinetic energy in one collision to result in a hot fuel nucleus.

Hot neutrons may be provided by external mechanisms including, but not limited to, photodisintegration of a deuteron by gamma radiation, from radioactive decay, from fission processes, etc. The process is sub-critical and may be controllable by externally controlling the additional hot neutron flux to the fuel. The hot fuel nucleus is deeply screened by two-temperature plasma, which effectively screens the two fuel nuclei to be fused. The tunneling probability of the hot fuel (e.g., at MeV levels) with the cold fuel is high. The hot fuel can alternatively scatter off metal lattice nuclei in Oppenheimer-Phillips reactions if it is sufficiently hot and well screened.

In some embodiments, the fuel includes LiD that can participate in additional multiple channels available from scattering of hot neutrons or protons or from photodistintegration of Li. In certain embodiments, fissionable material could be added for process multiplication. In some embodiments, an envelope may be added to reflect/moderate neutrons as desired for the particular process design. In some embodiments, the metal lattice may further include additional materials capable of being deuterated and also being fissionable (e.g., deuterated or titrated actinide metals). Such materials may provide additional multiplication channels for neutron production.

The process of some embodiments may be described as sub-critical, locally hot reactions in globally cold and dense fuel (liquid, solid, or highly compressed gas—not fully ionized plasma state). This means that the overall chemical or structural integrity of the fuel and container thereof is maintained since fusion and other reactions are localized in small regions in the overall volume such that the heat generated can be transmitted to the outside via heat transfer processes. In a way, fusion reactors made with the above elements produce small to moderate amounts of heat in a fully controllable, sub-critical manner.

Per the above, some embodiments of the present invention pertain to methods and apparatuses for facilitating localized nuclear fusion reactions in deuterated metals enhanced by electron screening. As used herein, the terms “deuteron” or “deuterated” may also refer to a “triton” or “tritiated”, respectively. It was theorized that combining various or all features contributing to electron screening (e.g., lattice, shell, and plasma screening) into an enhanced screening energy Uₑ and utilizing the concept of an enhancement factor f(E) to relate bare cross sections to those experimentally observed could be defined as follows.

The experimental fusion cross section σₑₓₚ(E) can be written as:

σₑₓₚ(E)=σ_{bare}(E)·f(E) (1)

where E is the projectile energy and σ_{bare}(E) is the nuclear fusion cross section of bare nucleus ions. The enhancement factor f(E) can be formulated as:

$$f ( E ) = \frac{S ( E + {U}_{e} )}{S ( E )} \cdot \frac{E}{( E + {U}_{e} )} \cdot exp \{ G ( E ) - G ( E + {U}_{e} ) \} \qquad ( 2 )$$

where G (E) is the Gamow factor and S(E) is the astrophysical factor.

From the theoretical analysis provided in detail below, electron screening (also referred to herein as “screening”) is effective not only to enhance nuclear tunneling, but also to increase the probability of Coulomb scattering at large angles. Without screening, low angle scattering of hot projectiles dominates, resulting in nonproductive elastic scattering and reduced tunneling. Therefore, efficient electron screening is a necessary ingredient for inducing and sustaining of nuclear fusion.

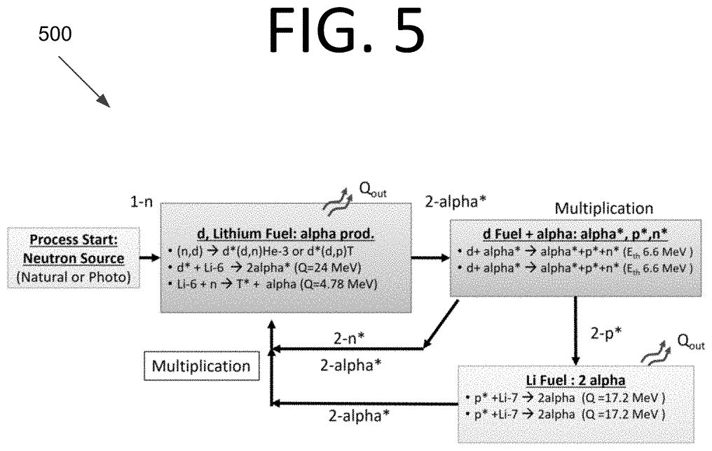

In particular, in some embodiments, the metal lattice nuclei of the deuterated material participate in a type of nuclear reaction called an Oppenheimer-Phillips process, in which charge polarization of the hot deuteron occurs when it approaches the target nucleus (e.g., the lattice metal nuclei). During the Oppenheimer-Phillips process, the proton-side faces away from the target nucleus and the neutron-side faces towards the target. A fusion reaction then ensues when the binding energy of the neutron and the target nucleus exceeds the binding energy of the deuteron. Depending on the energy of the incoming deuteron, either the proton or the neutron may fuse, although the neutron is typically absorbed, and a proton is then repelled from the transmuted nucleus. Both cases may lead to process multiplication, with the hot neutron being ejected off the target nucleus, providing a significant fraction of its kinetic energy to a nearby cold deuteron to continue the reaction process. Alternatively, a hot proton may either directly break down a deuteron or a metal lattice nucleus (e.g., a lithium nucleus), further resulting in additional hot neutrons or production of hot deuteron or tritium nuclei to enable subsequent nuclear processes, as shown in FIG. 5, for example.

From the theoretical analysis below, it is also evident that an optimal way to exchange kinetic energy between particles should involve uncharged particles. Neutrons have relatively high scattering cross sections on nuclear fuel (e.g., deuterons), and can deliver a substantial portion of their kinetic energy in a single elastic collision to the deuteron. A fusion process was therefore examined in which kinetic energy exchange by hot neutrons to the fuel provides the basis for process initiation and potential secondary nuclear events.

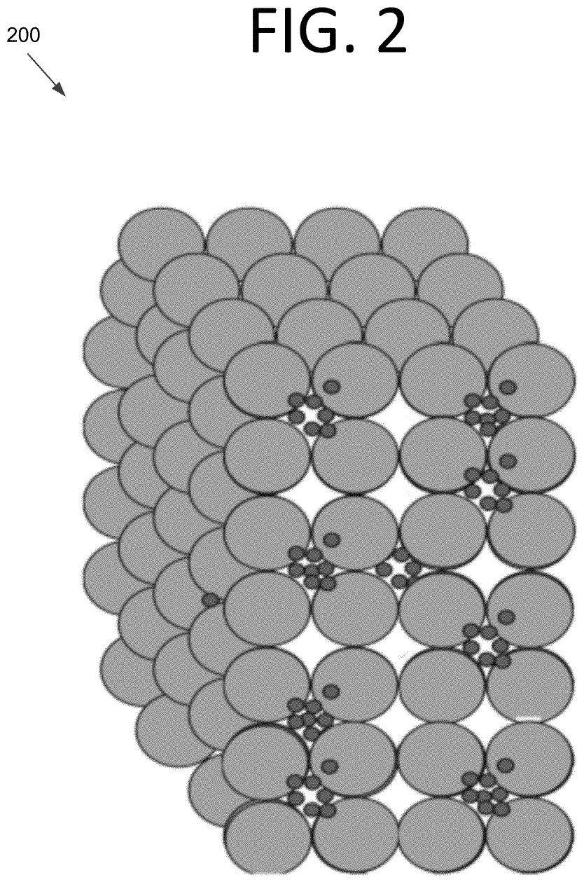

A deuterated or tritiated metal (e.g., lithium deuteride (LiD)) may be used to create an environment where electrons are well screened (i.e., deep screening). In certain embodiments, LiD is used with a sufficiently high photon energy to photodissociate the lithium, resulting in production of hot tritium or deuterons. A portion of such a deuterated metal lattice 200 is shown in FIG. 2. It should be noted that the metal may be one or more of lithium, boron, beryllium, a high Z metal, etc. In other words, different deuterated and/or tritiated metals may be included in the metal lattice of FIG. 2. The metal lattice provides both the electrons for deep screening and a “cage” so the deuterons themselves can be at a high density and may further participate in reactions subsequent to the primary fusion reaction via multiple routes.

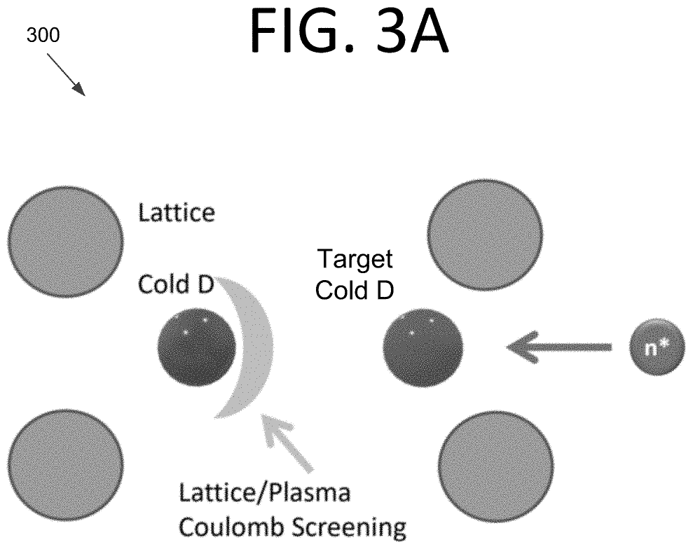

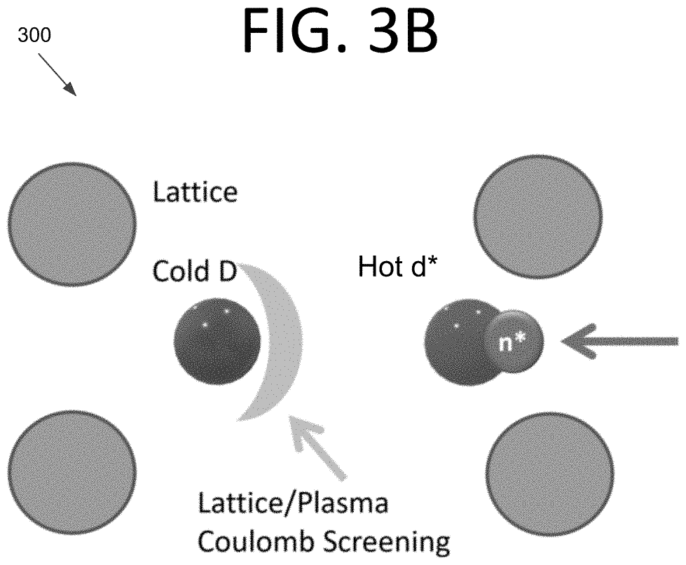

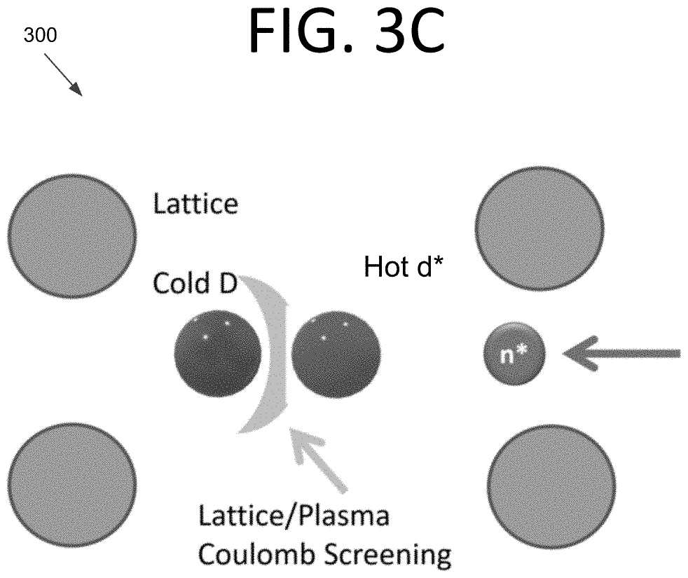

The metal lattice is bombarded with neutrons from a neutron source that provides a desired rate of neutron production. See, for example, step 300 of FIG. 3A. In FIG. 3A, two cold deuterons (D) are contained within a metal lattice. A hot neutron (n*) travels towards the right deuteron (D) in the lattice.

In step 310 of FIG. 3B, the hot neutron (n*) strikes the rightmost of the two cold deuterons (D), imparting energy on that deuteron and making it hot (d*). Only uncharged particles, such as neutrons, may efficiently deliver significant amounts of their kinetic energy in a single elastic collision to a charged deuteron. For example, Table I below provides the scattering cross section and the kinetic energy transfer between various particles, such as light, heavy charged particles, and neutrons, off deuterons at various levels of energy. Only the neutron can deliver a substantial portion of its kinetic energy to the deuteron, while all other charged interactions result in a small amount of kinetic energy being transferred. Therefore, only a deuteron that is heated by elastic collision with a hot neutron may possess sufficient kinetic energy to participate in subsequent nuclear tunneling reactions, whereas all other charged interactions result in only miniscule heating of the deuteron that cannot result in subsequent tunneling.

TABLE I
RESULTING DEUTERON ENERGIES FOR REACTIONS SHOWING
PRIMACY OF NEUTRONS FOR ENERGY TRANSFER

| | | Cross | |
|---|---|---|---|
| Reaction | | Section | Resulting Average |
| (particle, D): | | σ (barns): | Deuteron Energy (eV): |
| Light Particles | Eₑ = 2 MeV | 38.41 kb | 24.75 meV |
| (e⁻, e⁺) | | | |
| Heavy Particles: | Eₚ = 3 MeV | 5.76 Mb | 41.4 meV |
| | E_{d} = 3 MeV | 11.51 Mb | 42.7 meV |
| | E_{α} = 3 MeV | 91.48 Mb | 44 meV |
| Compton γ | E_{γ} = 2 MeV | 49.43 nb | 2.13 keV |
| Neutron | Eₙ = 2.45 MeV | 3 b | 1.09 MeV |

As such, and unlike conventional fusion processes, only one of the two deuterons is heated in this example. This sends the hot deuteron (d*) towards the cold deuteron (D) on the left, the screened Coulomb barrier of which is represented with a crescent shape. In this context, “cold” means kinetic energy measured in milli-electron volts (meV) up to one electron volt (eV), corresponding to eleven thousand degrees Celsius. In contrast, “hot” means kinetic energy is much higher, e.g., as measured in the kilo-electron volt (keV) or mega-electron volt (MeV) range, corresponding to millions of degrees. In step 320 of FIG. 3C, the hot deuteron (d*) collides with the cold deuteron (D), and if the scattering angle is sufficiently large (e.g., greater than or equal to 90°), could subsequently tunnel through the Coulomb barrier of the cold deuteron (D) via quantum tunneling. Because the right deuteron (d*) is hot, the probability of tunneling is relatively high. Both the probabilities of scattering at large angles and tunneling increase with electron screening.

The scattering probability between the neutron and the hot deuteron in such embodiments is much higher than in conventional hot fusion techniques. The neutron parts with a significant portion of its kinetic energy to the hot deuteron such that the latter can tunnel through the electrostatic barrier of another, much cooler deuteron and fuse therewith. Indeed, deep screening works very well if one of the deuterons is orders of magnitude cooler than the other.

This significantly differs from conventional hot fusion reactors, such as Tokamaks, for example. In a Tokamak, the entire fuel is ionized to hundreds of millions of degrees, but the fuel ions are only poorly screened by the hot plasma electrons, although some more modern techniques also include injection of screened atoms. Hot deuterons are elastically scattered off the Coulomb barrier at small angles. This causes the probability that they will scatter away rather than potentially enable subsequent fusion to be very high. Fusion is enabled when deuterons strike one another at large angles (e.g., 90° or more), but this is rare and the tunneling probability is very small. Because a large volume of hot fuel is kept in place within the Tokamak, fusion does occur, in spite of the very low fuel plasma density and dominance of the non-productive low angle Coulomb elastic scattering. However, cooling through the reactor walls and additional losses through Bremsstrahlung radiation also occurs, and a tremendous amount of energy is required to heat, maintain, and contain the fuel—indeed, more than is produced by the Tokamak process.

It should be noted that in the process of some embodiments, the otherwise Bremsstrahlung radiation assists in the further screening process for the high number density fuel, thus further increasing reaction rates. Using the terminology adopted herein, the Tokamak process could be described as a “locally hot—globally hot” process, and it differs from the process of some embodiments of the present invention that could be described as locally hot—globally cold. For example, one important distinction is that the former necessitates working at very low fuel densities to keep the very hot plasma intact, whereas the entire fuel source in some embodiments is kept in a cold and dense state until local reactions occur, and then locally returns to a cold state via diffusion, convection, or radiation of heat through the metal lattice to the external boundary.

A key insight of some embodiments is that if the deuterons are highly screened by electron or plasma screening, the probability that fusion will occur becomes much larger, potentially by many orders of magnitude. Screening increases the 90-180° Coulomb scattering angle chance, as well as the chance that hot deuterons will tunnel once they scatter in such large angles to begin with. Indeed, outside the so called “screening length,” the hot and cold deuterons cannot feel their mutual electrostatic repulsion, and thus in a deep screening case, the two nuclei can approach sufficiently close to one another to allow for nuclear tunneling and subsequent strong force fusion to occur. In the above description, the screening length is a convenient parameter to estimate the extent at which the electrostatic field is felt by other charged particles. The screening length could be estimated and derived for several cases of interest, such as for the case of screening by shell or conduction electrons or plasma electrons created by Compton scattering of gamma photons provided externally to the reacting volume.

With a rate of 1 billion neutrons per second and subsequent process multiplication events via Oppeneheimer-Phillips and other reaction processes, e.g., with LiD as the metal lattice/fuel configuration, leading to, e.g., 10¹⁴ nuclear events per second or tens or hundreds of watts in energy output, and with a metal lattice containing, e.g., a density of 10²² deuterons, there are still 10⁸ seconds of power output, providing for a long duration power source. As such, the reactions are highly localized and only occur sporadically in the deuterated metal lattice. However, since the processes described thus far are clearly sub-critical and directly depend on the externally controlled neutron flux, such processes could be designed to result in a relatively small number of reactions occurring continuously. This causes the deuterated metal lattice to stay relatively cool since the nuclear reaction heat produced locally is able to be dissipated through conduction and other means to the surroundings and not result in melting of the deuterated metal lattice as a whole unless neutrons are emitted at a high enough rate to cause melting, which can be controlled. While the local lattice may melt, conduction carries away the heat, the metal lattice and embedded fuel solidifies, and the surrounding molecules become relatively cool again.

In certain embodiments, a high-pressure gaseous fuel is provided to surround the deuterated metal. Such high pressure could be measured in the tens of thousands of pounds per square inch, leading to fuel density in the gaseous state to approximate that within the metal lattice. This high-pressure gas could participate in nuclear reactions as well. Alternatively, deuterium gas at pressure corresponding to that which is used to load and maintain the high fuel/lattice stoichiometry could be provided to ensure reloading of the lattice following resolidification of the lattice following localized nuclear reactions that lead to localized heating and melting.

Embodiments employing such a process provide complete control over the amount of energy that is produced since the number of neutrons that are delivered can be controlled. Also, if the neutron supply is shut off, the reactions stop. As such, the process is sub-critical. Furthermore, the supply of neutrons can be controlled to throttle power production up or down. Neutrons are used in some embodiments as a key process mediator, efficiently heating of fuel nuclei and their products. Management of neutrons in such embodiments via direct control of their input rate into the reacting volume, as well as their leakage from the same, is a key distinction of such embodiments from other hot fusion processes that rely on highly inefficient charged particle (e.g., alpha) heating to sustain the process.

Such embodiments also provide an element of safety over conventional nuclear reactors. For instance, if the reactor of some embodiments is employed on a satellite, and a rocket intended to carry the satellite into orbit explodes during launch, no nuclear reactions occur since the nuclear fuel may be totally radioactively inert to begin with (e.g., deuterium). Once in orbit, a device such as linear accelerator could be utilized to generate gamma radiation of sufficient energy above the photodisintegration limit of the deuteron (at 2.226 MeV) to yield hot neutrons to start the process of the employed embodiment. However, some embodiments do use radioactive elements (e.g., Californium, Americium, thorium, or any other suitable actinide) as a continuous neutron source to produce hot neutrons in the MeV range. Naturally, the number of neutrons emitted per second decreases over time as the element decays. Nevertheless, the process is well positioned for a compact, long duration, zero maintenance heat source which could then also be converted to electrical output using thermoelectric, Sterling, or other known heat to electrical conversation processes and devices.

The reaction rate R (e.g., the number of reactions per second per cm³) is given by:

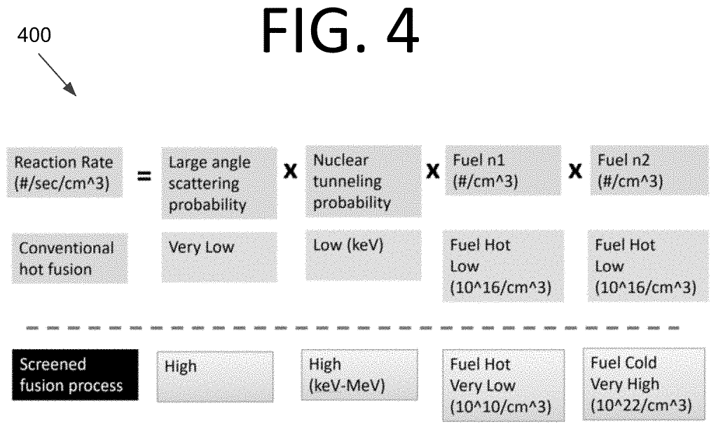

R˜n₁n₂σν (3)

where n₁ and n₂ are fuel densities (e.g., particles per cm³) of neutrons and deuterons, respectively, σ is the reaction cross section, and ν is the kinetic energy. A comparison 400 between a conventional hot fusion process and the deeply screened fusion process of some embodiments is shown in FIG. 4.

For σ to be high, a large angle of scattering plus subsequent tunneling is required. However, σ is relatively low in hot fusion, typically measured in milli-barns or below. Furthermore, in hot fusion, the plasma is about one million times less dense than the deuterium of some embodiments. In other words, hot fusion plasma is extremely rarified. Hot fusion reactors such as Tokamaks still achieve fusion due to a very high reactant volume, and all reactants are very hot. A Tokamak is designed for very large power outputs, whereas some embodiments of the present invention may be designed to produce lower levels of power, e.g., 100 watts, 1,000 watts, etc. These embodiments may have useful lifetimes of 20 to 30 years or more without being touched. Furthermore, in embodiments of the present invention, one reactant is locally hot whereas the other is globally cold, enabling fusion reactions to occur at a relatively small number of locations within the sample. For instance, 10¹⁴ reactions per second producing watt-level power may involve only around 10⁻⁹ of a relatively small deuterated sample containing 1 mole of material.

FIG. 5 is a flow diagram 500 illustrating a deeply screened fusion process, according to an embodiment of the present invention. A neutron source (natural or photo) inputs hot neutrons (1−n) into a deuterated lithium fuel. A “*” denotes a hot particle herein. The initial reactions between the hot neutrons (n*) and the deuterons (d) or lithium, or between hot deuterons (d*), create He-3, alpha particles, and tritium (T). The output of the first pass is two hot alpha particles, two hot protons, two hot neutrons, and heat. As further shown, the simple combination of LiD (naturally containing both Li-6 and Li-7 isotopes) may result in a process that produces more neutrons per cycle. Since neutrons may effectively escape the reaction volume and participate in other processes not conducive for nuclear reactions, the entire net output of such an example multiplication process depends on effective management of neutrons and their interactions with the surroundings.

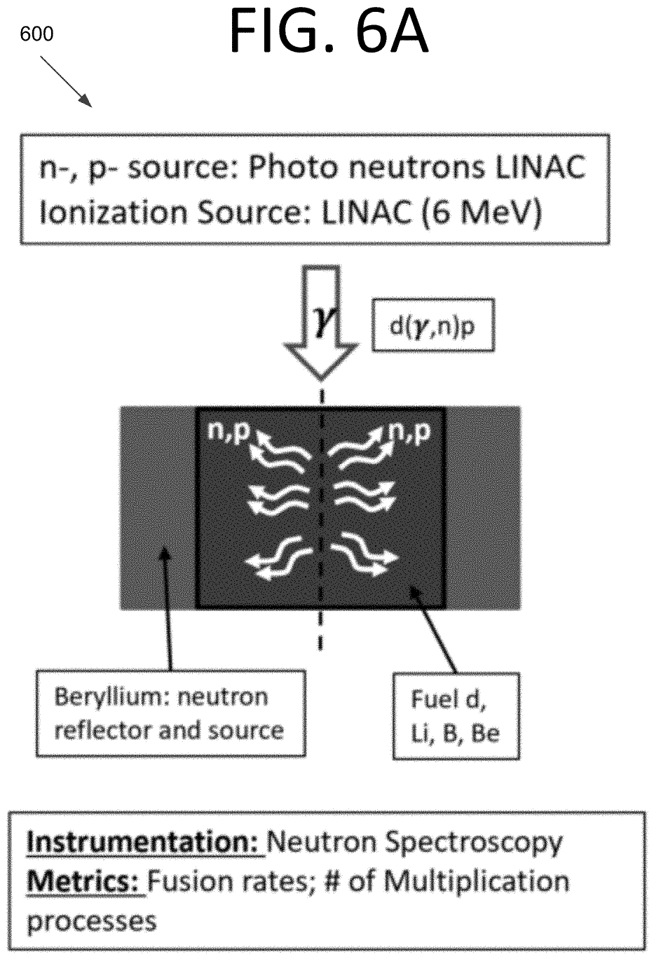

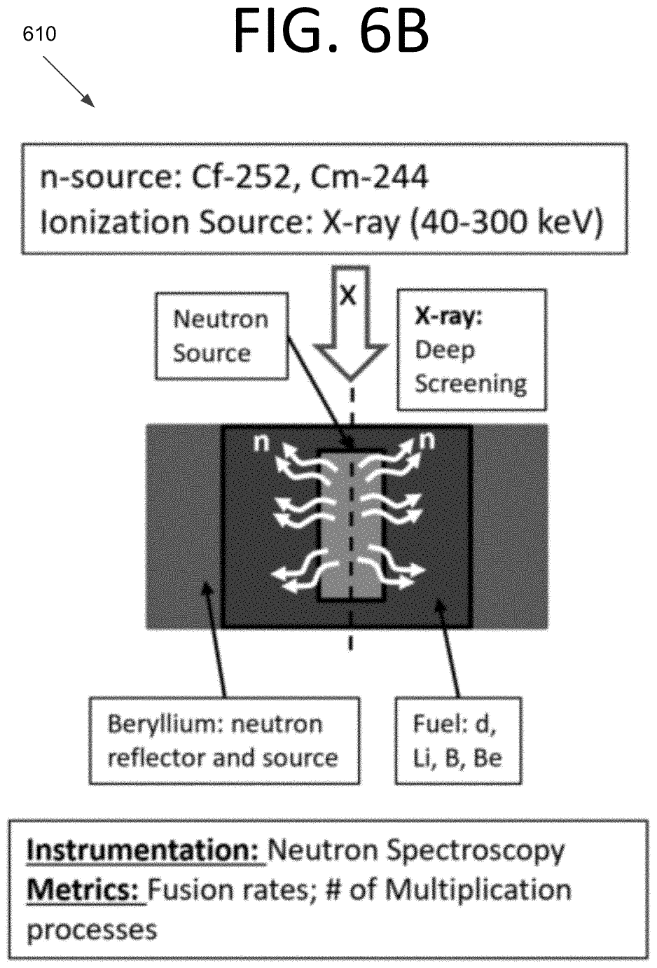

FIG. 6A illustrates a deeply screened nuclear reaction process 600 that uses photo neutrons, according to an embodiment of the present invention. Photo neutrons are produced by photodisintegration of the deuterium fuel by gamma radiation produced via a linear accelerator (LINAC), which also serves as an ionization source for creation of a deeply screened environment for efficient tunneling and scattering events in some embodiments. The hot photo neutrons are sent into a deuterated fuel (e.g., deuterium contained within lithium, boron, beryllium, high Z metals or other materials capable of being deuterated, etc.), which is located within a beryllium neutron reflector and source. Fusion reactions (and other reactions) then occur as shown and described in FIGS. 3A-5.

FIG. 6B illustrates a deeply screened nuclear reaction process 610 that uses a radioactive neutron source, according to an embodiment of the present invention. Hot neutrons are emitted by a radioactive material (e.g., Californium, Curium, etc.). An x-ray device provides an ionization source for deep screening. The x-rays are sent into the deuterated fuel (e.g., deuterium contained within lithium, boron, beryllium, actinide series elements (e.g., UD₃), etc.). The deuterated fuel, in turn, is located within a beryllium neutron reflector that also contains the radioactive material source. Fusion reactions (and other reactions) then occur as shown and described in FIGS. 3A-5.

In some embodiments, a nuclear active process is employed that combines activation via the introduction of hot neutrons into a high-density deuteron environment within a metal lattice that may optionally include high Z elements in combination with, or including, lithium, boron, or other elements. The hot neutrons efficiently heat the cold deuterons via elastic collisions, and the hot deuterons are deeply screened from other cold deuterons or from the cold lattice nuclei by a combination of shell or conduction electrons, or by Compton electrons produced by optionally irradiating the deuterated material via x-rays or gamma rays. The large angle scattering and nuclear tunneling probabilities of the hot deuteron with cold deuterons or from the cold lattice nuclei is increased by the deep screening. Hot neutrons are generated by fusion of the hot and cold deuterons, secondary fusion reactions (e.g., with He-3 or tritium generated from a primary d-D reaction and other subsequent reaction products), Oppenheimer-Phillips reactions, other nuclear reactants generated by breaking down of deuterons or lithium, and/or related secondary processes leading to multiplication of nuclear events. In certain embodiments, a system includes deuterated metal, a hot neutron source generated via a gamma source of sufficient energy to photodisintegrate a deuteron or via natural decay processes of radioactive isotopes, and optionally, additional material capable of participating in multiplication processes including, but not limited to, lithium and an external envelop including beryllium or actinide nuclei, such as natural uranium, thorium, etc., to reflect or participate in nuclear reactions, or manage the neutron balance and kinetic energy thereof.

Theoretical Analysis

Nuclear fusion reactions of d-D are examined below in an environment including high density cold fuel embedded in metal lattices, in which a small fuel portion is activated by hot (i.e., “thermal”) neutrons. Such an environment provides enhanced screening of the Coulomb barrier due to conduction and shell electrons of the metal lattice, or by plasma induced by ionizing radiation (γ-quanta). It is shown herein that kinetic energy transfer to fuel nuclei (D) by neutral particles, such as energetic neutrons or photons, is far more efficient than by energetic charged particles, such as light particles (e⁻, e⁺) or heavy particles (p, d, α).

It is known that screening increases the probability of tunneling through the Coulomb barrier. Electron screening also significantly increases the probability of large versus small angle Coulomb scattering of the reacting nuclei to enable subsequent nuclear reactions via tunneling. This probability is incorporated into the astrophysical factor, S(E). Aspects of screening effects to enable calculation of nuclear reaction rates are also evaluated herein, including Coulomb scattering and localized heating of the cold fuel, primary d-D reactions, and subsequent reactions with both the fuel and the lattice nuclei.

The effect of screening for enhancement of the total nuclear reaction rate is a function of multiple parameters, including fuel temperature and the relative scattering probability between the fuel and lattice metal nuclei. Screening also significantly increases the probability of interaction between hot fuel and lattice nuclei, increasing the likelihood of Oppenheimer-Phillips processes opening a potential route to reaction multiplication. It is demonstrated that the screened Coulomb potential of the target ion is determined by the nonlinear Vlasov potential and not by the Debye potential.

In general, the effect of screening becomes important at low kinetic energies of the projectile. The range of applicability of both the analytical and asymptotic expressions is examined herein for the known electron screening lattice potential energy Uₑ, which is valid only for E>>Uₑ (E is the energy in the center of mass reference frame). It is demonstrated that for E≤Uₑ, a direct calculation of the Gamow factor for screened Coulomb potential should be performed to avoid unreasonably high values of the enhancement factor f(E) by the analytical and asymptotic formulae.

Electron screening is essential for efficient nuclear fusion reactions to occur. Screening effects on fusion reaction rates as measured in deuterated materials have been demonstrated to be important. The nuclear reaction rate includes two primary factors: (1) the Coulomb scattering of the projectile nuclei on the target nuclei; and (2) nuclei tunneling through the Coulomb barrier. During elastic scattering of charged projectiles on a target nucleus, such as a deuteron, some of the energy of the projectile particle is transferred to the target nucleus, thus heating it. Depending on the projectile particle energy and the efficiency of kinetic energy transfer during the scattering event, the target deuteron may become energetic enough to enable subsequent nuclear fusion reactions via tunneling through the Coulomb barrier of another atom's nucleus. Electron screening may play a significant role in this process due to hot fuel interacting with lattice nuclei in the highly screened environment, as has been demonstrated in the experiments discussed in more detail below. This analysis focuses on analyzing the electron screening effect on Coulomb scattering and the tunneling process involving charged projectiles. It is then demonstrated that superior efficiency of kinetic energy transfer by uncharged projectile particles such as photons or neutrons on the on the target deuteron nucleus occurs. Such a process may facilitate achieving and sustaining nuclear reactions.

The nuclear fusion reactions in high density hydrogen isotopes (fuel) embedded in metal lattices are examined, when a small fraction of fuel nuclei is heated by energetic photo neutrons. Such a setup supports enhanced screening of the Coulomb barrier between fuel ions by conduction and shell electrons of the metal lattice. Electron screening significantly increases the probability of large versus small angle Coulomb scattering of the reacting nuclei to facilitate subsequent nuclear reactions via tunneling. This enhanced probability is integrated into the astrophysical factor S(E).

Electron screening also increases the probability of fuel ions tunneling through the Coulomb barrier. Furthermore, screening significantly increases the probability of interaction between hot fuel and lattice nuclei due to Oppenheimer-Phillips processes, which could open potential routes to reaction multiplication. The applicability of the electron screening potential energy Uₑ for the calculation of the enhancement factor f(E) to the nuclear fusion cross section is examined. The expression of Uₑ is also derived for general screening process using a unifying concept of a screening length λ_{sc}. It was found that energetic neutrons provide the most effective heating of fuel ions to initiate nuclear fusion reactions in condensed matter, in comparison with heating via energetic charged particles. The above effects were integrated into an overall analysis of a nuclear fusion process that could be used as a theoretical basis for understanding, designing, and optimizing of experiments, such as those discussed below.

I. Nuclear Fusion Cross-Section of Bare Nucleus Ions

In the standard case of sub-barrier quantum tunneling through the Coulomb barrier between positive nucleus ions, the nuclear fusion cross-section of bare nucleus ions σ_{bare}(E) can be written as:

$${σ}_{bare} ( E ) = \frac{S ( E )}{E} \cdot exp ( - G ( E ) ) \qquad ( 5 )$$

where E is the energy in the center of mass (CM) reference frame, G (E) is the Gamow factor, and S(E) is the astrophysical S-factor containing the details of nuclear interactions. In the non-relativistic case, the relation between energy E in the CM frame and the kinetic energy K_{1∞} of the projectile nucleus ion in the laboratory (lab) frame takes the relatively simple form:

$${K}_{1 ∞} ≡ \frac{{{m}_{1} ( {\vec{v}}_{1 ∞} )}^{2}}{2} = ( 1 + \frac{{m}_{1}}{{m}_{2}} ) E \qquad ( 6 )$$

In the lab frame, the target nucleus ion with mass m₂ is at rest (i.e., \vec{v}₂=0) and the projectile nucleus ion with mass m₁ has a velocity of \vec{v}_{1∞} at infinity.

In Wentzel-Krammers-Brilloin (WKB) approximation, the Gamow factor G(E) involves the evaluation of the following integral:

$$G ( E ) = \frac{2}{ℏ} {{\int }_{{r}_{0}}}^{{r}_{ctp}} {[ 2 μ \{ {U}_{C} ( r ) - E \} ]}^{1 / 2} dr \qquad ( 7 )$$

Here, ℏ is the reduced Planck constant, U_{C}(r) is the Coulomb potential energy U_{C}(r)=Z₁e·Z₂e/r (i.e., the Coulomb barrier) of a projectile nucleus with charge Z₁e in the Coulomb field Z₂e/r of the target nucleus, μ=m₁m₂/(m₁+m₂) is the reduced mass of the projectile and target nuclei, r₀=(R₁+R₂) is the classical distance of closest approach with nuclei (effective) radii R₁ and R₂, and r_{ctp} is the classical turning point, determined from the following expression:

$$E = {U}_{C} ( {r}_{ctp} ) \to {r}_{ctp} = \frac{{Z}_{1} e \cdot {Z}_{2} e}{E} \qquad ( 8 )$$

Evaluation of the integral in Eq. (7) gives the standard expression for the Gamow factor:

$$G ( E ) = {( \frac{{E}_{G}}{E} )}^{1 / 2} \cdot [ \frac{2}{π} \{ {cos}^{- 1} \sqrt{\frac{E}{{V}_{C}}} - \sqrt{\frac{E}{{V}_{C}} ( 1 - \frac{E}{{V}_{C}} )} \} ] \qquad ( 9 )$$

where V_{C}=(Z₁e)(Z₂e)/r₀ is the full height of the Coulomb barrier, E_{G}=2 μc²(παZ₁Z₂)² is the Gamow energy, and α=e²/ℏc.

In the limit of

$$\sqrt{\frac{E}{{V}_{C}}} << 1$$

(what is usually the case), the Gamow factor reduces to the relatively simple Sommerfeld expression:

$${G}_{C , asymptotic} ( E ) = {( \frac{{E}_{G}}{E} )}^{1 / 2} \cdot ( 1 - \frac{4}{π} \sqrt{\frac{E}{{V}_{C}}} + … ) \to {( \frac{{E}_{G}}{E} )}^{1 / 2} \qquad ( 10 )$$

II. Nuclear Fusion with Electron Screening

A. Coulomb Barrier Screening by Lattice Electrons

In experiments with deuteron beams and deuterated targets, when target deuterium nuclei (D) were embedded in insulators and semiconductors, a relatively small enhancement of nuclear reaction rates was found for D(d, p)t nuclear fusion reactions as compared to reactions with gaseous D₂ target experiments. These enhancements of reaction rates for D(d, p)T nuclear reactions in host insulators and semiconductors are naturally explained by the screening of interacting nuclei with static electron clouds localized in atomic shells of host materials. Collectively, shell electrons produce a negative screening potential for the projectile nucleus, effectively reducing the height and spatial extension of the Coulomb barrier between interacting nuclei.

However, much larger effects have been readily measured with deuterated metal targets (excluding the noble metals, such as copper (Cu), silver (Ag), and gold (Au)). A large enhancement of the nuclear reaction rates for D(d, p)T fusion reactions in host metals could be considered as the result of an additional dynamic screening by free-moving conduction electrons, which are readily concentrated near the positive ions. These screening effects are collectively referred to as “lattice screening.”

Electron screening of target nuclei either by atomic shell electrons or conduction electrons are usually both approximated by a negative uniform shift −Uₑ of the Coulomb barrier U_{C}(r). Here, Uₑ is the electron screening potential energy and is given by the formula:

$${U}_{e} = \frac{{Z}_{1} e \cdot {Z}_{2} e}{{λ}_{sc}} \qquad ( 11 )$$

where Z₁ and Z₂ are the atomic number of projectile and target nuclei, respectively, and λ_{sc} is the corresponding screening length. The standard derivation of Eq. (11) and the effect of electron screening can be straightforwardly estimated by recalculating the Gamow factor G(E) in Eq. (7) by replacing the Coulomb potential energy U_{C}(r) with the general expression for the screened Coulomb potential energy U_{C,sc}(r):

$${U}_{C , sc} ( r ) = \frac{{Z}_{1} e \cdot {Z}_{2} e}{r} \cdot exp ( - \frac{r}{{λ}_{sc}} ) \qquad ( 12 )$$

The radial distance r in Eq. (7) is less than or equal to the classical turning point r_{ctp} given by Eq. (8), which, in turn, is generally much smaller than the characteristic distance of electron cloud distribution from reacting nuclei, which is the corresponding screening length λ_{sc}. In other words:

r₀≤r≤r_{ctp}<<λ_{sc} (13)

One can expand

$$( - \frac{r}{{λ}_{sc}} ) = ( 1 - \frac{r}{{λ}_{sc}} )$$

in Eq. (12) to find that the screened Coulomb potential energy U_{C,sc}(r) (i.e., the screened coulomb barrier) can be rewritten as:

$${U}_{C , sc} ( r ) = \frac{{Z}_{1} e \cdot {Z}_{2} e}{r} \cdot ( 1 - \frac{r}{{λ}_{sc}} ) = \frac{{Z}_{1} e \cdot {Z}_{2} e}{r} - \frac{{Z}_{1} e \cdot {Z}_{2} e}{{λ}_{sc}} = {U}_{C} ( r ) - {U}_{e} \qquad ( 14 )$$

with the standard Coulomb barrier U_{C}(r) as:

$${U}_{C} ( r ) = \frac{{Z}_{1} e \cdot {Z}_{2} e}{r} \qquad ( 15 )$$

and the electron screening potential energy Uₑ determined as:

$${U}_{e} = \frac{{Z}_{1} e \cdot {Z}_{2} e}{{λ}_{sc}} \qquad ( 16 )$$

Therefore, the concept of an electron screening potential energy Uₑ, introduced above in Eqs. (11)-(15), can be theoretically justified if the classical turning point r_{ctp} is much smaller than the corresponding screening length λ_{sc}. This condition, stated in Eq. (13), can be rewritten as:

E>>Uₑ (17)

using the definition of the classical turning point given by Eq. (8).

For low energies, where E≤Uₑ, the concept of an electron screening potential energy Uₑ given by Eqs. (11)-(15) is not applicable, and the direct numerical evaluation of the Gamow factor G(E) in Eq. (7) with the screened Coulomb potential energy U_{C,sc}(r) from Eq. (12) is required.

It is known that the lowering of U_{C}(r) by Uₑ is equivalent to the increase of E by Uₑ, as can be seen in Eq. (7)—namely, [U_{C}(r)−Uₑ]−E=U_{C}(r)−(E+Uₑ). The uniform shift Uₑ is called the “electron screening potential energy.”

Therefore, the experimentally measured tunneling probability σₑₓₚ(E) in a screened target at the ion energy E in the CM frame can be evaluated as the experimentally measured tunneling probability for bare ion collisions at higher energy (E+Uₑ):

σₑₓₚ(E)≡σ_{screen}(E)=σ_{bare}(E+Uₑ) (18)

The experimental fusion cross-section σₑₓₚ(E) can be written as:

σₑₓₚ(E)=σ_{bare}(E)·f(E) (19)

which is essentially the definition of the enhancement factor f(E).

From Eq. (5), the expression for an enhancement factor f_{U}_{ₑ}(E) can be written as:

$${f}_{{U}_{e}} ( E ) = \frac{S ( E + {U}_{e} )}{S ( E )} \cdot \frac{E}{( E + {U}_{e} )} \cdot exp [ {G}_{C} ( E ) - {G}_{C} ( E + {U}_{e} ) ] \qquad ( 20 )$$

In the case of S(E+Uₑ)≅S(E), which is usually the general case, the enhancement factor f_{U}_{ₑ}(E) can be written as:

$${f}_{{U}_{e}} ( E ) = \frac{E}{( E + {U}_{e} )} \cdot exp [ {G}_{C} ( E ) - {G}_{C} ( E + {U}_{e} ) ] \qquad ( 21 )$$

In the limit of

$$\sqrt{\frac{E}{{V}_{C}}} << 1 ,$$

Eq. (20) is further reduced to the following asymptotic formula:

$${f}_{{U}_{e} , asymptotic} ( E ) = \frac{E}{( E + {U}_{e} )} \cdot exp [ \frac{{U}_{e}}{2 E} {( \frac{{E}_{G}}{E} )}^{1 / 2} ] \qquad ( 22 )$$

following from Eq. (10).

For low energy (when E≤Uₑ), the concept of an electron screening potential energy Uₑ given by Eqs. (11)-(15) is not applicable, and the direct numerical evaluation should be used. For the Gamow factor G_{direct}(E) in Eq. (7) with U_{C}(r)→U_{C,sc}(r),

$${G}_{direct} ( E ) ≡ {G}_{C , sc} ( E ) = \frac{2}{ℏ} {{\int }_{{r}_{0}}}^{{r}_{ctp}^{*}} {[ 2 μ \{ {U}_{C , sc} ( r ) - E \} ]}^{\frac{1}{2}} dr \qquad ( 23 )$$

where r_{ctp}* is the modified classical turning point determined numerically from the following equation:

$${U}_{C , sc} ( {r}_{ctp}^{*} ) = \frac{{Z}_{1} e \cdot {Z}_{2} e}{{r}_{ctp}^{*}} \cdot exp ( - \frac{{r}_{ctp}^{*}}{{λ}_{sc}} ) = E \qquad ( 24 )$$

where the screened Coulomb potential energy U_{C,sc}(r) is obtained from Eq. (12).

The enhancement factor in this case is equal to:

f_{direct}(E)=exp[G_{C}(E)−G_{direct}(E)] (25)

where G_{C}(E) is determined from Eq. (9).

Table II presents the calculated values of enhancement factors for deuterated erbium (ErD₃) for various levels of energy of interest. Note that Uₑ was calculated using Eqs. (54) or (62) noted below and was found to be Uₑ=347 eV.

TABLE II
ENHANCEMENT FACTOR VALUES FOR DEUTERATED ERBIUM

| E, | f_{direct} (E) | f_{U}_{ₑ} (E) | f_{U}_{ₑ}_{,asymptotic} (E) | f_{U}_{ₑ} (E)/ | f_{U}_{ₑ}_{,asymptotic} (E)/ |
|---|---|---|---|---|---|
| eV | Eq. (25) | Eq. (21) | Eq. (22) | f_{direct}(E) | f_{direct} (E) |
| ½Uₑ | 1.09 × 10¹² | 2.36 × 10¹³ | 1.90 × 10³² | 21.5 | 1.70 × 10²⁰ |
| Uₑ | 9.89 × 10⁵ | 3.09 × 10⁶ | 1.96 × 10¹¹ | 3 | 2.00 × 10⁵ |
| 2Uₑ | 539 | 676 | 8286 | 1.25 | 15.4 |
| 3Uₑ | 45.7 | 46.4 | 127 | 1.017 | 2.8 |

Note, for example, that the value of 3Uₑ corresponds to a 2 keV kinetic energy of the projectile in the lab frame, illustrating that the analytical formula for f_{U}_{ₑ}(E) is valid, but the asymptotic formula for the enhancement factor is still inappropriate. Since the electron screening effect becomes important at low kinetic energy of the projectile, direct numerical calculation of the Gamow factor should be used for accurate results.

The above equations show a sharp rise in enhancement factor f(E) for deuterium interaction with host metals, especially at moderately low deuteron energies. The enhancement factor f(E) further increases with Z and with decreasing projectile energy. This may enable Oppenheimer-Phillips stripping reactions, resulting in the production of energetic protons and neutrons, and providing a possible route for multiplication. Such Oppenheimer-Phillips stripping reactions appear to have been observed in the experimental work described below.

Measured Uₑ for Select Targets: The experimental values for electron screening potential energies are Uₑ=25±15 eV for gaseous targets and Uₑ=39 to 52 eV for deuterated insulators and semiconductors targets. However, for deuterated metal targets, much larger values of electron screening potential energies Uₑ are measured, ranging from Uₑ=180±40 eV for beryllium to Uₑ=800±90 eV for palladium. The exclusion is observed for deuterated noble metal targets, namely, Uₑ=43±20 eV (Cu), Uₑ=23±10 eV (Ag), and Uₑ=61±20 eV (Au).

Theoretical values for Uₑ, considering screening by static electron clouds localized in atomic shells of host materials, that are calculated in the adiabatic limit utilizing differences in atomic binding energies, correlate well with experimentally measured values for Uₑ for gaseous targets, as well as for deuterated insulators and semiconductors targets. In contrast, theoretically calculated values of screening potential energies Uₑ by static electron clouds in atomic shells of host most metals are almost one order of magnitude smaller than values of electron screening potential energies Uₑ experimentally measured for deuterated alkaline metal targets. These discrepancies require a different physical mechanism for theoretical clarification of the experimental results. The novel physical mechanism, which takes into account the presence of quasi-free-moving conduction electrons in metals as an additional source for screening of interacting nuclei, is discussed later herein.

B. Coulomb Barrier Screening by Plasma Particles

In deuterated materials exposed to ionizing radiation (γ-quanta or energetic electron e-beam) dense plasma channels are created inside an irradiated sample including non-equilibrium two-temperature plasma with free moving hot electrons and free-moving cold deuteron ions. Energetic electrons in plasma cannot create a bound state with deuteron ions because the mean kinetic energy of hot electrons (K̅ₑ˜kTₑ) is much larger than the Coulomb interaction (Ūᵢₑ˜qᵢ·qₑ/r̅) between them:

K̅ₑ>>|Ūᵢₑ| (26)

The inequality in Eq. (22) represents the condition required for plasma existence, and can also be written as:

kTₑ>>e²·n^{1/3} (27)

using the fact that the mean distance r̅ between ions is on the order of n^{1/3}:

r̅˜n^{1/3} (28)

Introducing the Debye length λ_{De}, which is defined as:

$${λ}_{De} = {( \frac{{kT}_{e}}{4 π {e}^{2} n} )}^{1 / 2} \qquad ( 29 )$$

Eq. (27) can be rewritten in light of Eq. (28) as:

$${λ}_{De}^{2} ≫ \frac{{\overline{r}}^{2}}{4 π} \to {λ}_{De} ≻ \frac{\overline{r}}{\sqrt{4 π}} ≅ 0.28 \cdot \overline{r} \qquad ( 30 )$$

Eq. (30) indicates that in plasma, the Debye length λ_{De} is larger by order of magnitude than the mean distance r̅ between ions.

It also follows from Eqs. (28) and (30) that the number of electrons in the electron Debye sphere N_{De} in plasma is much larger than one:

$${N}_{De} \sim n \cdot ( \frac{4 π}{3} \cdot {λ}_{De}^{3} ) ≫ 1 \qquad ( 31 )$$

Therefore, the statement λ_{De} [symbol] 0.28·r̅ as given by Eq. (30), and the equivalent statement N_{De}>>1 in Eq. (31), follow from the plasma existence requirement of K̅ₑ>>|Ūᵢₑ|, which is expressed in Eq. (26).

The undisturbed plasma in plasma channels is electroneutral, with the total electric charge density Q₀ being equal to zero in each unit volume:

Q₀=qᵢ·nᵢ₀+qₑ·nₑ₀=0 (32)

where nᵢ₀ is the undisturbed mean ion number density, nₑ₀ is the undisturbed mean electron number density, qᵢ is the ion electrical charge, and qₑ is the electron electrical charge. It follows from Eq. (32) that the electron and ion undisturbed number densities nₑ₀ and nᵢ₀, respectively, are equal to each other if qᵢ−qₑ=e:

Q₀=qᵢ·nᵢ₀+qₑ·nₑ₀=0→n≡nₑ₀≡nᵢ₀ (33)

However, the long-range Coulomb forces between ions in the plasma act at distances that are much larger than the mean distance r̅ between plasma particles. The interaction between any two charged ions at such distances is influenced by the presence of a large number of charged particles. Consequently, the resulting effective field is collectively produced by many charged particles, and naturally described by the self-consistent Vlasov field, which is not a random one, but rather macroscopically certain. In other words, it does not cause the entropy of the system to increase.

In accord with the above description, each ion in the plasma can be considered as surrounded by a spherically symmetrical (on average) charged ion cloud with non-uniform charge density distribution Q(r):

Q(r)=qᵢ·nᵢ(r)+qₑ·nₑ(r) (34)

where r is the distance from the ion (located at r=0). Here, nₑ(r) is the electron number density and nᵢ(r) is the ion number density, both distributed in the self-consistent Vlasov potential field φ(r) around the ion in consideration.

Since in the Vlasov field φ(r) the potential energy of an electron is qₑ·φ(r) and the potential energy of the ion is qᵢ·φ(r), the corresponding electron number density nₑ(r) and ion number density nᵢ(r) are both given by the corresponding Boltzmann's distribution:

$$\begin{matrix}{n}_{e} ( r ) = {n}_{e 0} \cdot exp [ \frac{{q}_{e} \cdot φ ( r )}{{kT}_{e}} ] & ( 35 ) \\ {n}_{i} ( r ) = {n}_{i 0} \cdot exp [ \frac{{q}_{i} \cdot φ ( r )}{{kT}_{i}} ] & ( 36 )\end{matrix}$$

where Tₑ and Tᵢ are the electron and ion temperatures, respectively. Here, nₑ₀ and nᵢ₀ are the mean electron and ion number densities, respectively, in undisturbed plasma.

The Vlasov potential φ(r) in the ion cloud around any considered ion obeys the nonlinear electrostatic Poisson's equation (the Vlasov equation):

$${\vec{∇}}^{2} φ = \frac{1}{{r}^{2}} \frac{\partial }{\partial r} [ {r}^{2} \frac{\partial φ ( r )}{\partial r} ] = - 4 π \cdot Q ( r ) = 4 π \cdot Q ( φ ( r ) ) \qquad ( 37 )$$

where the total electric charge density Q(r) is the nonlinear function in φ(r), as given by Eq. (34) together with Eqs. (35) and (36).

The solution of the Vlasov equation in Eq. (37) should be used in the evaluation of the Gamow factor in Eq. (7) for the screened Coulomb barrier U_{C,sc}. For the projectile nucleus with charge +e in the Vlasov potential field φ(r) of target nucleus with charge qᵢ=+e, the screened Coulomb barrier U_{C,sc} is by definition:

U_{C,sc}=e·φ(r) (38)

At a large distance from the considered ion (located at r=0), the Vlasov field goes to zero (φ(r→∞)→0) since it describes the deviation from reference potential of unperturbed plasma. Thus,

nₑ(r→∞)→n≡nₑ₀ (39)

nᵢ(r→∞)→n≡nᵢ₀ (40)

As the undisturbed plasma is electroneutral, the total electric charge density Q₀ is equal to zero in each unit volume:

Q(r→∞)→Q₀=qᵢ·nᵢ₀+qₑ·nₑ₀=0→n≡nₑ₀≡nᵢ₀ (41)

See Eqs. (32) and (33).

Since the Vlasov potential φ(r) is small at a large distance r from the ion (located at r=0), the ion and electron charge density distributions can be reduced to linear expressions in terms of φ(r):

$$\begin{matrix}{n}_{e} ( r ) = {n}_{e 0} ( 1 - \frac{{q}_{e}}{{kT}_{e}} \cdot φ ( r ) ) & ( 42 ) \\ {n}_{i} ( r ) = {n}_{i 0} ( 1 - \frac{{q}_{i}}{{kT}_{i}} \cdot φ ( r ) ) & ( 43 )\end{matrix}$$

Leading to a linear expression in φ(r) for the total charge density Q(φ(r)):

$$Q ( φ ( r ) ) = {Q}_{0} - ( \frac{{q}_{i}^{2} {n}_{i 0}}{{kT}_{i}} + \frac{{q}_{e}^{2} {n}_{e 0}}{{kT}_{e}} ) φ ( r ) , {Q}_{0} = 0 \qquad ( 44 )$$

Substitution of Eq. (44) into Eq. (37) gives the linearized electrostatic Poisson's equation (Debye equation) for the Vlasov potential φ(r):

$$\frac{1}{{r}^{2}} \frac{\partial }{\partial r} [ {r}^{2} \frac{\partial φ ( r )}{\partial r} ] = \frac{1}{{λ}_{D}^{2}} \cdot φ ( r ) \qquad ( 45 )$$

where λ_{D} is the Debye screening length in two-component, two-temperature plasma:

λ_{D}⁻²=λ_{Di}⁻²+λ_{De}⁻² (46)

where λ_{Di} and λ_{De} are the ion and electron Debye lengths, respectively. They are defined as:

$$\begin{matrix}{λ}_{Di} = {( \frac{{kT}_{i}}{4 π \cdot {n}_{i 0} \cdot {e}^{2}} )}^{1 / 2} & ( 47 ) \\ {λ}_{De} = {( \frac{{kT}_{e}}{4 π \cdot {n}_{e 0} \cdot {e}^{2}} )}^{1 / 2} & ( 48 )\end{matrix}$$

If the electron temperature Tₑ Is much higher than the ion temperature Tᵢ (i.e., hot electrons and cold ions), then the Debye screening length λ_{D} for two-component, two-temperature plasma is determined by the ion Debye length λ_{Di}:

$${T}_{e} ≫ {T}_{i} \to {λ}_{D} = {λ}_{Di} = {( \frac{{kT}_{i}}{4 π \cdot {n}_{e 0} \cdot {e}^{2}} )}^{1 / 2} \qquad ( 49 )$$

as it follows from Eqs. (46)-(48).

Near the ion with charge q₁=+e (located at r=0), the Vlasov potential φ(r) reduces to the Coulomb potential qᵢ/r generated by this ion:

$$φ ( r \to 0 ) \to \frac{{q}_{i}}{r} \qquad ( 50 )$$

The exact solution of the Debye equation, Eq. (45), for the Debye potential φ_{D}(r) that satisfies the boundary condition expressed by Eq. (42), takes the following form known as the Debye potential:

$${φ}_{D} ( r ) = \frac{{q}_{i}}{r} \cdot exp ( - \frac{r}{{λ}_{D}} ) \qquad ( 51 )$$

The usual approximation of the Vlasov potential φ(r) that obeys nonlinear Eq. (37) by the linear Debye potential φ_{D}(r) is expressed by Eq. (51) with the correct boundary condition from Eq. (50), which is extensively used in the nonlinear theory of plasma sheaths.

This approximation can also be used to obtain the analytical expression for the plasma-screened Coulomb barrier U_{C,sc}. The Debye potential energy U_{D}(r) of the projectile nucleus with charge +e in the Debye potential field φ_{D}(r) of the target nucleus with charge qᵢ=+e, given by Eq. (51), by definition is as follows:

$${U}_{C , sc} ≡ {U}_{V} ( r ) = e \cdot φ ( r ) \approx {U}_{D} = e \cdot {φ}_{D} ( r ) = \frac{{e}^{2}}{r} \cdot exp ( - \frac{r}{{λ}_{D}} ) \qquad ( 52 )$$

In summary, the correct expression for the screened Coulomb barrier U_{C,sc} is determined by the Vlasov potential and not by its linearized version, the Debye potential. The Vlasov potential is valid at any temperature and can be obtained by direct numerical solution of the nonlinear equation, Eq. (37), with the total electric charge density Q(r) given by Eqs. (34)-(36). Alternatively, as commonly done in an evaluation of the nonlinear plasma sheath problem, it is linearized to the Debye potential given by Eq. (51), with the correct boundary condition in Eq. (50), to merge with the Coulomb potential near the bare ion.

In dense non-equilibrium, two-temperature plasma channels created in deuterated metal by γ-ionizing radiation, the electron temperature Tₑ is much higher than ion temperature Tᵢ, and therefore the Debye screening length λ_{D} is determined mainly by the ion Debye length λ_{Di}, as it follows from Eqs. (46)-(48). Therefore, the Debye screening length λ_{D} as given by Eq. (49) converts to:

$${T}_{e} ≫ {T}_{i} \to {λ}_{D} = {λ}_{Di} = {( \frac{{kT}_{i}}{4 π \cdot {n}_{i 0} \cdot {e}^{2}} )}^{\frac{1}{2}} = 4.15 \times {10}^{- 10} cm \qquad ( 53 )$$

since in deuterated erbium ErD₃ exposed to γ-ionizing radiation nᵢ₀=nₑ₀==8×10²² cm⁻³ and Tᵢ=293 K (room temperature). Also, the plasma-particle screening potential energy Uₑ, which is given by Eq. (16) for deuterated erbium ErD₃, becomes equal to:

$${U}_{e} = \frac{{e}^{2}}{{λ}_{D}} = 347 eV \qquad ( 54 )$$

with λ_{D} from Eq. (53).

C. Coulomb Barrier Screening by Conduction Electrons in Metal Lattice

In order to scientifically explain the high values of electron screening potential Uₑ^{exp} experimentally measured for deuterated alkaline metal targets, it has been suggested to take into account the presence of quasi-free moving conduction electrons in metals for screening of interacting nuclei. Indeed, when atoms are tightly packed, such as in solid host metals, wave functions of valence electrons of individual atoms are overlapped, acquiring a considerable kinetic energy K̅_{e,degeneracy} due to quantum degeneracy. The Fermi repulsion is large enough to liberate valence electrons from individual atoms into a sea of conduction electrons since they are identical particles and are truly indistinguishable.

The electron energy K̅_{e,degeneracy}, also called the Fermi energy ε_{F}, can be straightforwardly estimated from the Heisenberg uncertainty relation:

Δₚ_{ₑ}·Δr˜h (55)

The root-mean-square of electron momentum pₑ≡\sqrt{ [symbol]pₑ² [symbol]} is equal to the momentum uncertainty Δpₑ if [symbol] pₑ [symbol] =0:

pₑ=Δpₑ=\sqrt{ [symbol]pₑ² [symbol]}−\sqrt{ [symbol]pₑ [symbol] ²}=\sqrt{ [symbol]pₑ² [symbol]} (56)

and Δr is of the order of the characteristic distance between electrons r̅ which, in turn, is of the order of nₑ^{-1/3}:

Δr˜r̅≅nₑ^{-1/3} (57)

where nₑ is the electron number density. The value of pₑ is obtained from Eqs. (37)-(39):

$${p}_{e} ∼ \frac{ℏ}{\overline{r}} ≅ ℏ \cdot {n}_{e}^{- 1 / 3} \qquad ( 58 )$$

Then the Fermi energy ε_{F} is estimated to be:

$${\overline{K}}_{e , degeneracy} ≡ {ɛ}_{F} ∼ \frac{{p}_{e}^{2}}{{m}_{e}} ≅ \frac{{ℏ}^{2}}{{m}_{e}} \cdot {n}_{e}^{2 / 3} \qquad ( 59 )$$

More precise calculation of the Fermi energy ε_{F} for degenerate electron gas is given by:

$${ɛ}_{F} = \frac{{( 3 {π}^{2} )}^{2 / 3}}{2} \cdot \frac{{ℏ}^{2}}{{m}_{e}} \cdot {n}_{e}^{2 / 3} = 4.78 \cdot \frac{{ℏ}^{2}}{{m}_{e}} \cdot {n}_{e}^{2 / 3} \qquad ( 60 )$$

It has been previously considered that differences between the Fermi-Dirac and classical (Boltzmann) distributions of the conduction electrons may be expected to be negligible for the electron screening at room temperature. In that simplified model, deuteron ions together with metal conduction electrons were treated as a one-component equilibrium classical plasma, which comprises metallic quasi-free moving conduction electrons (providing plasma screening) and singly-charged localized deuteron ions (not contributing to plasma screening). The Debye screening length in one-component, equilibrium (Tₑ=Tᵢ) classical (Boltzmann) plasma that approximates the screening by conduction electrons, λ_{De,c}, is then reduced to the electron Debye screening length, λ_{De}:

$${λ}_{De , c} = {λ}_{De} = {( \frac{{kT}_{e}}{4 π \cdot {n}_{e 0} \cdot {e}^{2}} )}^{1 / 2} \qquad ( 61 )$$

For deuterated erbium ErD₃ with material parameters nₑ₀=nᵢ₀=8×10²² cm⁻³ and Tₑ=293 K (room temperature), Eq. (61) gives λ_{De,c}=4.15×10⁻¹⁰ cm. Therefore, the conduction electron screening potential energy Uₑ, which is given by Eq. (16) for deuterated erbium ErD₃, is equal to:

$${U}_{e} = \frac{{e}^{2}}{{λ}_{De , c}} 347 eV \qquad ( 62 )$$

with λ_{De,c} from Eq. (61). It should be clear to the skilled artisan that a much better estimate of U_{e,c} can be achieved with Fermi-Dirac statistics for the description of conduction electrons rather than with the classical (Boltzmann) statistics. It is noted that the screening potential values calculated for plasma and conduction electrons are identical, although for different reasons. Indeed, plasma formation may also contribute to screening in non-metal targets, e.g., in dense deuterium gas irradiated by ionizing radiation.

D. Screening of Reacting Hydrogen Isotope Nuclei by Atomic Shell (Bound) Electrons in Deuterated Metals

The screening of ions by atomic shell (bound) electrons is modeled by the Thomas-Fermi model. The Wentzel-Thomas-Fermi screened Coulomb atomic potential (energy) is:

$${V}_{C , sc} ( r ) = \frac{{Z}_{1} e \cdot ( {Z}_{2} \cdot e )}{r} \cdot exp ( - \frac{r}{{λ}_{TF}} ) \qquad ( 63 )$$

where Z₁ and Z₂ are the atomic numbers of projectile and target (host) nuclei, respectively, and for instance, the modified (to better fit experimental data) Thomas-Fermi screening length λ_{TF} (atom size) by atomic shell electrons of host material is given by the following relation:

$${λ}_{TF} = \frac{1.4 \cdot {a}_{0}}{{Z}^{1 / 3}} \qquad ( 64 )$$

where a₀ is the Bohr radius of a₀=5.29·10⁻⁹ cm and Z is the atomic number of the host material.

III. General Screening Case for Reacting Hydrogen Isotope Nuclei

In the general case, taking into account possible simultaneous screening of reacting hydrogen isotope nuclei by atomic shell electrons of the host material and by conduction electrons the total screening potential energy U_{e,sc} can be estimated as:

$${U}_{e , sc} = \frac{{e}^{2}}{{λ}_{sc}} \qquad ( 65 )$$

where the screening length λ_{sc} is given by one of the following general relations:

λ_{sc}⁻²=λ_{TF}⁻²+λ_{De,c}⁻² or λ_{sc}⁻²=λ_{TF}⁻²+λ_{D}⁻² (66)

where λ_{TF} is the modified Thomas-Fermi screening length by atomic shell electrons of the host material, λ_{De,c} is the screening length by conduction electrons, and λ_{D} is the Debye screening length in plasma.

Since the inverse square of screening lengths λ_{TF}⁻², λDe,c⁻², or λD⁻² is proportional to the corresponding electron number density, the derivation of Eqs. (65) and (66) is similar to the derivation of Eqs. (46)-(48), as the summation of electron number densities was used in both cases to contribute to the total charge density is in electrostatic Poisson's equation for the screened Coulomb interaction potential.

IV. Coulomb Scattering on Target Nuclei

A. Elastic Coulomb Scattering by Light Particles (e⁻,e⁺)

Coulomb scattering of energetic projectile particles on target nuclei is the principle process associated with the nuclear fusion reactions of interest. Fusion nuclear events are more likely under the condition of large-angle scattering, which brings the reacting ions to the classical distance of closest approach to successfully tunnel through the Coulomb barrier. However, the elastic scattering at small angles dominates the Coulomb scattering interaction. Generally, the electron screening of the Coulomb barrier could significantly reduce the small-angle elastic scattering, thus increasing the probability of large-angle scattering and correspondingly successful nuclear fusion events. Elastic scattering studies on Coulomb scattering of energetic projectiles on target nuclei are analyzed herein and extended to include the electron screening by plasma electrons, as well as by conduction electrons in deuterated metals. It is also found that the kinetic energy transfer (kinetic heating) to fuel nuclei is the most successful by energetic neutral particles, such as neutrons and γ-quanta-producing photodissociation neutrons.

The Coulomb scattering of relativistic projectile electrons on target atoms (absorbing medium) is characterized by the projectile electron-target atom differential cross section dσ/dΩ|ₑ₋ₐ, which is determined as the sum of the projectile electron-target nucleus differential cross-section dσ/dΩ|_{e-N} and the projectile electron-target orbital electron differential cross section dσ/dΩ|ₑ₋ₑ multiplied by Z (the atomic number of target atoms). The projectile electron-target atom differential cross section is given by the following relation:

$$\frac{d σ}{d Ω} {\vert}_{e - a} = \frac{d σ}{d Ω} {\vert}_{e - N} + Z \cdot \frac{d σ}{d Ω} {\vert}_{e - e} = \frac{{D}_{e - a}^{2} \cdot ( 1 - \frac{{β}^{2}}{2} \cdot ( 1 - cos θ ) )}{{( 2 \cdot ( 1 - cos θ ) + {θ}_{min}^{2} )}^{2}} \qquad ( 67 )$$

where θ is the electron scattering angle, β=vₑ/c (with vₑ being the velocity of the projectile electron and c being the speed of light), and θₘᵢₙ is the atomic screening parameter defined as:

$${θ}_{min} = \frac{ℏ / {λ}_{TF}}{{p}_{e}} \qquad ( 68 )$$

where ℏ is the reduced Planck constant and λ_{TF} is the modified Thomas-Fermi target atomic radius given by Eq. (25). The electron momentum pₑ is determined by the following relations:

$${p}_{e} = \frac{{E}_{e}}{c} \cdot {( 1 + \frac{2 {m}_{e} \cdot {c}^{2}}{{E}_{e}} )}^{\frac{1}{2}} \qquad ( 69 )$$

where Eₑ=Eₑ−mₑ·c² is the kinetic energy of the projectile electron (Eₑ is the total energy of projectile electron and mₑ is the electron mass).

Eq. (67) was derived in the first Born approximation to the Dirac equation for the Wentzel-Thomas-Fermi screened Coulomb atomic potential (energy) given in Eq. (63):

$${V}_{C , sc} ( r ) = \frac{e \cdot ( Z \cdot e )}{r} \cdot exp ( - \frac{r}{{λ}_{TF}} ) \qquad ( 70 )$$

where λ_{TF} is the Thomas-Fermi screening length (atom size) by atomic shell electrons of host material given by Eq. (64).

The projectile electron-target atom elastic scattering characteristic distance Dₑ₋ₐ is determined from the following relation:

Dₑ₋ₐ²=D_{e-N}²+(Z·Dₑ₋ₑ²) (71)

where the projectile electron-target nucleus characteristic scattering distance D_{e-N} is determined by:

$${D}_{e - N} = \frac{Z \cdot {e}^{2}}{γ \cdot {m}_{e} \cdot ( {v}_{e}^{2} \text{/} 2 )} = \frac{2 Z \cdot {r}_{e} \cdot \sqrt{1 - {β}^{ 2}}}{{β}^{ 2}} = \frac{Z \cdot {e}^{2}}{β \cdot {E}_{e} \cdot {( 1 + ( {m}_{e} {c}^{2} \text{/} {E}_{e} ) )}^{1 / 2}} \qquad ( 72 )$$

with γ=1/\sqrt{1−β₂}, and the projectile electron-target orbital electron characteristic scattering distance Dₑ₋ₑ given by Eq. (71) with Z=1.

Here, rₑ=e²/mₑc² is the classical radius of electron rₑ=2.82 femtometers (fm)=2.82×10⁻¹³ cm. Substitution from Eq. (72) and Dₑ₋ₑ into Eq. (71) yields:

$${D}_{e - a} = \frac{2 {r}_{e} \cdot \sqrt{Z ( Z + 1 )}}{γ \cdot {β}^{ 2}} = \frac{2 {e}^{2} \cdot \sqrt{Z ( Z + 1 )}}{β \cdot {E}_{e} \cdot {( 1 + 2 {m}_{e} {c}^{2} \text{/} {E}_{e} )}^{1 / 2}} \qquad ( 73 )$$

The total cross section σₑ₋ₐ is obtained by integrating over dΩ the differential cross section for projectile electrons scattering on target atoms from Eq. (67):

$${σ}_{e - a} = \int \frac{d σ}{d Ω} {\vert}_{e - a} d Ω = \frac{π {D}_{e - a}^{2}}{{θ}_{min}^{2}} \cdot [ ( \frac{4 + {β}^{ 2} {θ}_{min}^{2}}{4 + {θ}_{min}^{2}} ) - \frac{{β}^{ 2} {θ}_{min}^{2}}{4} \cdot ln ( \frac{4}{{θ}_{min}^{2}} - 1 ) ] \qquad ( 74 )$$

where θₘᵢₙ=(ℏ/pₑ)˜λ_{TF}⁻², given by Eq. (68). The expression for σ_{e-N} follows from Eq. (68) with the substitution Dₑ₋ₐ²→D_{e-N}².

For Eₑ=2 MeV and m_{N}=m_{d} (deuteron mass), the numerical value for σ_{e-d} is as follows:

$${σ}_{e - d} = \int \frac{d σ}{d Ω} {\vert}_{e - d} d Ω \approx \frac{π {D}_{e - d}^{2}}{{θ}_{min}^{2}} = \frac{4 π {e}^{4} \cdot {λ}_{TF}^{2}}{{ℏ}^{2} {c}^{2} {β}^{ 2}} = 38.41 kb \qquad ( 75 )$$

since πD_{e-d}²=45.1 mb, but θₘᵢₙ²=(ℏ/pₑ)²·λ_{TF}⁻²=1.17×10⁻⁶.

The target nucleus recoil energy can be found from the conservation of the total momentum in the elastic projectile electron-target nucleus scattering process:

\vec{p}_{N}=\vec{p}ₑ−\vec{p}ₑ′ (76)

Where \vec{p}_{N} is the target nucleus recoil momentum, \vec{p}ₑ is the momentum of incident electron, and \vec{p}ₑ′ is the momentum of the scattered electron. Since in elastic scattering Pₑ=|\vec{p}ₑ|≈|\vec{p}ₑ′| (for the reason that small angle scattering is the most probable event), it follows from Eq. (76) that:

p_{N}²=\vec{p}_{N}²=\vec{p}ₑ²+\vec{p}′ₑ²−2\vec{p}ₑ·\vec{p}ₑ′·cos θ≈pₑ²·(1·cos θ) (77)

where θ is the scattering angle. Correspondingly, it follows from Eq. (77), with the help of Eq. (69) that the nucleus recoil energy E_{N}(θ) is:

$${E}_{N} ( θ ) = \frac{{p}_{N}^{2}}{2 {m}_{N}} \approx \frac{{p}_{e}^{2}}{{m}_{N}} \cdot ( 1 - cos θ ) = \frac{{E}_{e}^{2}}{{m}_{N} \cdot {c}^{2}} ( 1 + \frac{2 {m}_{e} {c}^{2}}{{E}_{e}} ) \cdot ( 1 - cos θ ) \qquad ( 78 )$$

where Eₑ=Eₑ−m_{c}c² is the kinetic energy of projectile electron, Eₑ is the total energy of the projectile electron, and mₑ and m_{N} are the electron and nucleus masses, respectively.

The mean target nucleus recoil energy Ē_{N} in a single elastic projectile electron-nucleus (target) collision is obtained by averaging E_{N}(θ) over dΩ:

$${\overline{E}}_{N} = \frac{\int {E}_{N} ( θ ) \cdot d σ \text{/} d Ω {\vert}_{e - N} \cdot d Ω}{\int d σ \text{/} d Ω {\vert}_{e - N} \cdot d Ω} \qquad ( 79 )$$

Substitution of

$$\frac{d σ}{d Ω} {\vert}_{e - N}$$

into Eq. (79) and taking the integral yields the expression for the mean target nucleus recoil energy Ē_{N} in a single elastic projectile electron-nucleus (target) collision:

$${\overline{E}}_{N} = \frac{{ℏ}^{2}}{{m}_{N} \cdot {λ}_{TF}^{2}} \cdot \frac{\begin{matrix}( ( 2 + α ) \cdot ( 1 + α \cdot {β}^{ 2} ) \cdot ln ( \frac{2 + α}{α} ) - \\ 2 [ 1 + ( 1 + α ) {β}^{ 2} ] )\end{matrix}}{2 ( 2 + α \cdot {β}^{ 2} ) - α \cdot ( 2 + α ) \cdot {β}^{ 2} \cdot ln ( \frac{2 + α}{α} )} \qquad ( 80 )$$

where α=θₘᵢₙ²/2 and β=vₑ/c. For Eₑ=2 MeV and m_{N}=m_{d} (deuteron mass), the numerical value for the mean target nucleus recoil energy Ē_{N}=Ē_{d} in a single elastic projectile electron-target deuteron nucleus collision is as follows:

Ē_{d}=24.75 meV (81)

B. Heavy Particle Elastic Coulomb Scattering (d, p, α)

The Coulomb scattering of the heavy projectile particles on target nuclei is characterized by the differential cross section of the heavy projectile particles and nuclei, which is given by Eq. (67) with the substitution Dₑ₋ₐ²→D_{p-N}²S, with βₚ=vₚ/c, and:

$${θ}_{min , p} = \frac{ℏ \text{/} {λ}_{TF}}{{p}_{p}} = \frac{ℏ \text{/} {λ}_{TF}}{\sqrt{2 {m}_{p} \cdot {E}_{p}}} \qquad ( 82 )$$

where pₚ=\sqrt{2mₚ·Eₚ} is the projectile momentum and mₚ and Eₚ are the projectile mass and kinetic energy, respectively.

The projectile particle-target nucleus characteristic scattering distance D_{p-N} is determined by:

$${D}_{p - N} = \frac{{z}_{p} \cdot {Z}_{N} \cdot {e}^{2}}{{E}_{p}} \qquad ( 83 )$$

where zₚ is the projectile particle atomic number (zₚ=1 for the proton and deuteron projectile, zₚ=2 for the α projectile), and Z_{N} is the target nucleus atomic number.

The total cross section σ_{p-N} for a single scattering event can be obtained from Eq. (74) with the substitution Dₑ₋ₐ²→D_{p-N}² and with β→βₚ<<1, since the heavy projectiles are nonrelativistic:

$${σ}_{p} - N = \frac{π \cdot {D}_{p - N}^{2}}{{θ}_{min , p}^{2}} \cdot {( 1 + \frac{{θ}_{min , p}^{2}}{4} )}^{- 1} \to \frac{π \cdot {D}_{p - N}^{2}}{{θ}_{min , p}^{2}} = \frac{2 π \cdot {m}_{p} \cdot {e}^{4} \cdot {z}_{p}^{2} \cdot {Z}_{N}^{2}}{{ℏ}^{2}} \cdot \frac{{λ}_{TF}^{2}}{{E}_{p}} \qquad ( 84 )$$

since

$${θ}_{min , p} = \frac{ℏ}{{λ}_{TF} \cdot {p}_{p}} ≪ 1 , {λ}_{TF} - 1.4 {a}_{0} \cdot {{Z}_{N}}^{- 1 / 3} ,$$

and pₚ=\sqrt{2mₚ·Eₚ}.

For a non-particle projectile with Eₚ=3 MeV and a deuteron target nucleus (m_{N}=m_{d}), the numerical value for σ_{p-D} (total scattering cross section) is as follows:

$${σ}_{p - D} = \int \frac{d σ}{d Ω} {\vert}_{p - D} d Ω \approx \frac{π \cdot {D}_{p - D}^{2}}{{θ}_{min , p}^{2}} = \frac{2 π \cdot {m}_{p} \cdot {e}^{4}}{{ℏ}^{2}} \cdot \frac{{λ}_{TF}^{2}}{{E}_{p}} = 5.76 Mb \qquad ( 85 )$$

For a deuteron projectile with E_{d}=3 MeV and a deuteron target nucleus (m_{N}=m_{d}), the numerical value for σ_{d-D} is as follows:

$${σ}_{d - D} = \int \frac{d σ}{d Ω} {\vert}_{d - D} d Ω \approx \frac{π \cdot {D}_{d - D}^{2}}{{θ}_{min , d}^{2}} = \frac{2 π \cdot {m}_{p} \cdot {e}^{4}}{{ℏ}^{2}} \cdot \frac{{λ}_{TF}^{2}}{{E}_{d}} = 11.51 Mb \qquad ( 86 )$$

whereas for deuteron projectile with E_{d}=10 keV and a deuteron target nucleus (m_{N}=m_{d}), the numerical value for σ_{d-D} is as follows:

$${σ}_{d - D} = \int \frac{d σ}{d Ω} {\vert}_{d - D} d Ω \approx \frac{π \cdot {D}_{d - D}^{2}}{{θ}_{min , d}^{2}} = \frac{2 π \cdot {m}_{d} \cdot {e}^{4}}{{ℏ}^{2}} \cdot \frac{{λ}_{TF}^{2}}{{E}_{d}} = 3.45 Gb \qquad ( 87 )$$

The relative probability P_{sc}(π/2≤θ≤π) to scatter in the back hemisphere (π/2≤θ≤π) is equal to:

$${P}_{sc} ( π / 2 \leq θ \leq π ) = \frac{1}{{σ}_{d - D}} {{\cdot \int }_{\frac{π}{2}}}^{π} \frac{d σ}{d Ω} {\vert}_{d - D} \cdot 2 π \cdot sin θdθ \qquad ( 88 )$$

For a deuteron projectile with E_{d}=3 MeV and a deuteron target nucleus (m_{N}=m_{d}), the numerical value of P_{sc}(π/2≤θ≤π) for screening by shell electrons (λ_{sc}=λ_{TF}=1.4a₀=7.4×10⁻⁹ cm) is equal to:

P_{sc}(π/2≤θ≤π)=1.57×10⁻¹⁰ (89)

and the value for screening by a metal conduction electron (λ_{sc}=λ_{De,c}=5×10⁻¹⁰ cm) is equal to:

P_{sc}(π/2≤θ≤π)=3.45×10⁻⁸ (90)

In the case of conduction electron screening in Eq. (90), the screened Coulomb potential energy V_{C,sc}(r) is defined by the same as in Eq. (70) with λ_{TF}→λ_{sc}=λ_{De,c}=5×10⁻¹⁰ cm.

For a deuteron projectile with E_{d}=10 keV and a deuteron target nucleus (m_{N}=m_{d}), the numerical value of the probability P_{sc}(π/2≤θ≤π) for screening by a deuteron shell electron (λ_{sc}=λ_{TF}=1.4a₀=7.4×10⁻⁹ cm) is equal to:

P_{sc}(π/2≤θ≤π)=4.73×10⁻⁸ (91)

and for screening by a metal conduction electron (λ_{sc}=λ_{De,c}=5×10⁻¹⁰ cm) is equal to:

P_{sc}(π/2≤θ≤π)=1.04×10⁻⁵ (92)

Generally, the deep electron screening of the Coulomb barrier (with λ_{De,c}<<λ_{TF}) could significantly reduce small angle elastic scattering dominance, increasing the probabilities of large angle scattering (thus increasing the astrophysical factor S(E)) and successful nuclear fusion events.

For an α projectile with E_{α}=3 MeV and a deuteron target nucleus (m_{N}=m_{d}), the numerical value for σ_{α-D} (total scattering cross section) is as follows:

$${σ}_{α - D} = \int \frac{d σ}{d Ω} {\vert}_{α - D} d Ω \approx \frac{π \cdot {D}_{α - D}^{2}}{{θ}_{min , α}^{2}} = \frac{8 π \cdot {m}_{α} \cdot {e}^{4}}{{ℏ}^{2}} \cdot \frac{{λ}_{TF}^{2}}{{E}_{α}} = 91.48 Mb \qquad ( 93 )$$

whereas for an α projectile with Eₐ=1 MeV and a deuteron target nucleus (m_{N}=m_{d}), the numerical value for σ_{a-D} increases due to the inverse dependence on energy:

σ_{α-D}=274.5 Mb (94)

The target nucleus recoil energy could be found from the conservation of the total momentum in the elastic projectile particle-target nucleus scattering process:

\vec{p}_{N}=\vec{p}ₚ−\vec{p}ₚ′ (95)

where \vec{p}_{N} is the target nucleus recoil momentum, \vec{p}ₚ is the momentum of the incident projectile particle, and \vec{p}ₚ′ is the momentum of the scattered projectile particle. Since in elastic scattering pₚ=|\vec{p}ₚ|≈|\vec{p}ₚ′| (for the reason that small angle scattering is the most probable event), it follows from Eq. (95) that:

p_{N}²=\vec{p}_{N}²=\vec{p}ₚ²+\vec{p}′ₚ²−2\vec{p}ₚ·\vec{p}ₚ′·cos θ≈2pₚ²·(1−cos θ) (96)

where θ is the scattering angle. Correspondingly, the target nucleus recoil energy E_{N}(θ) follows from Eq. (96):

$${E}_{N} ( θ ) = \frac{{p}_{N}^{2}}{2 {m}_{N}} \approx \frac{{p}_{p}^{2}}{{m}_{N}} \cdot ( 1 - cos θ ) = \frac{2 {m}_{p}}{{m}_{N}} \cdot {E}_{p} \cdot ( 1 - cos θ ) \qquad ( 97 )$$

where Eₚ=pₚ²/2mₚ is the kinetic energy of the projectile particle.

The mean target nucleus recoil energy Ē_{N} in a single elastic nonrelativistic projectile-target nucleus collision is obtained by averaging of E_{N}(θ) over dΩ, and from Eq. (79) with the usual substitution α→αₚ=θmin,p²/2 it follows that:

$${\overline{E}}_{N} ( {β}_{p} ≪ 1 ) = \frac{{ℏ}^{2}}{{m}_{N} \cdot {λ}_{TF}^{2}} \cdot ln ( \frac{2}{{θ}_{min , p}} ) = \frac{{ℏ}^{2}}{{m}_{N} \cdot {λ}_{TF}^{2}} ln ( \frac{2 {λ}_{TF}}{ℏ} \cdot \sqrt{2 {m}_{p} \cdot {E}_{p}} ) \qquad ( 98 )$$

since θ_{min,p}=h/(λ_{TF}·pₚ)=ℏ/(λ_{TF}·\sqrt{2mₚ·Eₚ})<<1.

C. Compton Scattering on Free Deuteron

The differential Klein-Nishina (1929) cross section dσ_{C}^{KN}/dΩ per unit solid angle dΩ for Compton scattering of an electron on a deuteron is given by the standard expression:

$$\frac{d {σ}_{C}^{KN}}{d Ω} = \frac{{r}_{D}^{2}}{2} \{ \frac{1 + {cos}^{2} θ}{{[ 1 + {ɛ}_{D} ( 1 - cos θ ) ]}^{2}} + \frac{{{ɛ}_{D}^{2} ( 1 - cos θ )}^{2}}{{[ 1 + {ɛ}_{D} ( 1 - cos θ ) ]}^{3}} \} \qquad ( 99 )$$

where r_{D} is the deuteron classical radius r_{D}=e²/m_{D}c², ε_{D}=E_{γ}/m_{D}c², and E_{γ} is the photon energy.

The total cross section σ_{C}^{KN} is obtained by integrating the differential cross section for Compton scattering given by Eq. (99) over dΩ:

$${σ}_{C}^{KN} = \int \frac{d {σ}_{C}^{KN}}{d Ω} d Ω = {{\int }^{π}}_{0} \frac{d {σ}_{C}^{KN}}{d Ω} \cdot 2 π \cdot sin θdθ \qquad ( 100 )$$

The above integration produces the standard known formula:

$${σ}_{C}^{KN} = 2 π {r}_{D}^{2} ( \frac{1 + {ɛ}_{D}}{{ɛ}_{D}^{2}} ( \frac{2 ( 1 + {ɛ}_{D} )}{1 + 2 {ɛ}_{D}} - \frac{ln ( 1 + 2 {ɛ}_{D} )}{{ɛ}_{D}} ) + \frac{ln ( 1 + 2 {ɛ}_{D} )}{{ɛ}_{D}} - \frac{1 + 3 {ɛ}_{D}}{{( 1 + 2 {ɛ}_{D} )}^{2}} ) \qquad ( 101 )$$

For E_{γ}=2 MeV and m_{N}=m_{d}, the numerical value for σ_{C}^{KN} is as follows:

σ_{C}^{KN}=49.43 nb (102)

For small

$${ɛ}_{D} = \frac{E γ}{{m}_{D} {c}^{2}} ≪ 1 ,$$

the expression σ_{C}^{KN} is reduced to:

$${σ}_{C}^{KN} ( {ɛ}_{D} ≪ 1 ) = \frac{8 π {r}_{D}^{2}}{3} ( 1 - 2 {ɛ}_{D} + \frac{26}{5} {ɛ}_{D}^{2} - \frac{133}{10} {ɛ}_{D}^{3} + \frac{1144}{35} {ɛ}_{D}^{4} - … ) \qquad ( 103 )$$

For E_{γ}=2 MeV and (m_{N}=m_{d}), the numerical value for σ_{C}^{KN}(ε_{D}<<1), calculated with the help of Eq. (103), is almost as in Eq. (102), namely:

σ_{C}^{KN}(ε_{D}<<1)=49.43 nb (104)

The deuteron recoil energy E_{D}(θ), which is the kinetic energy transferred to a free (unbounded) deuteron by γ-quanta with energy E_{γ}, is given by the standard known expression:

$${E}_{D} ( θ ) = {E}_{γ} \cdot {ɛ}_{D} \cdot \frac{( 1 - cos θ )}{1 + {ɛ}_{D} ( 1 - cos θ )} , {ɛ}_{D} = \frac{{E}_{γ}}{{m}_{D} {c}^{2}} \qquad ( 105 )$$

where θ is the photon scattering angle. When E_{γ}<<m_{D}c² (i.e., ε_{D}<<1), then Eq. (105) is reduced to:

$${E}_{D} ( θ ) \approx \frac{{E}_{γ}^{2}}{{m}_{D} {c}^{2}} ( 1 - cos θ ) = {E}_{γ} \cdot {ɛ}_{D} \cdot ( 1 - cos θ ) , {ɛ}_{D} = \frac{{E}_{γ}}{{m}_{D} {c}^{2}} ≪ 1 \qquad ( 106 )$$

Mean deuteron recoil energy Ē_{D} in a single Compton collision is obtained by averaging of E_{D}(θ) from Eq. (104) with dσ_{C}/dΩ from Eq. (99) over dΩ:

$${\overline{E}}_{D} = \frac{\int {E}_{D} ( θ ) \frac{d {σ}_{C}^{KN}}{d Ω} d Ω}{\frac{d {σ}_{C}^{KN}}{d Ω} d Ω} = \frac{1}{{σ}_{C}^{KN}} \cdot {{\int }_{0}}^{π} {E}_{D} ( θ ) \cdot \frac{d {σ}_{C}^{KN}}{d Ω} \cdot 2 π \cdot sin θdθ \qquad ( 107 )$$

The above integration produces the standard known expression:

$${\overline{E}}_{D} = {E}_{γ} \cdot [ 2 {ɛ}_{D} ( 9 + 51 {ɛ}_{D} + 93 {ɛ}_{D}^{2} + 51 {ɛ}_{D}^{3} - 10 {ɛ}_{D}^{4} ) - 3 ( 3 - {ɛ}_{D} ) ( 1 + {ɛ}_{D} ) {( 1 + 2 {ɛ}_{D} )}^{3} ln ( 1 + 2 {ɛ}_{D} ) ] \div \{ 6 {ɛ}_{D} ( 1 + 2 {ɛ}_{D} [ 2 + {ɛ}_{D} ( 1 + {ɛ}_{D} ) ( 8 + {ɛ}_{D} ) ] - 3 {( 1 + 2 {ɛ}_{D} )}^{3} [ 2 + {ɛ}_{D} ( 2 - {ɛ}_{D} ) ] ln ( 1 + 2 {ɛ}_{D} ) \} \qquad ( 108 )$$

When ε_{D}<<1 (i.e., E_{γ}<<m_{D}c²), then Eq. (108) is reduced to:

$${E}_{D} ( {ɛ}_{D} ≪ 1 ) = {E}_{γ} \cdot {ɛ}_{D} \cdot ( 1 - \frac{11}{5} {ɛ}_{D} + \frac{51}{10} {ɛ}_{D}^{2} - \frac{3931}{350} {ɛ}_{D}^{3} + … ) \qquad ( 109 )$$

For E_{γ}=2 MeV and m_{N}=m_{d}, the numerical value for Ē_{D}(ε_{D}<<1) is as follows:

Ē_{D}(ε_{D}<<1)=2.13 keV (110)

In the case of Compton scattering on free electrons, when E_{γ}=2 MeV, then εₑ=E_{γ}/mₑc²=3.914. It thus follows from Eq. (108) that in the case (r_{D}→rₑ), Ēₑ=1.062 MeV. For Ē_{γ}, E_{γ}=1.022 MeV, εₑ=E_{γ}/mₑ c²=2, and it follows from Eq. (108) that Ēₑ=0.453 MeV. Therefore, the kinetic energy transfer to fuel nuclei (D) by energetic photons is much more efficient than by other energetic, light charged particles (e⁻, e⁺), or by energetic, heavy charged particles (p, d, α).

Table III provides a comparison of the mean target nucleus recoil energy Ē_{N} in single elastic nonrelativistic projectile-target nucleus collision for various projectiles and at different projectile energies. In Table III, the target is always a deuteron nucleus (m_{N}=m_{d}), and the calculation provides a numerical value for Ē_{D} (βₚ<<1).

TABLE III
MEAN DEUTERON RECOIL ENERGIES FOR SOME REACTIONS

| | | Total Cross | Mean Deuteron |
|---|---|---|---|
| Reaction (particle, D) | | Section, σ (barn) | Recoil Energy |
| Light Particles | Eₑ = 2 MeV | 38.41 kb | 24.75 meV |
| (e⁺, e⁻) | | | |
| Heavy Particles | Eₚ = 3 MeV | 5.76 Mb | 41.4 meV |
| | E_{d} = 3 MeV | 11.51 Mb | 42.7 meV |
| | E_{α} = 3 MeV | 91.48 Mb | 44 meV |
| Compton (γ) | E_{γ} = 2 MeV | 49.43 nb | 2.13 keV |
| Neutron (n) | Eₙ = 2.45 MeV | 3 b | 1.09 MeV |

Thus, it can be concluded that the kinetic energy transfer to fuel nuclei D by either energetic light charged particles (e⁺, e⁻) or by energetic heavy charged particles (p, d, α) is a very inefficient process unless there is a mechanism to increase the probability of large-angle scattering, such as via a decreased mean-free path by increased ion and electron densities.

V. Neutron Elastic Scattering on Deuteron Nuclei

Since the deuteron nucleus possesses just a single (ground) energy level, the neutron scattering on the deuteron is an elastic scattering process if the energy of the neutron is below the disintegration of the deuteron by the neutron (the deuteron disintegration threshold by a neutron is Kₙ^{th}=3.4 MeV). In this case, it is known that the neutron elastic cross section σ_{sc}(θ_{CM}) is isotropic in CM (the center of mass frame), that is:

$${σ}_{sc} ( {θ}_{CM} ) = \frac{{σ}_{sc}}{4 π} \qquad ( 111 )$$

where θ_{CM} is the neutron scattered angle in the CM frame and σ_{sc} is the total neutron elastic cross section. The scattering angle θ_{lab} in lab frame is related to θ_{CM} as:

$$tan {θ}_{lab} = \frac{{m}_{d} \cdot sin {θ}_{CM}}{{m}_{n} + {m}_{d} \cdot cos {θ}_{CM}} \qquad ( 112 )$$

where mₙ and m_{d} are the neutron and deuteron masses, respectively.

Since the scattered angles θ_{CM} and θ_{lab} are different, the angular distributions of scattered particles in the CM and lab frames are also different. However, the number of scattered particles in the corresponding solid angle dΩ(θ_{CM}) in the CM frame and in solid angle dΩ(θ_{lab}) in the lab frame must be the same:

σ_{sc}(θ_{lab})dΩ(θ_{lab})=σ_{sc}(θ_{CM})dΩ(θ_{CM}) (113)

However, dΩ(θ_{CM})=2π sin θ_{CM} and dΩ(θ_{lab})=2π sin(θ_{lab}) dθ_{lab}. Therefore, Eq. (113) becomes:

σ_{sc}(θ_{lab})Sin(θ_{lab})dθ_{lab}=σ_{sc}(θ_{CM})sin(θ_{CM})dθCM (114)

With the help of Eq. (112), it follows from Eq. (114) that the angular distribution of scattered particles in the lab frame can be determined from the corresponding angular distribution of scattered particles in the CM frame as follows:

$${σ}_{sc} ( {θ}_{lab} ) = {σ}_{sc} ( {θ}_{CM} ) \cdot \frac{{[ {m}_{n}^{2} + {m}_{d}^{2} + 2 {m}_{n} \cdot {m}_{d} \cdot cos ( {θ}_{CM} ) ]}^{3 / 2}}{{m}_{d}^{2} \cdot [ {m}_{d} + {m}_{n} \cdot cos ( {θ}_{CM} ) ]} \qquad ( 115 )$$

The relation between scattered neutron velocities \vec{v}′_{n,CM} in the CM frame and \vec{v}_{n,lab} in the lab frame is given by the formula:

$$\begin{matrix}{\overline{\vec{v}}}_{n , lab}^{′} = {\vec{v}}_{n , CM}^{′} + {\vec{v}}_{CM} , & {\vec{v}}_{CM} = \frac{{m}_{n}}{{m}_{n} + {m}_{d}} {v}_{n}\end{matrix} \qquad ( 116 )$$

where \vec{v}_{CM} is the CM frame velocity and \vec{v}ₙ is the neutron velocity in the lab frame. Correspondingly, the relation between neutron and deuteron velocities \vec{v}_{n,CM} and \vec{v}_{d,CM} in the CM frame and \vec{v}ₙ and \vec{v}_{d} in the lab frame are as follows:

$${\vec{v}}_{n , CM} = {\vec{v}}_{n} - {\vec{V}}_{CM} = \frac{{m}_{d}}{{m}_{n} + {m}_{d}} {\vec{v}}_{n} , {\vec{v}}_{d , CM} = - {\vec{V}}_{CM} = - \frac{{m}_{n}}{{m}_{n} + {m}_{d}} {\vec{v}}_{n} , and {\vec{v}}_{d} = 0 \qquad ( 117 )$$

Since the magnitude of neutron velocity in the CM frame does not change after collision (i.e., \vec{v}′_{n,CM}=\vec{v}_{n,CM}), it follows with the help of Eq. (116) and Eq. (117) that:

$${v}_{n , lab}^{′2} = {v}_{n , CM}^{2} + {V}_{CM}^{2} + 2 {v}_{n , CM} {V}_{CM} cos {θ}_{CM} = \frac{( {m}_{n}^{2} + {m}_{d}^{2} + 2 {m}_{n} {m}_{d} cos {θ}_{CM} )}{{( {m}_{n} + {m}_{d} )}^{2}} {v}_{n}^{2} \qquad ( 118 )$$

Rewriting Eq. (118) in terms of the neutron kinetic energy Kₙ′ after and the neutron kinetic energy Kₙ before the collision yields:

$${K}_{n}^{′} = \frac{( {m}_{n}^{2} + {m}_{d}^{2} + 2 {m}_{n} {m}_{d} cos {θ}_{CM}}{{( {m}_{n} + {m}_{d} )}^{2}} {K}_{n} \qquad ( 119 )$$

It is convenient to introduce the new parameter αₙ by the following definition:

$${α}_{n} = \frac{{( {m}_{d} - {m}_{n} )}^{2}}{{( {m}_{d} + {m}_{n} )}^{2}} \qquad ( 120 )$$

Then, in terms of the new parameter αₙ, Eq. (119) is reduced to:

Kₙ′=½Kₙ·[(1+αₙ)+(1−αₙ)·cos θ_{CM}] (121)

From Eq. (121), one skilled in the art will recognize that the kinetic energy Kₙ′ is in the following limits (0<θ_{CM}<π):

αₙ·Kₙ≤Kₙ′≤Kₙ (122)

The probability distribution P(Kₙ→Kₙ′)·dKₙ′ is, by definition, the probability that the neutron with initial kinetic energy Kₙ will acquire kinetic energy in the energy gap (Kₙ′, Kₙ′+dKₙ′) after the collision. The probability that the neutron will be scattered in the interval (θ_{CM}, θ_{CM}+dθ_{CM}) is given by:

$$\frac{{σ}_{sc} ( {θ}_{CM} ) \cdot d Ω ( {θ}_{CM} )}{{σ}_{sc}} = \frac{{σ}_{sc} ( {θ}_{CM} ) \cdot 2 πsin ( {θ}_{CM} ) d {θ}_{CM}}{{σ}_{sc}} \qquad ( 123 )$$

where σ_{sc}(θ_{CM}) is the neutron differential elastic cross section and σ_{sc} is the total neutron elastic cross section in the CM frame. It is clear that they are the same probabilities:

$$P ( {K}_{n} \to {K}_{n}^{′} ) \cdot {dK}_{n}^{′} = - \frac{{σ}_{sc} ( {θ}_{CM} ) \cdot 2 π sin ( {θ}_{CM} )}{{σ}_{sc}} \cdot d {θ}_{CM} \qquad ( 124 )$$

since for dθ_{CM}>0→dKₙ′>0, thus providing the positivity of the probability P(Kₙ→Kₙ′)>0.

From Eq. (121), it follows that:

dKₙ′=−½Kₙ·(1·αₙ)·sin θ_{CM}dθ_{CM} (125)

Substitution of Eq. (125) into Eq. (124) yields:

$$P ( {K}_{n} \to {K}_{n}^{′} ) = \frac{4 π \cdot {σ}_{sc} ( {θ}_{CM} )}{{K}_{n} \cdot ( 1 - {α}_{n} ) \cdot {σ}_{sc}} for ( {α}_{n} \cdot {K}_{n} \leq {K}_{n}^{′} \leq {K}_{n} ) \qquad ( 126 )$$

Since the neutron elastic cross section σ_{sc}(θ_{CM}) is isotropic in the CM frame, then substitution of σ_{sc}(θ_{CM})=σ_{sc}/4π from Eq. (111) into Eq. (126) yields:

$$P ( {K}_{n} \to {K}_{n}^{′} ) = \frac{1}{{K}_{n} \cdot ( 1 - {α}_{n} )} for ( {α}_{n} \cdot {K}_{n} \leq {K}_{n}^{′} \leq {K}_{n} ) \qquad ( 127 )$$

Therefore, the kinetic energy probability distribution P(Kₙ₁→Kₙ′) is independent on K′ in the whole interval (αₙ·Kₙ′≤Kₙ′≤Kₙ).

VI. Neutron Energy Loss in Elastic Collisions with Deuteron Nuclei

By definition, the average neutron energy Kₙ′ after elastic collision is obtained by averaging Kₙ′ with the probability distribution P(Kₙ→Kₙ′) given by Eq. (127):

$${\overline{K}}_{n}^{′} = \frac{{\int }_{α {K}_{n}}^{{K}_{n}} {K}_{n}^{′} \cdot P ( {K}_{n} \to {K}_{n}^{′} ) {dK}_{n}^{′}}{{\int }_{α {K}_{n}}^{{K}_{n}} P ( {K}_{n} \to {K}_{n}^{′} ) {dK}_{n}^{′}} = \frac{1}{2} \cdot ( 1 - {α}_{n} ) \cdot {K}_{n} \qquad ( 128 )$$

The average kinetic energy transferred from the neutron to the deuteron nucleus in an elastic collision is equal to Kₙ→Kₙ′ (see also Eq. (120)):

$${\overline{K}}_{d}^{′} = {K}_{n} - {\overline{K}}_{n}^{′} = \frac{1}{2} \cdot ( 1 - {α}_{n} ) \cdot {K}_{n} = \frac{2 {m}_{n} \cdot {m}_{d}}{{( {m}_{n} + {m}_{d} )}^{2}} \cdot {K}_{n} = \frac{4}{9} \cdot {K}_{n} \qquad ( 129 )$$

which is equal to one half of the maximum energy transfer in a head-on collision:

$${\overline{K}}_{d , max}^{′} = \frac{4 {m}_{n} {m}_{d}}{{( {m}_{n} + {m}_{d} )}^{2}} \cdot {K}_{n} \qquad ( 130 )$$

for a neutron projectile on a deuteron target nucleus, with the total elastic cross section of the order of:

σ_{sc}˜3bn(25 meV≤Kₙ≤2 MeV) (131)

Consequently, the kinetic energy transfer to fuel nuclei (D) by energetic neutrons is the most efficient process compared to energy transferred by energetic light charged particles (e⁺, e⁻), by energetic heavy charged particles (p, d, α), or even by energetic photons.

Theoretical Summary

Electron screening plays a critical role in the overall efficiency of nuclear fusion events between charged particles. The kinetic energy transfer to fuel nuclei (D) by neutral particles, such as energetic neutrons or photons, is shown above to be far more efficient than by energetic charged particles, such as light particles (e⁻, e⁺) or heavy particles (p, d, α). A theoretical framework is provided for d-D nuclear fusion reactions in high-density cold fuel nuclei embedded in metal lattices, with a small fraction of fuel activated by hot neutrons. Also established is the important role of electron screening in increasing the relative probability P_{sc}(π/2≤θ≤π) to scatter in the back hemisphere (π/2≤θ≤π), an essential requirement for subsequent tunneling of reacting nuclei to occur. This will correspondingly be reflected as an increase in the astrophysical factor S(E).

Also clarified is the applicability of the concept of electron screening potential energy Uₑ to the calculation of the nuclear cross section enhancement factor f(E). It is demonstrated that the screened Coulomb potential of the target ion is determined by the nonlinear Vlasov potential and not by the Debye potential. In general, the effect of screening becomes important at low kinetic energy of the projectile. The range of applicability of both the analytical and asymptotic expressions for the electron screening lattice potential energy Uₑ is examined, which is valid only for E>>Uₑ (E is the energy in the center of mass reference frame). It is demonstrated that for E≤Uₑ, a direct calculation of Gamow factor for screened Coulomb potential should be performed to avoid unreasonably high values of the enhancement factor f(E) by the analytical and asymptotic formulae.

### Experimental Setup and Results

Based on the results of the theoretical analysis, a highly screened environment in deuterated metals was selected. Such an environment features the fuel in a very high-density state, together with efficient screening by both shell and conduction electrons, or external ionization or Compton electrons from photon irradiation. Local fusion events were then initiated using hot neutrons that originate from photodisintegration of deuterons bombarded by photons above the 2.226 MeV level. The hot neutrons scatter and efficiently deliver nearly half of their energy to a relatively cold deuteron. The hot deuteron is then able to be scattered at a large angle with a nearby cold deuteron in a highly screened environment, leading to efficient nuclear tunneling and fusion.

This process is fundamentally different than other fusion processes in which all of the fuel nuclei are hot and reside in a weakly screened environment (e.g., in a Tokamak). Such an environment would be dominated by small angle nonproductive elastic Coulomb scattering with an inefficient tunneling probability. Maintaining one of the two fusing nuclei in a relatively cold and well-screened condition provides highly efficient large angle scattering and subsequent tunneling probabilities. Secondary processes following the initial fusion event include kinetically heated boosted fusion reactions, conventional secondary channels with ³He, ³H, alpha particles, etc., and potentially highly energetic interactions with the metal lattice nuclei, including Oppenheimer-Phillips stripping reactions. The goal in this experimentation was to explore fusion processes that make optimal use of highly electron screened environments with high density fuel in a manner conducive to process multiplication via effective secondary reactions. The experiments described herein were guided by the theoretical analysis. The experiments described below further illustrate the fundamental concepts of some embodiments of the present invention, namely, locally hot—globally cold fuel, process initiation and control by hot neutrons created in this particular case by photodistintegration of deuterons by gamma radiation, high density cold fuel, and highly screened fuel nuclei created from a combination of shell and conduction electrons and plasma channels from gamma irradiation.

d-D nuclear fusion events were observed in an electron-screened, deuterated metal lattice by reacting relatively cold deuterons with relatively hot deuterons (d*) produced by elastically scattered neutrons originating from Bremsstrahlung photodissociation. Exposure of deuterated materials (e.g., ErD₃ and TiD₂) to photon energies in the range of 2.5 to 2.9 MeV resulted in photodissociation neutrons below 400 keV and 2.45 MeV neutrons consistent with D(d,n)³He fusion. Additionally, neutron energies of approximately 4 and 5 MeV for TiD₂ and ErD₃ were measured, consistent with either “boosted” neutrons from kinetically heated deuterons or other capture processes.

Neutron spectroscopy was conducted using calibrated lead-shielded liquid (EJ309) and plastic (Stilbene) scintillator detectors. The data supports the subsequent theoretical analysis, predicting fusion reactions and subsequent reactions in highly screened environments. Such screening is naturally provided by shell and metal lattice electrons and by Compton scattering of the Bremsstrahlung radiation, providing plasma channels and further enhancing screening.

A. Electron Accelerator and General Layout

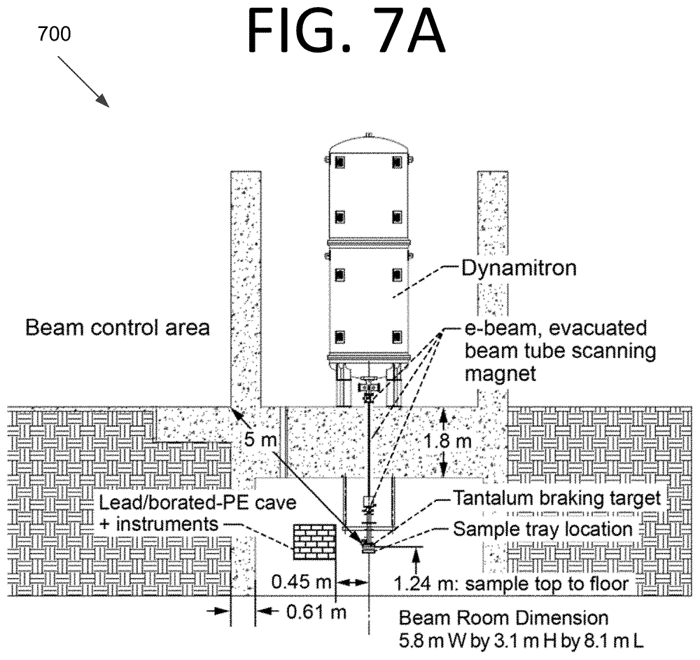

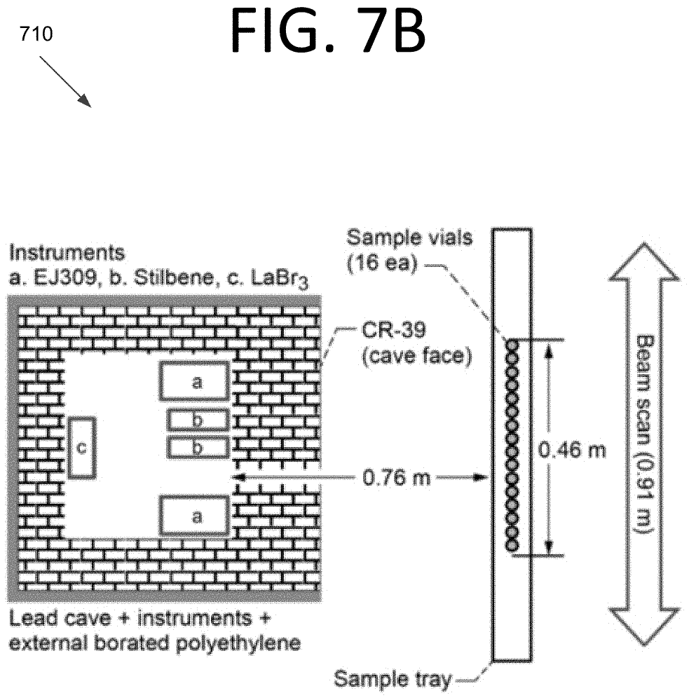

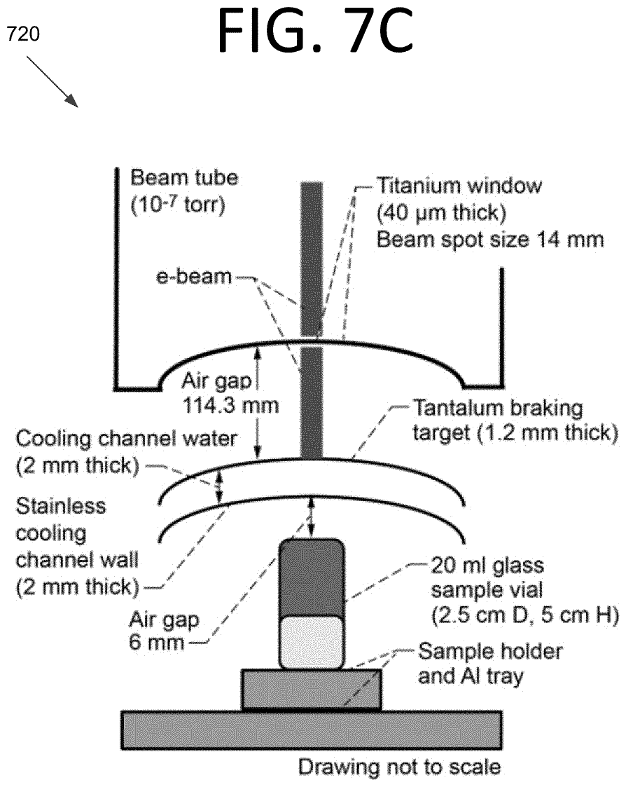

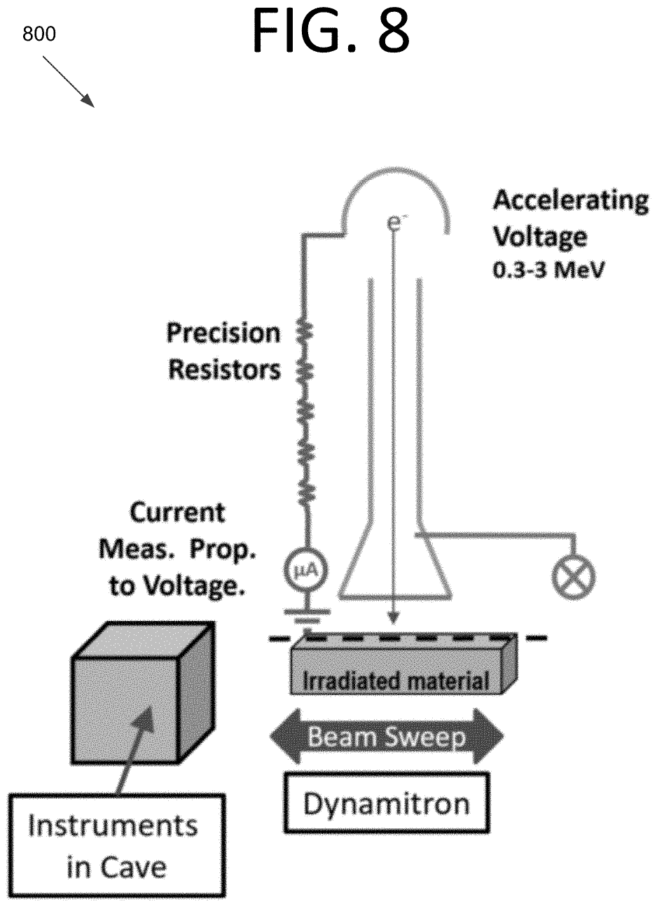

Tests were performed using a Dynamitron electron accelerator having independent control of beam energy (450 keV to 3.0 MeV) and beam current (10 μA to 30 mA), as shown in experimental reactor 700 of FIG. 7A. Lead cave 710 is shown more clearly in FIG. 7B. The direct current-accelerated electron beam enters the beam room via an evacuated tube and is scanned over the braking target, utilizing the scanning magnet ˜1 m above the target. The beam was operated in photon mode for the current tests, utilizing a 1.2 mm-thick tantalum braking target. Samples in glass vials were placed on an aluminum exposure tray close to the tantalum braking target and were exposed while the electron beam scanned at a frequency of 100 Hz over the length of 0.91 m. FIGS. 7A and 7B show the relative position of the 16 samples (total length 0.46 m) and lead cave 710, which housed the neutron detectors and is described below. FIG. 7C is a magnified view 720 of experimental reactor 700 illustrating the close proximity (11.2 mm distance) of the 20 ml sample vials relative to the braking target, which was cooled with ambient-temperature water flowing spanwise in a stainless-steel cooling channel. FIG. 8 shows a more general architecture 800 of the experimental setup, in which electrons are accelerated within a linear accelerator, impinging upon a high Z metal target from which Bremsstrahlung gamma radiation is emitted to impinge upon the sample, which includes a deuterated metal.

B. Cave Description

Due to the intense gamma flux, the detectors (a), (b), (c) were placed in a thick lead cave 710 with the following dimensions: front wall—30.5 cm (12 in); top and side walls—15.3 cm (6 in); and base and rear walls—10.1 cm (4 in). The distance from the sample centerline to the detectors was 0.76 m. Borated polyethylene (B-PE) was used to reduce the large flux of thermal neutrons entering from the sides of the cave to minimize the gamma signals from the reaction Pb(n, γ) from the cave walls, thus improving signal quality. The B-PE thickness was 2.5 cm for the top, sides, and back and 2.5 cm B-PE plus 5 cm normal high-density standard PE for the base of cave 710.

C. Beam Characteristics

1. Photon Flux

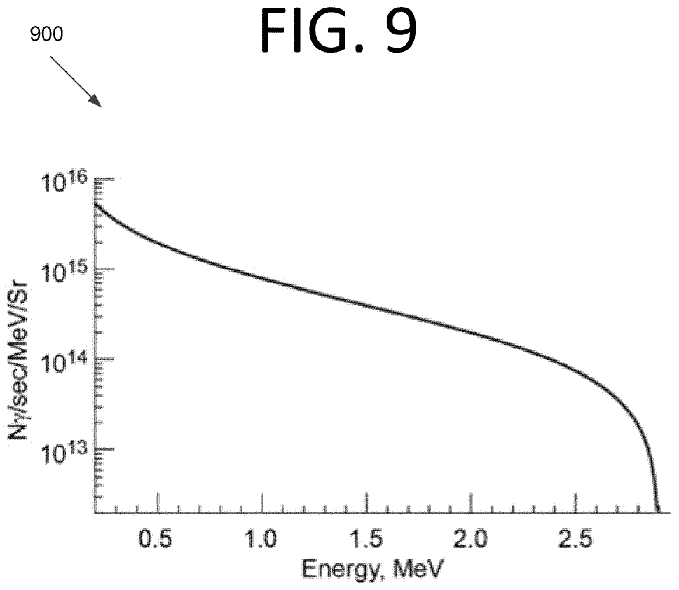

The high Dynamitron beam current exposed the samples to intense photon flux. FIG. 9 is a graph 900 providing the photon spectrum N_{γ} (E_{γ}) for the peak electron beam energy of 2.9 MeV at the top of the sample, as determined using the fitted 5-term interpolation formula, 450 μA of current (per vial):

$${N}_{γ} ( {E}_{γ} ) = ( {c}_{0} + {c}_{1} \cdot {E}_{γ} ) \cdot {( \frac{{E}_{γ}}{{E}_{γ}^{max}} )}^{{α}_{0} + {α}_{1} \cdot {E}_{γ}} \cdot {( 1 - \frac{{E}_{γ}}{{E}_{γ}^{max}} )}^{β} \qquad ( 102 )$$

where E_{γ}^{max} is the maximum photon energy per one incident electron and E_{γ} is photon energy in MeV, with N_{γ} (E_{γ}) in units of photon/second/MeV/Steradian. The constants used were c₀=−3.187×10⁻³, c₁=3.506×10⁻³, α₀=−2.035, α₁=−3.189×10⁻², and β=6.327×10⁻¹. The peak photon energy was corroborated by the lanthanum bromide (LaBr₃) gamma detector (c) mounted in cave 700. The photon flux plotted in FIG. 9 was corroborated by a Monte Carlo (MCNP) analysis modeling the geometry noted in FIG. 7C.

2. Beam Energy Measurement

Beam energy was monitored by measuring a current through a linear stack of resistors to measure the terminal voltage on the electron accelerator. The beam voltage was recorded using a Labview Data Acquisition system and a high-speed triggering scope for short-term transients. The Dynamitron was very stable in beam energy (e.g., 2.9 MeV±100 keV (5a)). Current was also measured and was stable to within 2.5% (5σ) of setpoint. During pre-test evaluation of the Dynamitron, the terminal voltage was checked by exposing beryllium near its photodissociation peaks of 1.76 and 2.42 MeV. By examining the change in the first and second derivatives of neutron production rates, it was determined that the photon beam energy was less than 50 keV of the specified set point, agreeing with the beam terminal voltage measurement method, which was used for all subsequent tests.

3. Photodissociation Neutrons

With the beam operating above the deuteron photodissociation energy (2.226 MeV), photo-neutrons were produced. The peak and average photodissociation neutron energies were calculated, as shown in Table IV below.

TABLE IV
CALCULATED PHOTODISSOCIATION NEUTRON ENERGIES

| | Neutron Energy (MeV) | | |
|---|---|---|---|
| Beam | | Aligned with Beam | Counter to Beam |
| Energy (hv) | Nominal Energy | (0° Direction) | (180° Direction) |
| 2.5 | 0.135 | 0.144 | 0.127 |
| 2.7 | 0.235 | 0.246 | 0.224 |
| 2.9 | 0.335 | 0.348 | 0.321 |
| 3.0 | 0.385 | 0.399 | 0.370 |

D. Neutron Detection

1. Prompt Neutron Detection

Three different neutron detection systems were employed, as noted in Tables V(A) and V(B) below.

TABLE V(A)
NEUTRON DETECTION INSTRUMENT DETAILS

| | Neutron | | | |
|---|---|---|---|---|
| | Detection | | Detector | Location (Distance |
| | Technology | Detector | Dimensions | from Specimens as |
| Detector: | (Manufacturer): | Material: | (cm): | Noted): |
| Eljen-309 | Liquid | Xylene-based | 5 cm diam. by | In cave (0.76 m) |
| (HV) | scintillator; | liquid | 10 cm length | |
| | proton recoil | | | |
| | (Eljen) | | | |
| Stilbene | Plastic, single | Stilbene | 2.5 cm diam. | In cave (0.76 m) |
| (St1) | crystal; proton | crystals | by 2.5 cm | |
| | recoil (InRad | wrapped in | length | |
| | Optics) | PTFE tape; | | |
| | | optically | | |
| | | polished on | | |
| | | face + fused | | |
| | | silica window | | |
| LaBr₃ | Lanthanum | LaBr₃ crystal | 3.8 cm diam. | In the rear of the cave, |
| | bromide detector | | by 3.8 cm | rotated 90° and offset |
| | | | length | toward the entry door |

TABLE V(B)
NEUTRON DETECTION INSTRUMENT DETAILS

| | PMT Voltage | Detector Efficiency | |
|---|---|---|---|
| Detector: | (V): | (Average): | Energy Detection: |
| Eljen-309 | −1100 | 11% | Neutron: |
| (HV) | | | 0.5 to 15 MeV |
| Stilbene | 730 | 13% | Neutron: |
| (St1) | | | 0.3 to 15 MeV |
| LaBr₃ | 730 | Gamma: | 0 to 10 MeV |
| | | ~15% < 1 MeV | |
| | | ~5% 1 to 4.4 MeV | |
| | | 0.1% > 4.4 MeV | |

The Eljen-309 liquid scintillator and the Stilbene single-crystal detector were used to detect prompt fast neutron counts and energies. The Eljen detector (5 cm diameter by 10 cm length) being larger than the Stilbene detector (2.5 cm diameter by 2.5 cm length), had a higher sensitivity to the fast neutrons, resulting in a greater signal. However, due to the unique single-crystal material, the Stilbene could measure slightly lower energy neutrons (0.3 MeV threshold) versus the EJ309 (0.5 MeV threshold). Both detectors pointed toward the specimens during radiation and were shielded from the intense gamma rays with the 30.5 cm front lead wall and surrounding cave. It was found that the Stilbene detector exhibited greater photon/neutron discrimination due to its material and design. A lanthanum bromide (LaBr₃) gamma detector was also placed in the cave (near the rear) and was used to measure gamma energies from both the beam and from thermal neutron capture on the lead walls, resulting in Pb(n, γ) reactions.

A rough estimate of photo-neutrons interacting with the cave was determined by counting the 3 to 8 MeV gammas created during beam on conditions. It is previously noted that to reduce the gamma glow within the cave to acceptable levels, borated polyethylene was placed on all five sides of the cave (except the front), thus minimizing the captured thermal neutrons to reduce the ionizing radiation from the Pb(n, γ). By using the B-PE around the cave, higher beam currents could be utilized, increasing the process signal-to-background noise for the fueled shots to meet the goal of accurately measuring fusion and other reaction neutrons.

2. Prompt Neutron Signal Postprocessing

High-intensity primary Bremsstrahlung and secondary fluorescence x-rays from the Dynamitron beam were the most significant challenges for postprocessing the detector signal, even though the detectors were shielded in the lead cave. The strategy was to record all detector signals without any information loss with the fast data acquisition system (DAQ) throughout the beam exposure. A sophisticated model-based pulse-shaped discrimination (PSD) signal analysis procedure was developed for the postprocessing data analysis.

The detector photomultiplier tube (PMT) signal output was directly connected to a CAEN, 8-channel DT5730 desktop digitizer with 500-MHz sampling rate and 14-bit resolution, which is well suited for the signal from the organic scintillators. The pulse-processing-(DPP)-PSD firmware and control software, CoMPASS, of the digitizer were used for the on-line signal processing, data acquisition monitoring, and waveform recording. Each detector signal was triggered locally at the input channel and recorded independently with the DPP firmware. The Universal Serial Bus (USB) 2.0 interface of the digitizer allows data transfer at a speed of up to 30 MB/s. During the experiment, the data transfer speed was monitored, and data overflow was prevented by increasing the detection threshold, reducing the beam current, reducing the number of detector channels, or increasing the shielding materials. A total of 140 samples (280 ns long) of each signal waveform were recorded for the postprocessing.

3. Energy Calibration

The energy scales of the pulse height spectrum of the detector were periodically calibrated using Cs-137, Co-60, and Th-232 check sources. The PMT gains and calibration stability were important for the PSD performance, the neutron spectrum unfolding, and combining and/or comparing separate sets of experimental data. The detector gain stability across the measurements was confirmed (and corrected) using the 511 keV line during off-line analysis. The neutron detection efficiency of the detector was determined from the known spectra of the AmBe and Cf-252 sources. Average detector efficiency was calculated to be approximately 13% for the Stilbene detectors and 11% for the EJ-309 detectors. Energy-dependent efficiency was used for the response matrix normalization and subsequently for the neutron flux calculation of the detector unfolding.

4. Signal Filtering and Hybrid PSD Approach

A two-stage process was used to process the scintillator data. First, the signal was filtered with a multistep approach to arrive at a series of clean wave forms. Second, a hybrid PSD technique was used to virtually eliminate false neutron counting. The most important filter to remove double peaks and false neutron counting is the Pile-Up signal rejection (PUR). If small peaks (spikes) with amplitudes exceeding 8% of the main peak were observed on the tail of the signal, the signal was rejected from further processing. The rejection criterion was set to 5% for the stronger signals above 1 MeV. The PUR criteria cannot be tighter because it is the delayed secondary scintillator phosphorescence light pulses that give the PSD information. Next, low-amplitude high-frequency noise filters incorporating a root-mean-square (RMS) approach were applied to remove the smaller x-ray signals (spikes) and delayed fluorescence, which may pass through the pile-up rejection criteria. Also, successive neutron recoils within the phosphorescence decay will alter PSD performance. These types of events were further reduced by the signal root-mean-square (RMS) and baseline shift filters. The pile-up rate increases with the beam energy and current. For example, at beam conditions of 2.9 MeV and 15 mA the filters rejected about 35% (passing 65%) of all triggered signals.

The clean wave forms were subsequently processed by the hybrid PSD algorithm. The PSD processing also consisted of a multistep approach. The signal was first processed through a frequency-gradient method with fast-Fourier transform (FFT) and wavelet analysis. Next, each signal was compared to a predetermined neutron or gamma template waveform. Finally, the charge integration method was then applied comparing the “tail” area to the overall area, resulting in the PSD parameter versus electron equivalent energy, as shown Section III (Experimental Results) below.

All signals that passed through those filters were subsequently plotted in the PSD spectrum. Due to the high gamma flux the neutron pulse height spectrum was accepted if the PSD parameter was above an 8σ threshold of the gamma ray band. Therefore, “accepted” waveform shapes reliably resulted in neutron signatures. The PUR algorithm coupled with the 8σ constraint on the PSD between neutron and gamma PSD parameter virtually eliminated neutron double hits (aliasing) and gamma signals being recorded as neutrons. The 8σ constraint also reduced fast-neutron counts considerably, but significantly increased the fidelity of the overall data and the neutron energy measurement. For reference purposes, the peak photo neutrons produced were less than 400 keV. This was below the Eljen-309 threshold and was also below the Stilbene ability to measure on account of the 8σ constraint window used to ensure separation of neutrons from gammas in the PSD.

5. Neutron Energy Determination

As discussed above, the detectors were calibrated in electron-equivalent units, as were the measured neutron pulse height spectra. The steps used to unfold the detector response include the following. First, MCNPX-Polimi and MPPost postprocessing codes were used to generate the detector response matrix. Subsequently, the HEPROW computer code package obtained from Oak Ridge National Lab (RSICC), which used Bayes theorem and maximum entropy methods, was utilized for the spectrum unfolding.

Three different unfolding codes were evaluated: GRAVELW, UNFANAW, and MIEKEW. A calibration study was performed in which a 40-mCurie AmBe neutron source was placed near the scintillator detectors while data was collected. Good correlation was found across the energy range when comparing the AmBe unfolded results with the well-known AmBe spectrum. The best correlation was found using the GRAVELW unfolding code, which was subsequently used in the final reported results.

The input files of the unfolding code were the experimental spectra and the detector response matrix. The response matrix is the ideal pulse height spectra with monoenergetic neutrons hitting the detector. Neutron count uncertainty is assumed to be the standard uncertainty assigned to contents in one channel assuming Poisson statistics hold, and is the square root of the number of counts. It is also assumed that no correlation exists between different channels. The neutron penetration through the cave (lead and B-PE) was simulated using the MCNP6 code. For reference purposes, the lead cave scattered approximately 80% of incoming fusion neutrons.

E. Sample Materials and Methodology

1. Sample Materials

The samples exposed in this study were created from prepared batches of either deuterated or bare (no-load) erbium or titanium metal material. Table IV below provides the materials, test shot identifier, shot durations, energy, and current settings that were used. In the test shot exposures, ErD₃ (480 g in 16 vials) and TiD₂ (216 g in plate and powder form) samples containing 5×10²⁴ deuterium atoms were used. No additional deuterium atoms were added to the samples.

TABLE VI
TEST SHOT SAMPLE EXPOSURES

| | | Exposure | Beam | |
|---|---|---|---|---|
| | | Duration | Energy | |
| Test Shot ID | Material | (min) | (MeV) | Current (mA) |
| TS 589 | Er, bare | 270 | 2.9 | 15 |
| (a, a2, f, g, Rd) | | | | |
| TS 589Ra | Er, bare | 30 | 2.5 | 15 |
| TS 589b2 | Er, bare | 30 | 2.7 | 15 |
| TS 589c2 | Er, bare | 30 | 2.8 | 15 |
| TS 589d2 | Er, bare | 30 | 3.0 | 15 |
| TS 589Rb | Er, bare | 30 | 2.9 | 5 |
| TS 589Rc | Er, bare | 30 | 2.9 | 10 |
| TS 589Re | Er, bare | 15 | 2.9 | 25 |
| TS 589Rf | Er, bare | 15 | 2.9 | 30 |
| TS1575 | ErD₃ | 360 | 2.9 | 15 |
| (a, Ra, Rb) | | | | |
| TS1575Rb | ErD₃ | 30 | 2.9 | 5 |
| TS1575Rc | ErD₃ | 30 | 2.9 | 10 |
| TS1575Rd | ErD₃ | 30 | 2.9 | 20 |
| TS1575Re | ErD₃ | 15 | 2.9 | 25 |
| TS1575Rf | ErD₃ | 15 | 2.9 | 30 |
| TS1576 | ErD₃ | 360 | 2.9 | 15 |
| (c, c2, e, Rb) | | | | |
| TS5176Ra | ErD₃ | 60 | 2.5 | 15 |
| TS5176a | ErD₃ | 30 | 2.7 | 15 |
| TS5176b | ErD₃ | 30 | 2.8 | 15 |
| TS5176d | ErD₃ | 30 | 3.0 | 15 |
| TS(610, 611, | TiD₂ | 330 | 2.9 | 15 |
| 611R, 612) | | | | |
| TS631 | Ti, bare | 60 | 2.9 | 15 |

In Table VI, black rows indicate baseline configuration, gray rows indicate beam energy study, and white rows indicate beam current study. Note that test shots TS1575 and 1576 were distinct samples made from ErD₃ and were exposed to evaluate reproducibility. These samples evaluated reproducibility of the process using specimens made from different material batches and exposed on different test days, and outcomes were comparable. Samples were tracked using meticulous records for custody control from material loading through exposure and posttest analysis using high-purity germanium (HPGE) gamma scans and liquid beta scintillator counting.

For each test, the samples were placed into glass vials and subsequently positioned at a close distance to the tantalum braking target (see FIG. 7C) to maximize the flux per unit area per unit time to evaluate the hypothesis that fusion events could be initiated with ionizing radiation in deuterated metal lattices where the deuterium fuel was in a stationary center-of-mass frame. Natural-abundance erbium (99% purity) and titanium (99% purity) were deuterated by gas loading using appropriate pressure, temperature, and time protocols. Erbium was chosen for this study for several reasons: (1) Erbium loads to ErD₃ have a high fuel number density (8×10²² D-atoms/cm³); (2) Erbium showed enhanced nuclear reactions via LINAC exposure in previous tests; (3) Erbium metal maintains a high deuteron stoichiometry between furnace D-loading and testing; and (4) Erbium (Z=68) provides a mid-range of metal lattice screening without excessive metal lattice interaction reducing fusion reactions.

Titanium was also exposed under comparable conditions to examine the effect of a higher fuel number density (1×10²³ D-atoms/cm³) and lower atomic mass (Z=22), approximately ⅓ the positive nuclear charge of Er, which also contributed to fewer metal lattice screening electrons. The sample mass change (accuracy ±5%) from before until after gas loading was used to determine the D-loading of the sample materials. Note 99.999% ultra-high-purity gas was used to deuterate the samples. Although the vials were sealed during exposure, air was used as the cover gas.

2. Case-Control Methodology

A case-control methodology was utilized, where identical tests were performed on fueled and unfueled samples, to isolate the fuel as the only experimental variable. For consistency between the ErD₃ and TiD₂, the same amount of fuel (5×10²⁴ D-atoms) was exposed. This amounted to 480 g of ErD₃ or 216 g TiD₂, respectively, exposed in 16 vials. For the unfueled case, a comparable mass of bare Er and bare Ti was exposed. As will be shown in the results below, during unfueled shots, there was some neutron activity above cosmogenic background. This activity is believed to have been caused by screened reactions from the naturally occurring deuterium (153 ppm) in various standard water-cooling passages in the Dynamitron that were exposed to either direct or indirect gamma irradiation. For reference, the braking target cooling channel contained 1.6×10²² D-atoms and the scanner side cooling passages contained 1.2×10²² D-atoms.

III. Experimental Results

A. Pulsed Shape Discrimination Spectra

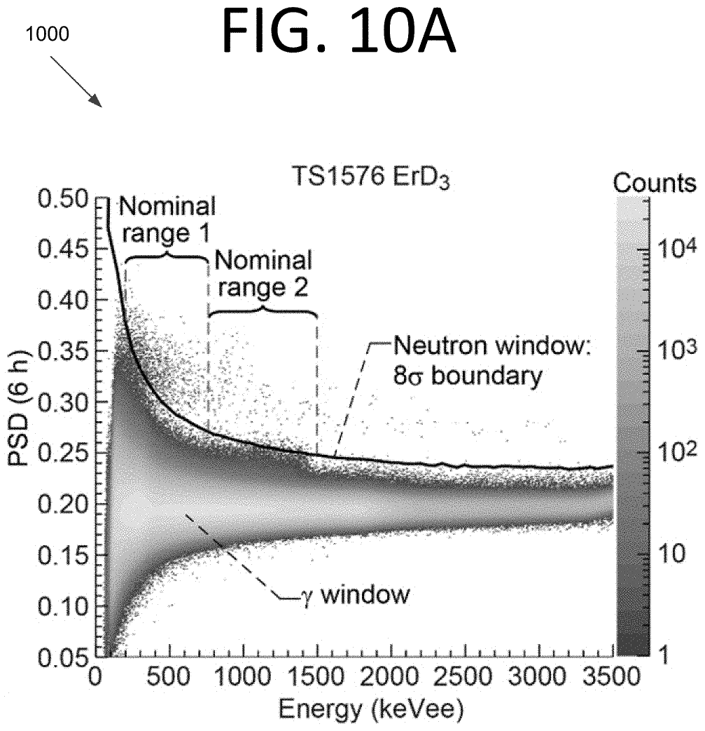

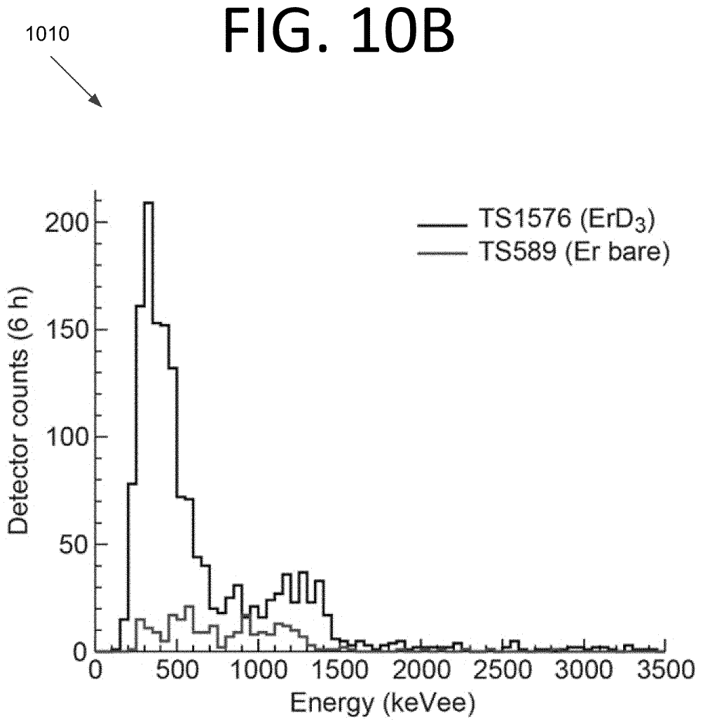

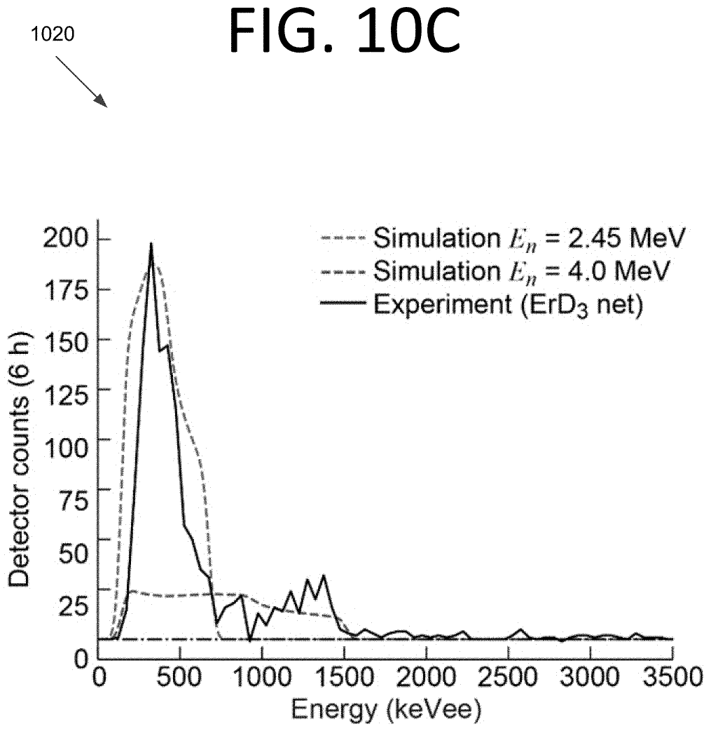

FIG. 10A provides an example Pulse Shape Discrimination (PSD) plot 1000 relating PSD parameters versus electron equivalent energy recorded in the detector (EJ309 HV) for TS1576 ErD₃ with beam conditions of 2.9 MeV and 15 mA and a 6-hour exposure. It should be noted that FIG. 10A includes ellipses illustrating nominal energy ranges (ranges 1 and 2) corresponding to those counts from the PSD plot that, when unfolded, lead to the nominal 2.45 MeV and 4 MeV neutron energies discussed in Section III(B). As noted in the Neutron Detection section, an 8σ constraint window was used to ensure separation of neutrons from gammas. Data points occurring above the 8σ separator line were confidently counted as neutrons and not gammas.

B. Comparison of Fueled Versus Unfueled Results

As described above, a case-control methodology was followed where ErD₃ (fueled) samples and Er-bare (unfueled) samples were exposed in separate exposures, holding constant all other experimental parameters, including sample material type and mass, beam energy and current, sample placement under the beam, detector placement, and cave configuration. FIG. 10B is a graph 1010 that presents the EJ309 detector results for TS1576 (fueled, black line above) and TS589 (unfueled, dark gray line below) in detector counts (PMT counts after filtered using the process noted earlier) versus electron energy equivalent units (keVee). The small spikes to the right of the peaks are all from the fueled results. FIG. 10C is a graph presenting a comparison of the net counts (TS1576 (fueled) minus TS589 (unfueled) prior to unfolding with the HEBROW algorithms and shows the results of two relevant comparison cases. For reference purposes, the simulation results were scaled as follows: 2.45 MeV spectrum per neutron was scaled up by 17000 and the 4 MeV neutron spectrum was scaled up by 6000 to roughly match the area under the experimental curves. The 6-hour data shows significantly higher detector counts during the fueled exposures.

In the simulations, a monochromatic neutron source with neutron energies (Eₙ) of either 2.45 MeV or 4 MeV are used as the input to the MCNPX-Polimi model of the EJ-309 detector. The fusion energy neutrons result in simulated detector spectra centered on the main peak. The detector counts for 4 MeV neutrons have a broader energy response and correlate with the higher energy measured counts. It is noted that the shape of the curve for ErD₃ in the 0 to 800 keVee range bears significant resemblance to previous results by Lang, who used a similar scintillator/PSD approach to measure neutron energies for a 35-DD-W-S NSD/Gradel Fusion d-D fusion neutron generator.

C. Neutron Spectra and Reproducibility

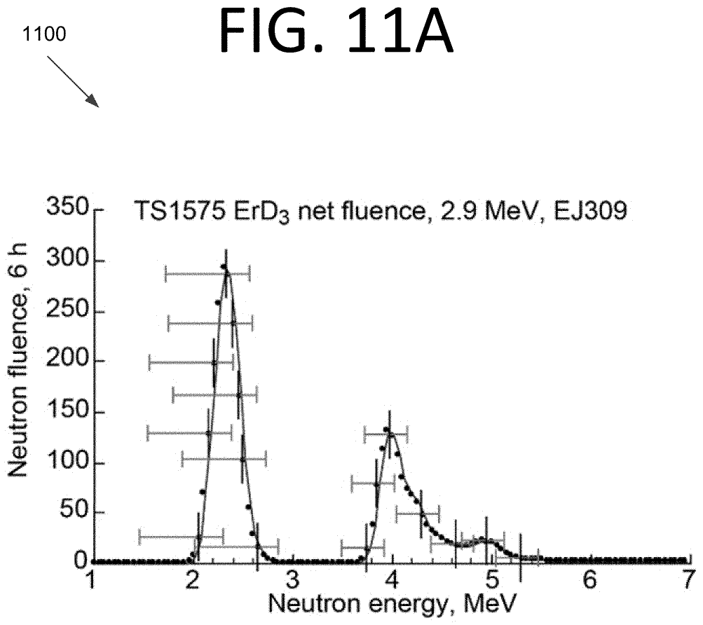

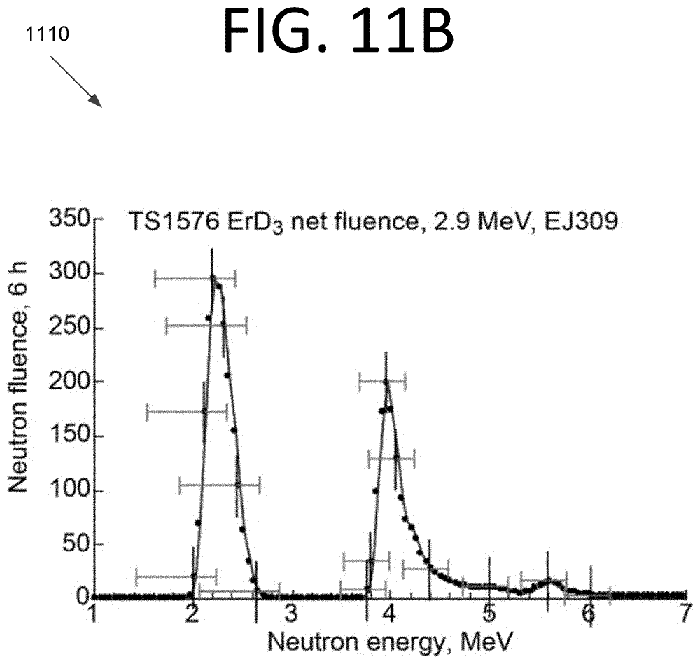

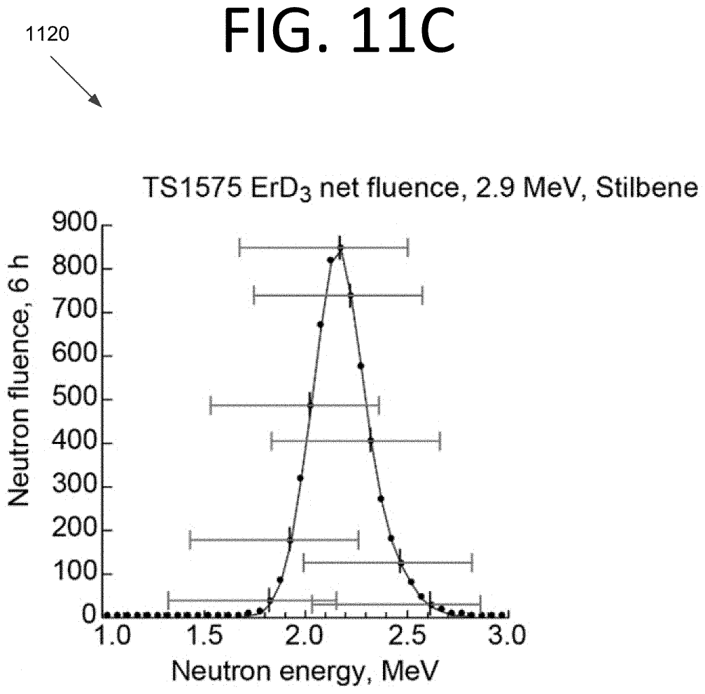

Utilizing the methods for the detector modeling and neutron energy unfolding described earlier, the “net” (fueled minus unfueled) PSD data was converted into neutron spectra. Graphs 1100, 1110, 1120 of FIGS. 11A-C present data showing neutron spectra measured for the 6-hour aggregate data for two separate ErD₃ test samples. FIGS. 11A-C show evidence of (1) fusion neutron production (all); (2) neutrons with greater than fusion energies (EJ309); and (3) reproducibility of the process. The uncertainty bars represent 3σ. Fusion energy neutron counts were scaled to sample location. TS1575 1.5×10³ neutron counts per second and TS1576 1.6×10³ neutron counts per second using EJ309 and 14×10³ neutron counts per second using the Stilbene detector. It should be noted that the Stilbene detector exhibits better gamma/neutron separation, and thus, fewer true neutrons are discarded during postprocessing, resulting in the higher neutron count rate.

FIG. 11A is for TS1575 and FIG. 11B is for TS1576. Both were corrected for background and unfueled exposure. The HEBROW unfolding algorithm incorporates the intrinsic detector efficiency. The unfolded neutron spectra showed a number of interesting features, including several primary neutron energy peaks of 2.45, 4, and to a lesser degree, 5 MeV, plus an apparent shoulder peak 4.2 MeV. The measured neutron energies were remarkably close, indicating process reproducibility. FIG. 10C shows the neutron spectra for TS1575 measured using the solid-state Stilbene detector, showing the nominal 2.45-MeV fusion neutron peak, which was in the calibrated range of the detector. The higher energy peaks occur in the nonlinear range of the detector, and are not presented here.

D. Alternate Material Exposure: Titanium Deuteride

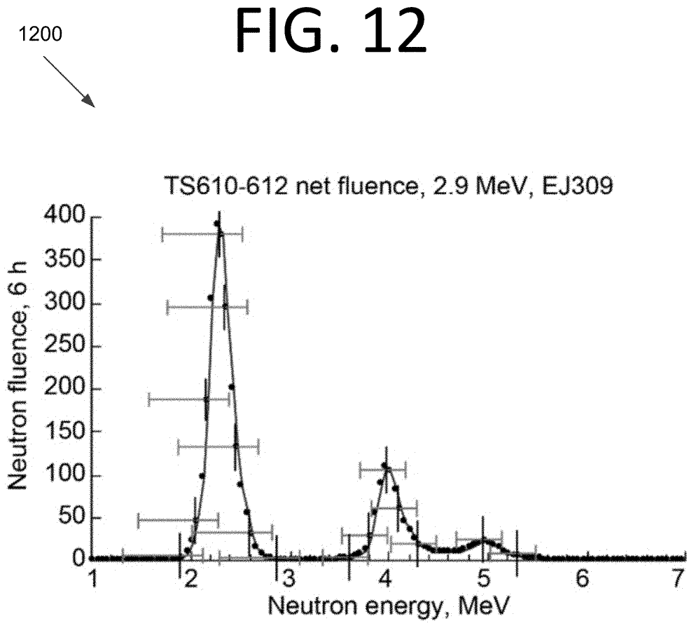

Graph 1200 of FIG. 12 shows the neutron spectra for TiD₂ using the EJ309 detector for the “net” fueled (TS611-612) minus unfueled (TS631) PSD data. The unfolded neutron spectra showed a number of interesting features, including several primary neutron energy peaks of 2.45 (fusion energy), 4, and to a lesser degree 5 MeV, and an apparent shoulder peak at 4.2 MeV. It is noted that the fluence fusion-energy neutron peak (˜2.45 MeV) is approximately 30% higher for the TiD₂ than for the ErD₃, accounting also for the exposure times.

E. Comparison Neutron Production in Titanium Deuteride Versus Erbium Trideuteride

Fusion Energy Neutrons:

Comparing integrated fusion neutron counts of TiD₂ and ErD₃, one finds TiD₂ produces 1.31 times more neutrons than ErD3. Recall that fusion reaction rates are proportional to the D-fuel number density squared (n²). TiD₂ has slightly higher number density (1×10²³ D/cm³) than ErD₃ (0.8×10²³ D/cm³). Squaring the ratios of the number densities one would expect to measure approximately 1.56 times more fusion neutrons for TiD₂ than for ErD₃. It is recognized that if the number density of TiD₂ were just slightly less (0.92×10²³ vs. 1×10²³ D/cm³), one could account for the small discrepancy.

Higher Energy Neutrons (˜4 MeV):

Higher counts of ˜4 MeV neutrons were measured for ErD₃ as compared to the TiD₂. This general trend would be in alignment of screened Oppenheimer-Phillips reactions favoring higher Z base metals. However, because there are other factors at work (i.e., neutron energy boosting) occurring simultaneously, additional research may be beneficial to understand the differences in the 4 MeV neutron production found for TiD₂ and ErD₃.

F. Measurement Uncertainty

The uncertainty bars for the neutron spectra in FIGS. 11A-C and 12 were determined based on the combined effect of detector energy resolution and the unfolding algorithm. The neutron energy uncertainty (horizontal band) was determined using the perturbation method. First the standard deviation in electron equivalent units was determined by examining the response of the detectors to established gamma peaks for standard check sources (Cs-137 and Co-60) by fitting a Gaussian distribution resulting in a σ˜50 keVee. To obtain the plotted 3σ, the original spectrum was “offset” by either +150 keVee or −150 keVee, corresponding to ±3σ on the EJ309 detector energy resolution, (or ±120 keVee for the slightly better resolution Stilbene detector) prior to unfolding. Once unfolded, the shifts in the neutron energy peaks (e.g., fusion neutron peak at 2.4 MeV) were determined for both the plus and minus unfolded spectrum.

This perturbation analysis resulted in a slightly asymmetric neutron energy uncertainty band, biased toward the lower energy, as shown in the figures. The fluence uncertainty (vertical bands) were determined using the GRAVEL unfolding methodology using ±3σ. Note that for clarity, the uncertainty bars were plotted on the figures for only select data points.

IV. Discussion

A. Evidence of Fusion and Fast Neutrons

1. Fusion Neutrons

As shown in FIGS. 11A-C, there are several distinct peaks corresponding to primary fusion neutrons as well as neutrons potentially resulting from subsequent fusion reactions. Kinematic derivations for neutron heating of the deuteron discussed in the theoretical section above were used to calculate the range of neutron energies caused by the heated fuel. See Table VII below.

TABLE VII
CALCULATED NEUTRON ENERGIES RESULTING FROM
KINETIC HEATING OF DEUTERIUM FUEL

| | | | | | | Product |
|---|---|---|---|---|---|---|
| | | | | Product | | Neutron |
| | | | | Deuteron | | Energy |
| | | | | Energy | | Range, n*, |
| | | | | Range d*, | | for |
| | | | | for n- | Total | (n*,³He*) |
| | | | Projectile | Recoil | Energy | Recoil |
| | | | Neutron | Angle: 0 | (Q + | Angle: 0 |
| | | Cross | Energy, n | to 180° | KE_{d}*) | to 180° |
| Generation | Reaction | Section | (MeV) | (MeV) | (MeV) | (MeV) |
| Initial: | (n, d*) | 3 | 0.145 (average | 0.064 (average | 0.145 | N/A |
| Photo neutron | | | photo neutron | d*; 2.9 MeV | | |
| heating | | | energy; | beam) | | |
| creating d* | | | 2.9 MeV | | | |
| | | | beam) | | | |
| Gen 1: | D(d*, n*)³He | 0.017 | N/A | 0.064 | 3.33 | 2.2 to 2.76 |
| Fusion reaction | D(d*, p*)³H | | | | | |
| with heated d* | | | | | | |
| as projectile | | | | | | |
| Fusion | (n, d*) | 2.3 | 2.2 to 2.76 | 0.98 to | 4.25 to 4.54 | N/A |
| neutron | | | | 1.27 | | |
| heating of | | | | | | |
| d* | | | | | | |
| Gen 2: | D(d*, n*)³He | 0.1 | N/A | 0.98 to | 4.25 to 4.54 | 1.77 to |
| Subsequent | | | | 1.27 | | 4.12 |
| fusion | | | | | | (for |
| reaction | | | | | | d* = 0.98 |
| with d* as | | | | | | MeV) |
| projectile | | | | | | 1.72 to |
| | | | | | | 4.45 |
| | | | | | | (for |
| | | | | | | d* = 1.27 |
| | | | | | | MeV) |

Bremsstrahlung at 2.9 MeV gives rise to photoneutrons with an average neutron energy of 0.145 MeV. Neutron-deuteron recoil then causes a hot deuteron with average energy of 0.064 MeV. Given enhanced screening as described above, a hot deuteron may fuse with a cold deuteron. The separation angle of the (n, 3He) recoil products from 0° to 180° leaves the neutron with 2.2 to 2.76 MeV. This energy spread, coupled with the full-width at half maximum (FWHM) of the instrument, explains some of the broadening of the neutron peaks. A second generation fusion neutron heats a deuteron (n, d*), giving rise to neutron energies from 1.72 to 4.45 MeV. These energies bracket the span of the secondary peak and shoulder of 4 to 4.2 MeV, noted in FIGS. 11A and 11B.

2. Efficiency of Detecting Fusion Neutrons

From the point at which the fusion neutrons are created until they are counted in the detector, there are several loss mechanisms. Tables VIII(A) and VIII(B) below list the factors influencing detector efficiency for measuring fusion (2.45 MeV) neutron counts, where absolute detector efficiency equals the product of all columns.

TABLE VIII(A)
FACTORS INFLUENCING DETECTOR EFFICIENCY

| | | Data Postprocessing Factors | | |
|---|---|---|---|---|
| | Detector | Filters (PU, | PSD | |
| | Intrinsic | FFT, and | Template | |
| Detector: | Efficiency: | baseline RMS): | Matching: | 8σ: |
| Eljen-309 | 0.49 | 0.65 | 0.88 | 0.42 |
| (HV) | | | | |
| Stilbene | 0.21 | 0.82 | 0.94 | 0.78 |
| (St1) | | | | |

TABLE VIII(B)
MORE FACTORS INFLUENCING DETECTOR EFFICIENCY

| | Cave Factor | | |
|---|---|---|---|
| | (Neutrons Passing | Geometric | Absolute Detector Efficiency |
| Detector: | through Cave): | Factor: | (Product): |
| Eljen-309 | 0.20 | 0.0003 | 7 × 10⁻⁶ |
| (HV) | | | |
| Stilbene | 0.20 | 0.00007 | 2 × 10⁻⁶ |
| (St1) | | | |

Per the above, these factors include detector intrinsic efficiency, three data postprocessing factors, a cave factor (i.e., neutrons passing through the cave), and a geometric factor. The data postprocessing factors account for effects of the filter, template-matching, and 8σ cut. The final column tabulates absolute detector efficiency, which is the product of the above-noted factors for both the EJ-309 and Stilbene. Based on these analyses, for every 1×10⁶ fusion energy neutrons created, the following numbers would be detected and reported: EJ-309 ˜7 neutrons; stilbene ˜2 neutrons.

3. Other Enhanced Nuclear Reactions

FIGS. 11A-C and 12 show evidence of distinct peaks of neutrons having ˜4 and ˜5 MeV energies. The 4 MeV peak appears sharp, potentially indicating unique nuclear reactions and not simple energy boosting from hot fuel reactions ((n, d*) followed by or (d*, n)). Examining FIG. 10(a), these higher energy neutrons correspond to PSD counts in the ˜1000 to 1500 keVee range. To confirm that these counts were not caused by intense (n,γ) reactions with the surrounding materials, the LaBr₃ spectrum was examined in this energy range and revealed a monotonically decreasing spectrum with no structure, which may raise concerns of gamma leakage into the neutron channel.

In the highly deuterated metal lattice, which provides shell and lattice screening coupled with temporal plasma filaments from the gamma radiation, it appears that other processes (for example, Oppenheimer-Phillips stripping processes in the highly screened environment) occurred where a fast neutron is ejected and the proton fuses with the metal nuclei. The theoretical section above calculated very large enhancement factors, on the order of 10¹³ above bare cross sections given ¹⁶⁶Er shell and photon-induced plasma screening. Consequently, 50 to 60 keV deuterons may react with the lattice atoms.

Table IX below presents candidate reactions with the candidate host metal isotopes.

TABLE IX
POSSIBLE REACTIONS WITH BASE METAL RESULTING IN
FAST-NEUTRON EMISSIONS

| | | | | | Average | |
|---|---|---|---|---|---|---|
| | Base Metal | | | | Neutron | |
| | Natural | Q- | | Projectile | Kinetic | |
| | Abundance | Value | | Energy | Energy | Notes: (Decay: |
| Reaction | (%) | (MeV) | Projectile | (MeV) | (MeV) | Half Life) |
| ¹⁶⁶Er(d, n)¹⁶⁷Tm | ¹⁶⁶Er/33.61 | 2.68 | d | 1.27 | 3.91 | ¹⁶⁷Tm: Unstable |
| | | | | | | (electron capture: |
| | | | | | | 9.25 d) |
| ¹⁶⁷Er(d, n)¹⁶⁸Tm | ¹⁶⁷Er/22.93 | 3.09 | d | 1.27 | 4.32 | ¹⁶⁸Tm: |
| | | | | | | Unstable (positron |
| | | | | | | decay: 93 d) |
| ¹⁶⁸Er(d, n)¹⁶⁹Tm | ¹⁶⁸Er/26.78 | 3.35 | d | 1.27 | 4.58 | ¹⁶⁹Tm: Stable |
| ¹⁷⁰Er(d, n)¹⁷¹Tm | ¹⁷⁰Er/14.93 | 4.17 | d | 0.87 | 5.00 | ¹⁷¹Tm: Unstable |
| | | | | | | (beta decay: 1.92 |
| | | | | | | yr) |
| ¹⁷⁰Er(d, n)¹⁷¹Tm | ¹⁷⁰Er/14.93 | 4.17 | d | 1.27 | 5.39 | ¹⁷¹Tm: Unstable |
| | | | | | | (beta decay: 1.92 |
| | | | | | | yr) |
| ¹⁶⁶Er(³He, n)¹⁶⁸Yb | ¹⁶⁶Er/33.61 | 3.50 | ³He | 0.4 | 4.00 | ¹⁶⁸Yb: Stable |
| ¹⁶⁸Er(³He, n)¹⁷⁰Yb | ¹⁶⁸Er/26.78 | 4.63 | ³He | 0.4 | 5.00 | ¹⁷⁰Yb: Stable |
| ¹⁷⁰Er(³He, n)¹⁷²Yb | ¹⁷⁰Er/14.93 | 6.01 | ³He | 0.82 | 6.77 | ¹⁷²Yb: Stable |
| ⁴⁶Ti(d, n)⁴⁷V | ⁴⁶Ti/8.25 | 2.94 | ^{d} | 1.2 | 4.03 | ⁴⁷V: Unstable |
| | | | | | | (positron decay: |
| | | | | | | 32.6 min) |
| ⁴⁷Ti(²H, n)⁴⁸V | ⁴⁷Ti/7.44 | 4.61 | ²H | 0.40 | 4.91 | ⁴⁸V: Unstable |
| | | | | | | (positron decay: |
| | | | | | | 15.9 d) |

Table IX also provides the resulting neutron energies for various “projectile” particles, with product energies consistent with either D(d*, p*)T or D(d*, n*)³He. One can see for erbium that several reactions may result in 4-MeV neutrons (e.g. 166Er(d, n)¹⁶⁷Tm or ¹⁶⁶Er(³He, n)¹⁶⁸Yb) or 5-MeV neutrons (e.g., ¹⁷⁰Er(d, n)¹⁷¹Tm or ¹⁶⁸Er(³He, n)¹⁷⁰Yb). For titanium, 4-MeV neutrons may result from ⁴⁶Ti(d, n)⁴⁷V and 5-MeV neutrons may result from ⁴⁷Ti(d, n)⁴⁸V. Table IX also indicates whether the product is stable and gives the decay half-life if unstable. The stable isotopes would not be seen during the posttest HPGE gamma scans, nor would the longer half-life isotopes. Post-exposure HPGE gamma analyses did not reveal isotopes other than ones obtained via neutron capture.

Based on the above observations, it appears that both primary d-D fusion and Oppenheimer-Phillips stripping processes in the highly screened environment occurred. Evidence of these energetic neutrons indicates attractive nuclear processes are occurring with energetic products (n*, p*, t*, ³He*), which can result in subsequent nuclear processes.

B. Comparison of Experimental Deuteron Heating to Published Work

Mori conducted direct-drive ICF experiments with deuterated polystyrene spheres. See Mori et al., “Fast heating of fuel assembled in a spherical deuterated polystyrene shell target by counter-irradiating tailored laser pulses delivered by a HAMA 1 Hz ICF driver,” Nucl. Fusion 57 116031 (2017). Using a three-step pulse, Mori observed that deuteron heating had occurred. Detailed time-of-flight neutron measurements along the axis (0°) and off-axis (90°) indicated both fusion energies (90°) and neutrons having greater than fusion energy. Although Mori doesn't highlight it, there is evidence of 2.45-MeV neutrons even on the “on-axis” case in his work. Similarly, the peak at 1.8 MeV may be an example of neutrons which have “cooled” by deuteron heating. There is some evidence of neutrons in the 4 MeV range. In Mori, the nominal 4-MeV peak shows a relatively broad base and seems to be consistent with boosted neutrons resulting from deuteron heating with energy ranges consistent with those in Table VIII. However, note that the 4-MeV peak in FIG. 11A rises sharply, which suggests that there is a primary reaction, such as Oppenheimer-Phillips stripping processes, consistent with the candidate reactions in Table VIII.

C. Comparision of Measured and Theoretical Calculations

1. d-D Fusion Rates, Calculation

Using the theoretical methods outlined herein, an estimate of the d-D fusion rates for the following conditions was determined: 2.9-MeV beam energy and 450-μA current for each of the 16 vials. The calculations were performed in Mathematica using the following steps: (1) calculation of the bremsstrahlung spectrum from 0 to 2.9 MeV using the five-term beta function approximation with a 2.9-MeV endpoint (see FIG. 9 for spectra); (2) calculation of the photoneutron energy spectra; (3) determination of the resulting deuteron energy spectra (from these calculations, it should be noted that the average photoneutron energy was 145 keV and average hot deuteron energy was 64 keV); and (4) determination of the number of d-D reactions per second per vial, utilizing shell and plasma screening. Of the total number of d-D reactions per second, half would have created neutrons via D(d,n)³He and the other half would have created protons via D(d,p)T. Utilizing both shell and plasma screening, with a screening length λ_{sc}=4.16×10⁻¹⁰ cm, a total reaction rate of 1.2×10³ neutrons/s was calculated for all 16 samples. It should be noted that the calculations did not include any subsequent processes described above, nor were all theoretical considerations included at this time.

2. d-D Fusion Rates, Experimental

Fusion energy neutron counts scaled to the sample location were determined to be 1.5±0.3×10³ neutrons/s for TS1575 and 1.6±0.3×10³ neutrons/s for TS1576 via the EJ-309 detector, showing process reproducibility. These values were obtained by scaling the neutron counts integrated in the fusion energy range (nominally 2.0 to 2.6 MeV) to account for detector factors effecting detector sensitivity of measuring neutron counts as outlined in Table VII. The measured neutron rate for the fusion channel energies for all 16 vials compared favorably with the calculated value.

### EXPERIMENTAL CONCLUSIONS

Per the above, it is demonstrated that efficient electron screening on localized fusion rates in a dense fuel environment can lead to a significant increase in reaction rates. Based on the theoretical analysis above, neutrons can be exploited to effectively heat deuterons in primary and subsequent reactions, with the well-screened cold target fuel providing screening by shell, conduction, and plasma electrons, resulting in d-D reactions measured by characteristic fusion energy neutrons. This fusion cycle is performed at a high fuel density inside a metal lattice to enable subsequent reactions with the host metal nuclei and other secondary processes.

More specifically, exposure of deuterated materials, including ErD₃ and TiD₂, to Bremsstrahlung photon energies (≤2.9 MeV) resulted in both photodissociation-energy neutrons and neutrons with energies consistent with D(d, n)³He fusion reactions. Furthermore, process reproducibility was demonstrated. Several key ingredients required for fusion reactions are also identified above. Deuterated metals present a unique environment with a high fuel density (10²² to 10²³ D-atoms/cm³), which further increases the fusion reaction probability through shell and lattice electron screening, reducing the d-D fusion barrier.

Exposing deuterated fuels to a high photon flux creates local plasma conditions near the cold D-fuel. This additional screening further increases the Coulomb barrier transparency and further enhances fusion reaction rates. In these experiments, deuterons were initially heated by photoneutrons with an average energy of 145 keV for the 2.9 MeV beam energy to initiate fusion. However, other neutron sources would also provide the necessary deuteron kinetic energy. Calculations in the theoretical section indicate that neither electrons nor photons alone impart sufficient deuteron kinetic energy to initiate measurable d-D reactions.

Neutron spectroscopy revealed that both d-D 2.45-MeV fusion neutrons and other processes occurred. The data also indicates that the significant screening enabled charged reaction products (hot d* or 3He*) to interact with the host metal. These interactions may produce the ˜4 MeV and ˜5 MeV neutrons, where the Oppenheimer-Phillips stripping processes occurred in the strongly screened environment. Some embodiments thus demonstrate the ability to create enhanced nuclear reactions in highly deuterated metals with the deuteron fuel in a stationary center-of-mass frame. This process eliminates the need to accelerate the deuteron fuel into the target with implications for various practical applications.

Medical Isotopes

Medical isotopes are a critical aspect of many modern medical diagnostic techniques and procedures. Techniques for radioisotope production include various neutron activation and creation mechanisms to produce an isotope of a specific decay chain, as well as techniques for separation of the desired isotope from the source materials and any ancillary products also produced as part of the activation/creation processes. Activation of a source is typically accomplished by neutron activation in a nuclear reactor, and also by using energetic photons, electrons, protons, alpha particles, and others from a variety of machines specifically designed to accelerate these particles. Targets in many configurations, both fluids and solids, are impacted, and as a consequence of these impacts, a fraction of the original target material is transmuted, whether isotopic or elemental. Chemical post-processing of targets after activation results in the isolation of the desired radioisotope.

Isotope-specific systems, and often more than one system for most isotopes, have been designed and redesigned as the machinery used in the production processes has improved. As medical research is an ever-changing field, the number of isotopes of interest varies, and in some cases, the development of a new isotope production technique influences the usage of that isotope in medical procedures. Various radioisotopes may be used to treat cancer and other medical conditions, provide diagnostic information about the functioning of various organs, and sterilize medical equipment, among other applications. Tables X and XI below provide lists of isotopes, half-lives, and uses for conventionally produced reactor and cyclotron radioisotopes, respectively.

TABLE X
REACTOR-PRODUCED RADIOISOTOPES

| ISO- | HALF- | |
|---|---|---|
| TOPE: | LIFE: | APPLICATIONS: |
| ²¹³Bi | 46 min | Used for targeted alpha therapy (TAT), especially |
| | | cancers, due to its high energy (8.4 MeV) |
| ¹³⁷Cs | 30 years | Used for low-intensity sterilization of blood |
| ⁵¹Cr | 28 days | Used to label red blood cells and to quantify |
| | | gastrointestinal protein loss |
| ⁶⁰Co | 5.27 years | Formerly used for external beam radiotherapy, now |
| | | almost universally used for sterilization |
| ¹⁶⁵Dy | 2 hours | Used as an aggregated hydroxide for synovectomy |
| | | treatment of arthritis |
| ¹⁶⁹Er | 9.4 days | Used for relieving arthritis pain in synovial joints |
| ¹⁶⁶Ho | 26 hours | Being developed for diagnosis and treatment of |
| | | liver tumors |
| ¹²⁵I | 60 days | Used in cancer brachytherapy (prostate and brain), |
| | | used diagnostically to evaluate the filtration rate of |
| | | kidneys and to diagnose deep vein thrombosis in |
| | | the leg, and widely used in radioimmuno-assays to |
| | | show the presence of hormones in tiny quantities |
| ¹³¹I | 8 days | Widely used in treating thyroid cancer and in |
| | | imaging the thyroid, as well as in diagnosis of |
| | | abnormal liver function, renal (kidney) blood flow, |
| | | and urinary tract obstruction; while a strong gamma |
| | | emitter, this isotope is used for beta therapy |
| ¹⁹²Ir | 74 days | Supplied in wire form for use as an internal |
| | | radiotherapy source for cancer treatment (used then |
| | | removed); beta emitter |
| ⁵⁹Fe | 46 days | Used in studies of iron metabolism in the spleen |
| ²¹²Pb | 10.6 hours | Used in TAT for cancers or alpha |
| | | radioimmunotherapy, with decay products ²¹²Bi |
| | | and ²¹²Po delivering the alpha particles; used |
| | | especially for melanoma, breast cancer, and |
| | | ovarian cancer |
| ¹⁷⁷Lu | 6.7 days | Increasingly important as it emits just enough |
| | | gamma radiation for imaging while the beta |
| | | radiation does the therapy on small (e.g., |
| | | endocrine) tumors; half-life is long enough to allow |
| | | sophisticated preparation for use; usually produced |
| | | by neutron activation of natural or enriched ¹⁷⁶Lu |
| | | targets |
| ⁹⁹Mo* | 66 hours | Used as the “parent” in a generator to produce |
| | | ^{99m}Tc |
| ¹⁰³Pd | 17 days | Used to make brachytherapy permanent implant |
| | | seeds for early stage prostate cancer |
| ³²P | 14 days | Used in the treatment of polycythemia vera (excess |
| | | red blood cells); beta emitter |
| ⁴²K | 12 hours | Used for the determination of exchangeable |
| | | potassium in coronary blood flow |
| ¹⁸⁶Re | 3.8 days | Used for pain relief in bone cancer; beta emitter |
| | | with weak gamma for imaging |
| ¹⁸⁸Re | 17 hours | Used to beta irradiate coronary arteries from an |
| | | angioplasty balloon |
| ¹⁵³Sm | 47 hours | Highly effective in relieving the pain of secondary |
| | | cancers lodged in the bone, sold as Quadramet ™, |
| | | and also very effective for prostate and breast |
| | | cancer; beta emitter. |
| ⁷⁵Se | 120 days | Used in the form of seleno-methionine to study the |
| | | production of digestive enzymes |
| ²⁴Na | 15 hours | Used for studies of electrolytes within the body |
| ⁸⁹Sr | 50 days | Highly effective in reducing the pain of prostate |
| | | and bone cancer; beta emitter |
| ^{99m}Tc* | 6 hours | Used to image the skeleton and heart muscle in |
| | | particular, but also for brain, thyroid, lungs |
| | | (perfusion and ventilation), liver, spleen, kidney |
| | | (structure and filtration rate), gall bladder, bone |
| | | marrow, salivary and lacrimal glands, heart blood |
| | | pool, infection, and numerous specialized medical |
| | | studies; also produced from ⁹⁹Mo in a generator |
| ¹³³Xe | 5 days | Used for pulmonary (lung) ventilation studies |
| ¹⁶⁹Yb | 32 days | Used for cerebrospinal fluid studies in the brain |
| ¹⁷⁷Yb | 1.9 hours | Progenitor of ¹⁷⁷Lu |
| ⁹⁰Y | 64 hours | Used for cancer brachytherapy and as a silicate |
| | | colloid for the relieving the pain of arthritis in |
| | | larger synovial joints; pure beta emitter and of |
| | | growing significance in therapy, especially for liver |
| | | cancer |

TABLE XI
CYCLOTRON-PRODUCED RADIOISOTOPES

| ISO- | HALF- | |
|---|---|---|
| TOPE: | LIFE: | APPLICATIONS: |
| ¹¹C, | Not | Positron emitters used in PET for studying brain |
| ¹³N, | provided | physiology and pathology, and in particular, for |
| ¹⁵O, | | localizing epileptic focus, and in dementia, for |
| ¹⁸F | | psychiatry and neuropharmacology studies; also |
| | | have a significant role in cardiology; ¹⁸F in |
| | | fluorodeoxyglucose (FDG) has become very |
| | | important in the detection of cancers and the |
| | | monitoring of progress in their treatment using PET |
| ⁵⁷Co | 272 days | Used as a marker to estimate organ size and for in- |
| | | vitro diagnostic kits |
| ⁶⁴Cu | 13 hours | Used to study genetic diseases affecting copper |
| | | metabolism, such as Wilson's and Menke's diseases, |
| | | and for PET imaging of tumors and therapy |
| ⁶⁷Cu | 2.6 days | Beta emitter, used in therapy |
| ¹⁸F | Not | Also used as a tracer in the form of fluorothymidine |
| | provided | (FLT), fluoromisonidazole (F-miso), and 18F- |
| | | choline |
| ⁶⁷Ga | 78 hours | Used for tumor imaging and localization of |
| | | inflammatory lesions (infections) |
| ⁶⁸Ga | 68 min | Positron emitter used in PET and PET-CT units; |
| | | derived from ⁶⁸Ge in a generator |
| ⁶⁸Ge | 271 days | Used as the “parent” in a generator to produce ⁶⁸Ga |
| ¹¹¹In | 2.8 days | Used for specialized diagnostic studies, e.g., brain |
| | | studies, infection, and colon transit studies |
| ¹²³I | 13 hours | Increasingly used for diagnosis of thyroid function; |
| | | a gamma emitter without the beta radiation of ¹³¹I |
| ¹²⁴I | Not | Tracer |
| | provided | |
| ^{81m}Kr | 13 sec | Produced from ⁸²Rb (4.6 hours), ^{81m}Kr gas can |
| | | yield functional images of pulmonary ventilation, |
| | | e.g. in asthmatic patients, and for the early |
| | | diagnosis of lung diseases and function |
| ⁸²Rb | 1.26 min | Convenient PET agent in myocardial perfusion |
| | | imaging |
| ⁸²Sr | 25 days | Used as the “parent” in a generator to produce ⁸²Rb |
| ²⁰¹TI | 73 hours | Used for diagnosis of coronary artery disease other |
| | | heart conditions such as heart muscle death and for |
| | | location of low-grade lymphomas |

Radioisotopes of cesium, gold, and ruthenium are also used in brachytherapy.

The (*) designates the importance of ⁹⁹Mo and ^{99m}Tc (metastable). ⁹⁹Mo, and its product ^{99m}Tc, are arguably the most important conventional radioisotopes since ^{99m}Tc is used in over 80% of diagnostic nuclear medical imaging. ⁹⁹Mo is by far the most used isotope and has been the focus of many competitive production techniques within the last decade.

Newer isotope research is adding different and more complex production techniques for ⁹⁹Mo. Similar situations exist for the roughly 40 isotopes currently in use at medical facilities around the world. Linear accelerator (LINAC) production is also being developed as a new technique.

However, of the hundreds, if not thousands, of isotopes that are known to exist or are theoretically possible, only dozens are conventionally available for use in modern medicine. This limits treatments to the specific characteristics of these isotopes. Also, many of these isotopes are in limited supply and/or are difficult to obtain. Furthermore, certain medical isotopes must be produced and rapidly delivered to a medical facility in order to be effective. For instance, ⁹⁹Mo, which is generally a byproduct of the fission of ²³⁵U in nuclear reactors, has a half-life of 66 hours. Thus, it is imperative that ⁹⁹Mo be rapidly separated and processed since half of the supply thereof is lost every 66 hours. Additionally, once ^{99m}Tc is generated from the ⁹⁹Mo, half the supply thereof is lost every six hours. Thus, significant infrastructure, logistical resources and coordination, and expense are required to deliver ^{99m}Tc in time to be useful for imaging applications. Many other radioisotopes have even shorter half-lives, and may decay so rapidly as to be impractical for medical purposes.

However, per the above, a linear accelerator (LINAC) may be used to facilitate deeply screened fusion. Many hospitals have LINACs, which are rarely in use at night. As such, while a hospital could purchase another LINAC for dedicated use, many would already have the machine without further investment.

The target medical isotope may be created within a lattice, which may by itself be the material to be transmuted. Other chemical means could subsequently be used to purify the medical isotope. For instance, “moly cows” may be used to purify ^{99m}Tc.

By using the hospital's LINAC to create medical isotopes on-site, various benefits may be realized. For instance, the value of the LINAC is increased since its useful operating time is increased. Also, medical isotopes with relatively short half-lives, such as ⁹⁹Mo and ^{99m}Tc, which have half-lives of 66 hours and 6 hours, respectively. This reduces the production and transportation costs, as well as the risks of exposure of various personnel to radiation during the transportation process. Additionally, it may no longer be necessary to perform chemical separation to obtain the radioisotope of interest. Furthermore, certain radioactive isotopes, such as alpha emitters with half-lives on the order of minutes that may be used to treat cancer, may be created and utilized. Conventionally, this is extremely impracticable or impossible.

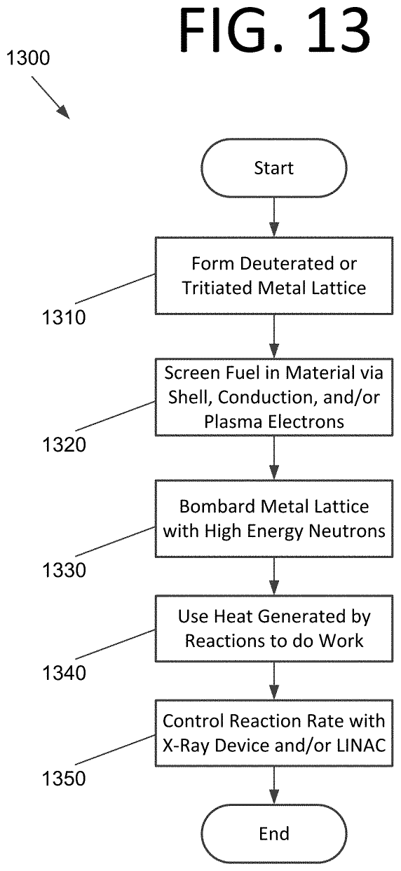

FIG. 13 is a flowchart 1300 illustrating deeply screened fusion reaction process, according to an embodiment of the present invention. The process begins with forming a metal lattice capable of forming a solid matrix with embedded nuclear fuel (such as deuterium or tritium) nuclei at 1310. The Coulomb barrier transparency is increased by screening the fuel via shell, conduction, and/or plasma electrons (i.e., photons) at 1320. The deuterated or tritiated metal lattice is then bombarded with high energy neutrons at 1330. The high energy neutrons may be provided by a LINAC, a radioactive element, or both. The high energy neutrons elastically scatter with the nuclear fuel nuclei, heating the fuel nuclei. Some of the nuclear tunnel screened hot and cold fuel nuclei fuse. Hot neutrons are also generated by the nuclear fusion and these elastically scatter with cold fuel nuclei as well, heating the nuclei. Nuclear tunnel screened fuel nuclei fuse, or alternatively, go through an Oppenheimer-Phillips reaction, reacting the screened hot fuel nuclei with a metal lattice nuclei. Additional materials may optionally be included to reflect neutrons escaping the reacting volumes, such as beryllium, materials for participating in nuclear reactions such as lithium deuteride, and/or others.

In some embodiments, such as for medical isotope production, the products of the reaction itself may be the end result of the process. However, in some embodiments, heat generated by the reactions is used to do work, as in step 1340. For instance, the heat may be used to drive a generator and create electricity and/or to warm a system. The reaction rate may be controlled in some embodiments by adjusting the amount of x-rays and/or gamma rays that are produced by an x-ray device and/or a LINAC at 1350.

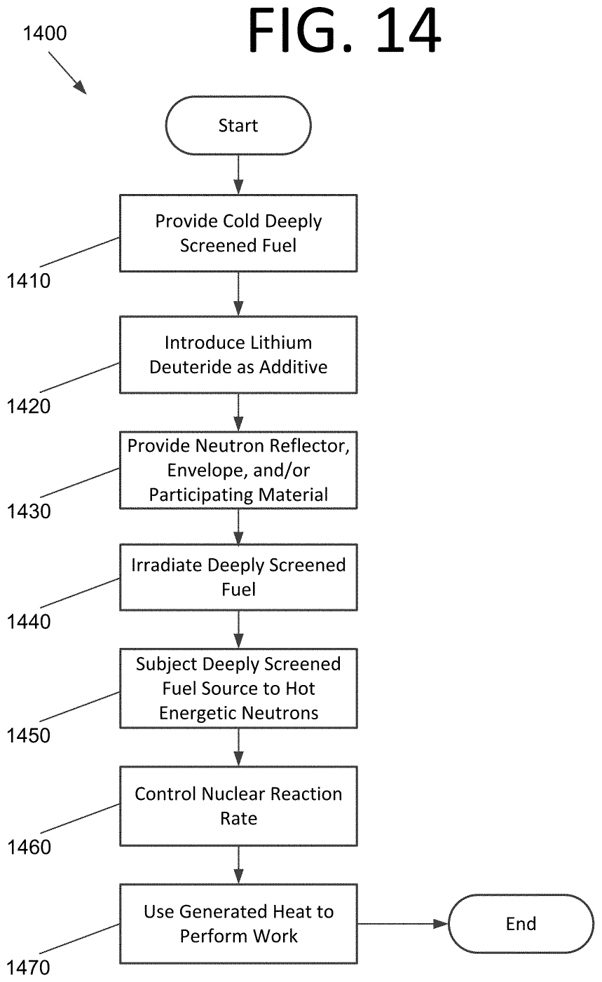

FIG. 14 is a flowchart illustrating a process 1400 for locally hot but globally cold nuclear fusion, according to an embodiment of the present invention. The process begins with providing cold deeply screened fuel at energies below 1 electron volt (eV) at 1410 that enhances nuclear tunneling. Lithium deuteride (LiD) is introduced at 1420 as an additive to participate in reactions following lithium disintegration. A neutron reflector, an envelope, a participating fissionable material, or any combination thereof, are provided at 1430. The participating fissionable material may include, but is not limited to, a deuterated or tritiated fissile actinide (e.g., UD₃) to participate in fission reactions following initial deuteron disintegration. These may be provided to reflect or moderate hot neutrons to facilitate further nuclear reactions, or both.

In some embodiments, the deeply screened fuel includes a deuterated and/or tritiated metal lattice. In certain embodiments, the deuterated and/or tritiated metal lattice includes lithium, boron, beryllium, one or more high Z metals, or any combination thereof. In some embodiments, the deuterated and/or tritiated metal lattice includes an element to be transmuted into a medical isotope. In certain embodiments, the deuterated and/or tritiated metal lattice includes molybdenum and the medical isotope includes technetium-99m. In some embodiments, the deuterated and/or tritiated metal lattice includes elements capable of Oppenheimer-Phillips reactions with deuterons having kinetic energies in a keV range. In certain embodiments, the deuterated and/or tritiated metal lattice includes a radioactive material. In some embodiments, the deeply screened fuel includes ⁷Li and the energetic neutrons are produced with an energy of at least 3 MeV, resulting in direct production of a neutron cluster. The neutron cluster participates in further nuclear reactions with the deeply screened fuel.

The deeply screened fuel is irradiated at 1440 with γ-quanta and/or energetic electron e-beam ionizing radiation sufficient to create plasma channels within the deeply screened fuel. The plasma creates highly screened conditions between adjacent nuclei in the deeply screened nuclear fuel. The deeply screened fuel is subjected to hot energetic neutrons at energies of 1 keV or more at 1450 that scatter off of target particles, thereby delivering a portion of kinetic energies of the energetic neutrons to the target particles and causing local nuclear fusion within the deeply screened fuel. In some embodiments, steps 1440 and 1450 may occur concurrently.

In some embodiments, the hot energetic neutrons are created by irradiation from one or more isotopes utilizing processes such as Pb-108 (γ,n) or U-238(γ,n), where γ>9 MeV, photodisintegration of deuteron fuel nuclei in the deeply screened fuel using gamma irradiation, from ensuing reactions after initial fusion or other nuclear reactions from hot neutron scattering, from secondary fission processes, or any combination thereof. In certain embodiments, the portion of atoms in the deeply screened fuel that undergo local nuclear fusion is 10⁹ or less of a total fuel volume. In some embodiments, a total rate of nuclear reactions in an overall volume comprising the deeply screened fuel is at least 10⁹ reactions per second per cubic centimeter, but less than 10¹⁶ reactions per second per cubic centimeter.

The nuclear reaction rate is controlled at 1460 by adjusting a flux of x-rays and/or gamma rays produced by an x-ray device, a LINAC, or both. The nuclear reaction rate may be sufficiently low that energy generated by the local nuclear fusion is sufficiently dispersed by conduction, convection, radiation, or any combination thereof, outside of the deeply screened fuel that the metal lattice self-heals and re-deuterates, that the deuterated material maintains a chemical composition, or that the fuel remains in a gaseous, liquid, or solid state. Heat generated by the nuclear reactions is then used to perform work, such as to produce electric power via a generator, at 1470.

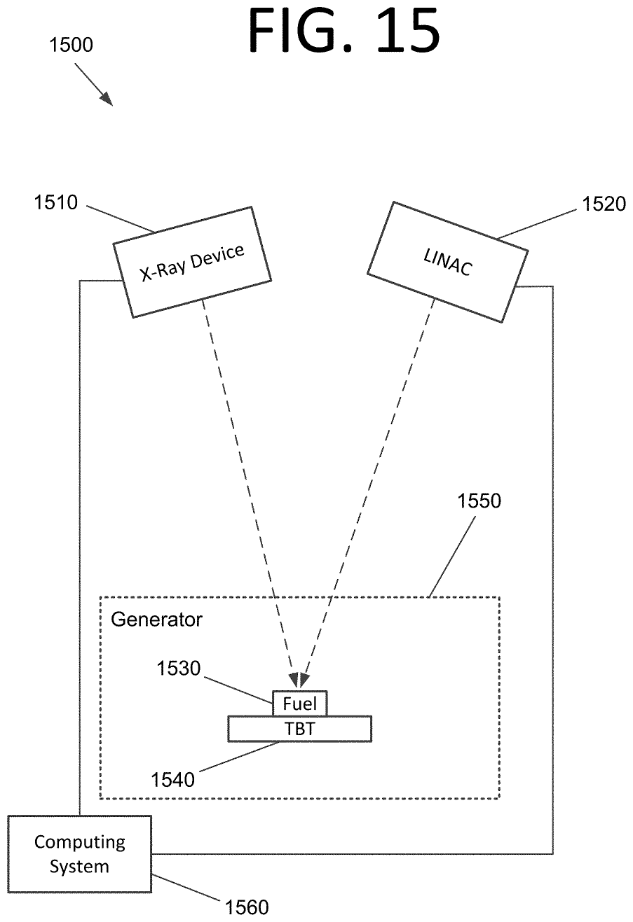

FIG. 15 is an architectural diagram illustrating a fusion reaction system 1500, according to an embodiment of the present invention. System 1500 includes an x-ray device 1510 and a LINAC 1520 for producing photo neutrons and providing an ionization source. However, in many embodiments, only one of these devices would be included.

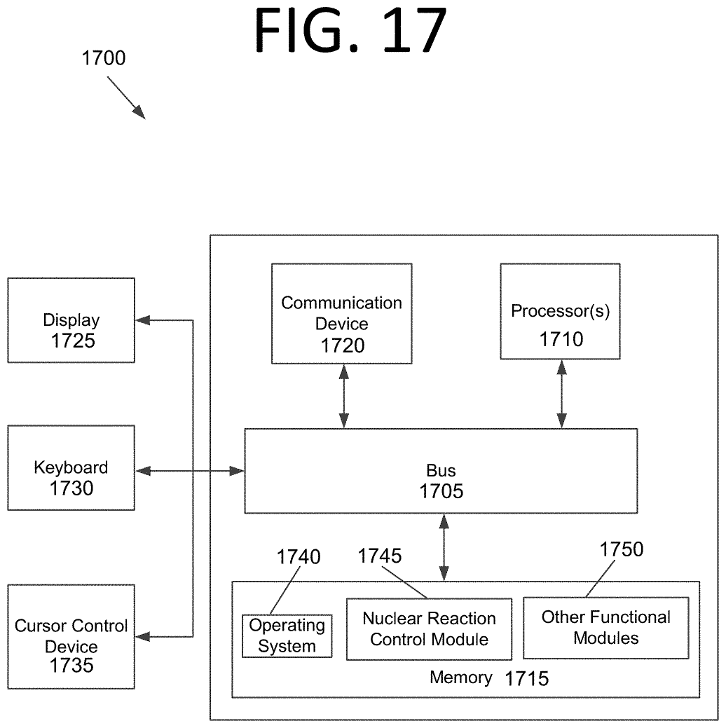

X-ray device 1510 and LINAC 1520 bombard a deeply screened deuterated and/or tritiated fuel target 1530 with x-rays and gamma rays, respectively. In some embodiments, fuel 1530 includes a fissionable material. Fuel 1540 is located on a tantalum braking target 1540. Subjecting deeply screened deuterated and/or tritiated fuel target 1530 to x-rays and gamma rays causes fusion reactions to occur, producing heat. This heat is used by a generator 1550 to create electricity (e.g., by heating water, creating steam, and using the steam to turn the generator). A computing system 1560 (e.g., computing system 1700 of FIG. 17) controls operation of x-ray device 1510 and LINAC 1520.

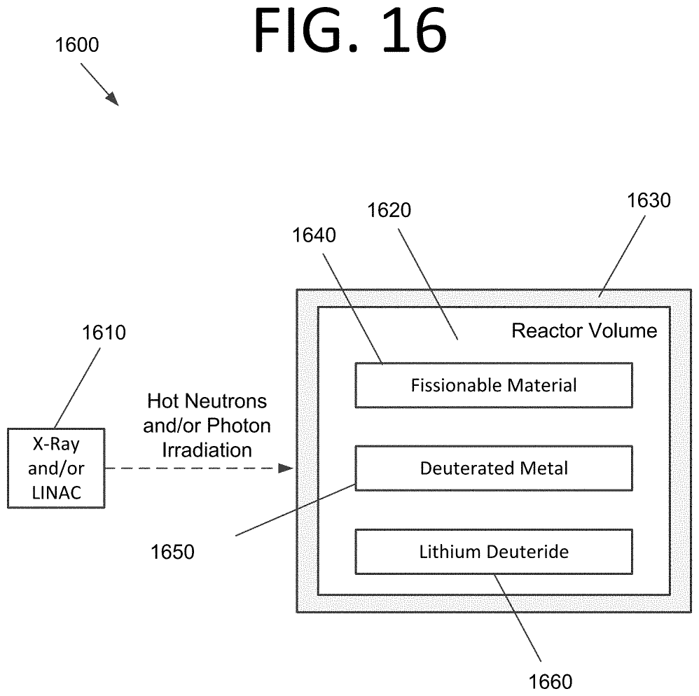

FIG. 16 is an architectural diagram illustrating a fusion-based reaction system 1600, according to an embodiment of the present invention. System 1600 includes an x-ray device and/or LINAC 1610 that provides hot neutrons and/or photon irradiation into a reactor volume 1620, which is surrounded by a reflecting and/or moderating envelope 1630. Reactor volume 1620 houses a fissionable material 1640, a deuterated metal 1650 (e.g., a material other than LiD), and lithium deuteride 1660. Providing hot neutrons and/or photon irradiation to reactor volume 1620 causes fissionable material 1640, deuterated metal 1650, and lithium deuteride 1660 to participate in the nuclear reactions described above. Alternatively, system 1600 could be designed with only fissionable material 1640 that is capable of forming a solid solution with deuterium fuel (e.g., UD₃), with only fissionable material 1640 in addition to deuterated metal 1650, with LiD 1660 in addition to deuterated metal 1650, with LiD 1660 in addition to fissionable material 1640 that is capable of forming a solid solution with deuterium fuel, or with any other combination of fissionable material 1640, deuterated metal 1650, and LiD 1660 without deviating from the scope of the invention.

FIG. 17 is a block diagram illustrating a computing system 1700 configured to control a nuclear reaction rate, according to an embodiment of the present invention. In some embodiments, computing system 1700 may be a control system configured to control a fusion reactor. Computing system 1700 includes a bus 1705 or other communication mechanism for communicating information, and processor(s) 1710 coupled to bus 1705 for processing information. Processor(s) 1710 may be any type of general or specific purpose processor, including a central processing unit (CPU) or application specific integrated circuit (ASIC). Processor(s) 1710 may also have multiple processing cores, and at least some of the cores may be configured to perform specific functions. Multi-parallel processing may be used in some embodiments. Computing system 1700 further includes a memory 1715 for storing information and instructions to be executed by processor(s) 1710. Memory 1715 can be comprised of any combination of random access memory (RAM), read only memory (ROM), flash memory, cache, static storage such as a magnetic or optical disk, or any other types of non-transitory computer-readable media or combinations thereof. Additionally, computing system 1700 includes a communication device 1720, such as a transceiver and antenna, to wirelessly provide access to a communications network.

Non-transitory computer-readable media may be any available media that can be accessed by processor(s) 1710 and may include volatile media and/or non-volatile media. The media may be removable and/or non-removable media.

Processor(s) 1710 are further coupled via bus 1705 to a display 1725, such as a Liquid Crystal Display (LCD), for displaying information to a user. A keyboard 1730 and a cursor control device 1735, such as a computer mouse, are further coupled to bus 1705 to enable a user to interface with computing system. However, in certain embodiments such as those for mobile computing implementations, a physical keyboard and mouse may not be present, and the user may interact with the device solely through display 1725 and/or a touchpad (not shown). Any type and combination of input devices may be used as a matter of design choice.

Memory 1715 stores software modules that provide functionality when executed by processor(s) 1710. The modules include an operating system 1740 for computing system 1700. The modules further include a nuclear reaction control module 1745 that is configured to control the rate of nuclear reactions. Computing system 1700 may include one or more additional functional modules 1750 that include additional functionality.

One skilled in the art will appreciate that a “system” could be embodied as an embedded computing system, a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method for locally hot but globally cold nuclear fusion, comprising:
providing cold deeply screened fuel at energies below 1 electron volt (eV) that enhances nuclear tunneling; and
subjecting the deeply screened fuel to hot energetic neutrons at energies of 1 keV or more that scatter off of target fuel particles, thereby delivering a portion of kinetic energies of the energetic neutrons to the target particles and causing local nuclear fusion within the deeply screened fuel source.

2. The method of claim 1, further comprising:
irradiating the deeply screened fuel with γ-quanta and/or energetic electron e-beam ionizing radiation sufficient to create plasma channels within the deeply screened fuel, further creating deeply screened conditions between adjacent nuclei in the nuclear fuel with at least one of the adjacent nuclear fuel nuclei being cold.

3. The method of claim 1, wherein
the deeply screened fuel comprises deuterated hydrogen isotopes within a metal lattice, pressurized deuterium, or liquid deuterium.

4. The method of claim 1, wherein the hot energetic neutrons are created by irradiation from one or more radioactive isotopes, photodisintegration of deuteron fuel nuclei in the deeply screened fuel using gamma irradiation, from reactions from hot neutron scattering in the deeply screened fuel, from secondary fission processes, or any combination thereof.

5. The method of claim 4, wherein a rate of atoms reacting within the deeply screened fuel is sufficiently low that energy generated by the local nuclear fusion is sufficiently dispersed by conduction, convection, radiation, or any combination thereof, outside of the deeply screened fuel that the metal lattice self-heals and re-deuterates, that the deuterated material maintains a chemical composition, or that the deeply screened fuel remains in a gaseous, liquid, or solid state.

6. The method of claim 1, wherein a total rate of nuclear reactions in an overall volume comprising the deeply screened fuel is at least 10⁹ reactions per second per cubic centimeter, but less than 10¹⁶ reactions per second per cubic centimeter.

7. The method of claim 1, wherein a portion of atoms of the deeply screened fuel that undergo local nuclear fusion per second is 10⁻⁹ or less of a total fuel volume.

8. The method of claim 1, wherein the energetic neutrons are provided by photodisintegration of the deeply screened fuel via energetic photons provided by a linear accelerator (LINAC), directly from a radioactive element, or both, and the method further comprises:
controlling the LINAC via a computing system to provide a desired photon flux at desired energy levels, inserting the radioactive element to provide hot neutrons into and/or near the deeply screened fuel, or both, to provide process control and initiation.

9. The method of claim 1, wherein
the deeply screened fuel comprises a deuterated metal, a tritiated metal, or both, and
the deuterated and/or tritiated metal comprises lithium, boron, beryllium, one or more high Z metals, a fissionable material, or any combination thereof.

10. The method of claim 9, wherein the deuterated and/or tritiated metal lattice comprises elements capable of Oppenheimer-Phillips reactions with deuterons having kinetic energies in a keV range.

11. The method of claim 9, further comprising:
introducing lithium deuteride (LiD) as an additive into the deeply screened fuel to participate in reactions following lithium disintegration.

12. The method of claim 1, wherein
the deeply screened fuel comprises a deuterated and/or tritiated metal lattice, and
the deuterated and/or tritiated metal lattice comprises an element to be transmuted into a medical isotope.

13. The method of claim 12, wherein
the deuterated and/or tritiated metal lattice comprises molybdenum, and
the medical isotope comprises technetium-99m.

14. The method of claim 1, further comprising:
controlling a nuclear reaction rate by adjusting a flux of x-rays and/or gamma rays produced by an x-ray device, a linear accelerator (LINAC), or both.

15. The method of claim 1, further comprising:
using heat generated by nuclear reactions in the deeply screened fuel to perform work.

16. The method of claim 1, further comprising:
providing a neutron reflector, an envelope, a participating fissionable material, or any combination thereof to reflect or moderate hot neutrons, to facilitate further nuclear reactions, or both.

17. The method of claim 1, wherein the deeply screened fuel comprises a deuterated and/or tritiated metal lattice additionally comprising a radioactive material capable of fission reactions.

18. The method of claim 1, wherein
the deeply screened fuel comprises ⁷Li, and
the energetic neutrons are produced with an energy of at least 3 MeV, resulting in direct production of a neutron cluster, the neutron cluster participating in further nuclear reactions with the deeply screened fuel.

19. A method for locally hot but globally cold nuclear fusion, comprising:
irradiating deeply screened fuel with γ-quanta and/or energetic electron e-beam ionizing radiation sufficient to create plasma channels within the deeply screened fuel, further creating deeply screened conditions between adjacent nuclei in the deeply screened nuclear fuel with at least one of the adjacent nuclear fuel nuclei being cold;
creating hot energetic neutrons at energies of 1 keV or more via irradiation from one or more radioactive isotopes, photodisintegration of deuteron fuel nuclei in the deeply screened fuel using gamma irradiation, from reactions from hot neutron scattering in the deeply screened fuel, from secondary fission processes, or any combination thereof; and
subjecting the deeply screened fuel to the hot energetic neutrons that scatter off of target fuel particles, thereby delivering a portion of kinetic energies of the energetic neutrons to the target particles and causing local nuclear fusion within the deeply screened fuel.

20. The method of claim 19, wherein
the deeply screened fuel comprises deuterated and/or tritiated hydrogen isotopes within a metal lattice.

21. The method of claim 19, wherein a rate of atoms reacting within the deeply screened fuel is sufficiently low that energy generated by the local nuclear fusion is sufficiently dispersed by conduction, convection, radiation, or any combination thereof, outside of the deeply screened fuel that the metal lattice self-heals and re-deuterates, that the deuterated material maintains a chemical composition, or that the deeply screened fuel remains in a gaseous, liquid, or solid state.

22. The method of claim 19, wherein the energetic neutrons are provided by photodisintegration of the deeply screened fuel via energetic photons provided by a linear accelerator (LINAC), directly from a radioactive element, or both, and the method further comprises:
controlling the LINAC to provide a desired photon flux at desired energy levels, inserting the radioactive element to provide hot neutrons into and/or near the deeply screened fuel, or both, to provide process control and initiation.

23. The method of claim 19, wherein
the deeply screened fuel comprises a deuterated and/or tritiated metal lattice, and
the deuterated and/or tritiated metal lattice comprises lithium, boron, beryllium, one or more high Z metals, or any combination thereof.

24. The method of claim 23, wherein
the deuterated and/or tritiated metal lattice comprises an element to be transmuted into a medical isotope.

25. The method of claim 19, further comprising:
controlling a nuclear reaction rate by adjusting a flux of x-rays and/or gamma rays produced by an x-ray device, a linear accelerator (LINAC), or both.

26. The method of claim 19, further comprising:
providing a neutron reflector, an envelope, a participating fissionable material, or any combination thereof to reflect or moderate hot neutrons, to facilitate further nuclear reactions, or both.

27. A method, comprising:
providing cold deeply screened fuel at energies below 1 electron volt (eV) that enhances nuclear tunneling, the deeply screened fuel comprising a deuterated and/or tritiated metal lattice;
providing a neutron reflector, an envelope, a participating fissionable material, or any combination thereof to reflect or moderate hot neutrons, to facilitate further nuclear reactions, or both;
irradiating the deeply screened fuel with γ-quanta and/or energetic electron e-beam ionizing radiation sufficient to create plasma channels within the deeply screened fuel, further creating deeply screened conditions between adjacent nuclei in the deeply screened nuclear fuel with at least one of the adjacent nuclear fuel nuclei being cold;
subjecting the deeply screened fuel to hot energetic neutrons at energies of 1 keV or more that scatter off of target fuel particles, thereby delivering a portion of kinetic energies of the energetic neutrons to the target particles and causing local nuclear fusion within the deeply screened fuel; and
controlling a nuclear reaction rate by adjusting a flux of x-rays and/or gamma rays produced by an x-ray device, a linear accelerator (LINAC), or both, wherein
the nuclear reaction rate is sufficiently low that energy generated by the local nuclear fusion is sufficiently dispersed by conduction, convection, radiation, or any combination thereof, outside of the deeply screened fuel that the metal lattice self-heals and re-deuterates, that the deuterated material maintains a chemical composition, or that the deeply screened fuel remains in a gaseous, liquid, or solid state.
